(19) United States
(12) Patent Application Publication
(10) Pub. No.: US 2004/0139001 A1
(43) Pub. Date: Jul. 15, 2004

(54) Network based business to business portal for the retail convenience marketplace

(76) Inventors: Peter Henriques, Cremorne (AU); John Wegrzyn, Bonnet Bay (AU); Dave Levine, Matraville East (AU); Arnold Abundo, Padstow (AU); Shon Kumar, Cremorne (AU)

Correspondence Address: CHRISTIE, PARKER & HALE, LLP, 350 WEST COLORADO BOULEVARD, SUITE 500, PASADENA, CA, 91105, US

(21) Appl. No.: 10/469,793

(22) PCT Filed: Mar. 1, 2002
(86) PCT No.: PCT/AU02/00215

(30) Foreign Application Priority Data
Mar. 2, 2001 (AU) PR 3482

(51) Int. Cl. G06F 17/60

(52) U.S. Cl. 705/39; 705/26

(57) ABSTRACT

Broadly, the invention provides an Electronic Marketplace Solution (EMS) which may be embodied, in part or in whole, as a method, system or computer readable medium of instructions. The invention provides a business to business Internet portal serving companies operating within the convenience marketplace. In one embodiment, the invention is an Internet portal which assists: Independent Convenience Retailers through the provision of a single system to sell, buy and pay for goods/services and manage their business more effectively; Organised Convenience Groups, by providing them access to improved network management, the ability to ensure compliance and the ability to reduce costs; FMCG Manufacturers in the areas of secondary supply chain efficiencies, by improved business intelligence and direct access to Convenience Retailers; Wholesalers/Logistics Providers, for reduced costs and improved efficiency and enabling them to expand their customer base; and/or Service Providers, by enabling them to more efficiently reach a large target market.

### TECHNICAL FIELD

The present invention relates to a new type of network based business to business portal, and in particular, to a method of, system for, or computer readable medium of instructions for, providing a new type of Internet based business to business portal for the retail convenience marketplace.

### BACKGROUND ART

Presently, the Australian retail convenience store market is estimated to generate annual revenues of AUD$10bn—AUD$12bn and consist of up to 60,000 outlets of which 75% are classified independent stores and 25% organised stores. The supply chain to this large number of retail outlets is costly and largely inefficient due to a high level of independent ownership and market fragmentation. This problem exists in many other retail convenience store marketplaces throughout the world.

The four key participants/groups involved in the convenience marketplace include:

Convenience Retailers—includes Organised Convenience, Independent Convenience/Route, Specialty Stores and Independent Supermarkets and Grocers;

Fast Moving Consumer Goods (FMCG) Manufacturers—includes Suppliers whose products are purchased by Convenience Retailers;

Wholesalers/Logistics Providers—includes any businesses providing product distribution services to Convenience Retailers and for FMCG Manufacturers;

Service Providers—includes any businesses providing “not for on-sale” products and services to Retailers, FMCG Manufacturers and/or their staff.

This supply chain and process complexity identifies a need to provide Retailers and Manufacturers, inter alia, a means to increase overall supply chain effectiveness.

There is a need to address the key business issues faced by the Convenience Retailer and to offer a solution which provides real value. A solution should have the ability to address the needs of key participants in the retail convenience store supply chain. These participants include Convenience Retailers, FMCG Manufacturers, Wholesalers/Logistics Providers and Service Providers.

Convenience Retailers:

The Retailer channels are generally those where consumer purchases are largely impulse or for immediate consumption. These channels include, but are not exclusive to, Organised Convenience, Independent Convenience/Route, Newsagents, Independent Grocery and Specialty Stores. There exists a need to provide such Retailers with a convenient means of accessing, ordering, handling payments, recording, managing and/or the like, goods, supplier details and/or other aspects of a Retailer's trade.

FMCG Manufacturers:

As an illustrative example, AC Nielsen estimates that at least 65% of the Australian convenience store market is supplied by fewer than ten manufacturers. Sales by individual manufacturers to these convenience stores can range from 5% of total deliveries (generally dry grocery products) to 50% (commonly impulse brand products such as chocolate bars, tobacco products and soft drinks). There exists a need to provide FMCG Manufacturers with a convenient means of supplying, offering for supply, ordering, arranging delivery, recording, managing, handling payments, and/or the like, goods, customer's details and/or other aspects of a Manufacturer's trade.

Wholesalers/Logistics Providers:

In Australia, approximately 25% of products sold in convenience stores are sourced through Wholesalers. The current wholesale market is characterised by various organised groups with differing operating arms and formats and a lack of a single nationwide organisation. There exists a need to provide a single portal for the various Wholesalers to reach the targeted Retailers.

Logistics Providers include businesses providing deliveries (and associated services) to the targeted Retailers. Industry consolidation in the Australian market, for example, has, at present, left only a few major players. There exists a need to provide a single portal for Logistics Provider's to reach/service the targeted Retailers, Wholesalers and/or Manufacturers.

There exists a need to provide Wholesalers and/or Logistics Providers with a convenient means of supplying, offering for supply, ordering, arranging delivery, recording, managing, handling payments, tracking and optimising logistics, and/or the like, goods, customer's details, supplier's details and/or other aspects of a Wholesaler's and/or Logistics Provider's trade.

Service Providers:

There are a number of organisations providing products and services (not for on-sale) to Retailers, FMCG Manufacturers, and/or their staff. These include providers of banking and insurance services, building and maintenance products, telecommunications services and lifestyle products. There exists a need to allow these providers to offer additional services to Retailers, Wholesalers, Logistics Providers and/or Manufacturers through a business exchange mechanism in an efficient manner.

Within the Retail Industry, it is presently known to individually provide:

Point of Sale (POS) scanning, that is sales information capture; or

Calculation of a replenishment order based on sales; or

Electronic transfer of store order to a web ordering site; or

Integration of a store order to web-based browse and buy functionality.

However, the combination of these features to provide an electronic marketplace solution, which in a non-limiting form may be embodied, at least partly, as a software marketplace solution, is not presently known and represents a problem to be overcome for the benefit of the convenience retail industry.

Presently, the following systems, individually, are available as stand-alone systems within the retail industry:

Available To Promise (ATP) checking from supplier's inventory database; or

Electronic transfer of checked order to supplier's order capture system; or

Supplier confirmation of order acceptance and fulfilment.

However, the combination of these systems to provide an electronic marketplace solution, which in a non-limiting form may be embodied, at least partly, as a software marketplace solution, is not presently known and represents a problem to be overcome for the benefit of the marketplace. This identifies a need to provide an end to end process for the order capture and order fulfilment within an e-commerce electronic marketplace solution for the convenience retail industry.

Furthermore, the integration of electronic payment processing with a combination of the aforementioned services/systems is, to the Applicant's knowledge, not presently known. There exists a need for a new integrated system of electronic payment processing provided with a combination of the aforementioned functions.

Presently, the provision of valued information regarding goods purchases by consumers to all or part of the convenience retail industry, that is, for example, manufacturers, store owners, wholesalers and logistics providers, is significantly limited. There exists a need to provide an improved means to obtain, access, manage and/or distribute this information.

Definitions:

The term “supplier” should be taken as a reference to the manufacturer, distributor or wholesaler selling the products to the retailer.

In a networked data communications system, users have access to terminals which are capable of requesting and receiving information from local or remote information sources. In such a system a terminal may be any type of computer or computerised device, a personal computer (PC), a mobile or cellular phone, a mobile data terminal, a portable computer, a personal digital assistant (PDA), a pager, a thin client, or any other similar type of electronic device. The capability of the terminal to request and/or receive information can be provided by an application program, hardware or other such entity. A terminal may be provided with associated devices, for example an information storage device such as a hard disk drive.

In such a system an information source may be a server or any other type of terminal (for example, a PC computer) coupled to an information storage device (for example, a hard disk drive). The exchange of information (i.e., the request and/or receipt of information) between the terminal and the information source, or other terminal(s), is facilitated by a connection referred to as a communication channel. The communication channel can be physically realised via a metallic cable (for example, a telephone line), semi-conducting cable, an electromagnetic signal (for example, a radio frequency (RF) signal), an optical fibre cable, a microwave link, a satellite link or any other such medium or combination thereof connected to a network infrastructure.

The infrastructure may be a telephone switch, a base station, a bridge, a router, or any other such specialised component, which facilitates the connection between the terminal and the network. Collectively, the interconnected group of terminals, physical connections, infrastructure and information sources is referred to as a computer network or data communications network.

The computer network itself may take a variety of forms. It may be located within a local geographic area, such as an office building, and consist of only a limited number of terminals and information sources. This type of computer network is commonly referred to as a Local Area Network (LAN). On a broader scale, it may be larger and support more users over a wider geographic area, such as across a city. This type of network is commonly referred to as a Wide Area Network (WAN). On an even broader scale LAN and WAN networks may be interconnected across a country or globally. An example of a globally connected computer network is the Internet.

To a user the Internet appears to be a single unified computer network, although in reality it consists of many different types of computer platforms utilising many diverse data communications technologies. The technologies are connected together in such a manner so they appear transparent to the user. This transparency is made possible through the use of a standard communications protocol suite known as Transmission Control Protocol/Internet Protocol (TCP/IP).

The Hyper-text Mark-up Language (HTML) and Hyper-text Transfer Protocol (HTTP) have developed to make the Internet or World Wide Web very accessible. The exchange of information on the Internet is further facilitated through hyper-text documents. Hyper-text documents are unique in that they use tags to define links which, when selected, fetch the related information from within the same document or from a new document altogether. The links are defined using HTML which provides a document formatting method which adapts in a consistent manner to any computer on which it is displayed. HTML tags are used to define the various components of an ASCII text file, image or sound which make up a hyper-text document, including such things as formatting and linking to other documents. HTML tags which link documents on one Internet information source to those on another do so by associating a Uniform Resource Locator (URL) with the referenced information. The ability to link Internet files of similar and/or differing formats to each other, and to link documents on other Internet sites, is a powerful feature of the Internet.

The appeal of the Internet is the large-scale interconnection of public and private networks. A concern exists, however, about “unauthorised” access from public networks to the attached private networks. This concern has resulted in the development of proxies. A proxy is a host computer or mechanism (usually an application program) on a network node which performs specialised functions on a network. One such function is to provide network security. Security is provided between a private and public network by requiring communications (i.e., information exchanges) to pass through the proxy. Another function of a proxy is to store or cache recently accessed information (i.e., copies of documents and images). If a browser desires information which is located outside the local network, that is to say on an information source attached to an external network, communications pass from the browser through the proxy before going on to the external network. Thus a proxy may operate to deny access to a private network from a public network by not replying to HTTP commands received from the public network.

Files are stored at various information sources. A user can access files from an information source, if authorised, by connecting to a computer network and requesting the files for viewing or downloading. Financial transactions are provided for over the computer network. Typically, financial transactions utilise proxies, SSL, data encryption etc.

Glossary of Terms:

| | |
|---|---|
| B2B | Business to Business |
| BOS | Back Office System |
| Convenience | Includes Convenience Retailers, Fast Moving |
| marketplace | Consumer Goods (FMCG) Manufacturers, |
| | Wholesalers and Logistics Providers, Service |
| | Providers |
| Connectivity | The ability to efficiently transfer |
| | data/information |
| Development software | A software platform providing the framework |
| | for an embodiment of the present invention |
| eBPP | Electronic Bill Presentment and Payment |
| ERP | Enterprise Resource Planning |
| FMCG | Fast Moving Consumer Goods |
| Independent | A Convenience Retailer not belonging to a |
| Convenience | group of Retailers |
| Retailers | |
| Internet Portal | A web-site positioned as an entrance in the |
| | Internet to a service or variety of services |
| Organised | A Convenience Retailer belonging to a group of |
| Convenience | Retailers |
| Retailers | |
| Participants | Include Retailers, FMCG Manufacturers, |
| | Wholesalers/Logistics Providers and Service |
| | Providers |
| POS | Point of Sale |
| Scanner | Device used to obtain information/data |
| | associated with a particular product or good |
| Specialty Stores | Retailer having a specialised range of goods |
| Supply Chain | Hierarchy of movement of goods within the |
| | convenience marketplace |
| Third Party Software | Additional software ancillary to the |
| | development software required for an |
| | embodiment of the present invention |
| Virtual Private | A secure shared network, eg. secured by |
| Network | encryption, tunnelling, firewalls etc. |

This identifies a need for a new type of method of, system for, or computer readable medium of instructions for, providing a new type of Internet based business to business portal for the convenience marketplace which overcomes or at least ameliorates the problems and limitations inherent in the prior art.

### DISCLOSURE OF INVENTION

Broadly, the present invention provides an Electronic Marketplace Solution (EMS) which may be embodied, in part or in whole, as a method, system or computer readable medium of instructions.

The present invention seeks to provide a business to business Internet portal, which may be independent, serving companies operating within the convenience marketplace, for example within Australia and New Zealand, specifically the present invention seeks to increase operational efficiency and effectiveness for all, or at least some, participants.

In a non-limiting embodiment of the present invention, the present invention seeks to provide an Internet portal to deliver the opportunity for significant business improvement to, inter alia:

Independent Convenience Retailers through the provision of a single system, method, and/or an electronic marketplace solution to sell, buy and pay for goods/services and manage their business more effectively; and/or

Organised Convenience Groups, by providing them access to improved network management, the ability to ensure compliance and the ability to reduce costs; and/or

FMCG Manufacturers in the areas of secondary supply chain efficiencies, improved business intelligence and direct access to Convenience Retailers; and/or

Wholesalers/Logistics Providers, for reduced costs and improved efficiency and enabling them to expand their customer base; and/or

Service Providers, by enabling them to more efficiently reach a large target market.

In a preferred embodiment, the present invention seeks to provide an electronic marketplace solution which takes sales-based orders through to a shopping cart function for web-based order processing, which includes:

Point of Sale (POS) scanning, that is sales information capture;

Calculation of a replenishment order based on sales;

Electronic transfer of store order to a web ordering site; and

Integration of a store order to web-based browse and buy functionality.

In another preferred embodiment, the present invention seeks to provide an electronic marketplace solution which integrates:

Available To Promise (ATP) checking from supplier's inventory database;

Electronic transfer of checked order to supplier's order capture system,

Supplier confirmation of order acceptance and fulfilment; and

whereby links between the electronic marketplace solution's browse and buy functionality and the supplier's sales systems are provided, enabling online tracking of web-placed orders.

In a further preferred embodiment, the present invention seeks to provide an electronic marketplace solution which integrates:

Sales-based orders being placed through to a shopping cart function for Web-based order processing, including:

Point of Sale (POS) scanning;

Calculation of a replenishment order based on sales;

Electronic transfer of store order to a web ordering site; and

Integration of a store order to web-based browse and buy functionality; and

ATP checking from supplier's inventory database;

Supplier confirmation of order acceptance and fulfilment;

Electronic transfer of checked order to supplier's order capture system; and

whereby links between the electronic marketplace solution's browse and buy functionality and the supplier's sales systems are provided, enabling online tracking of web-placed orders.

In a further particular embodiment of the present invention, electronic processing of claims is integrated in the electronic marketplace solution. Preferably, but not necessarily, the electronic marketplace solution includes a centrally managed data library which is linked with the order processing system; Also, POS/BOS data can be managed within a central service, thereby increasing the accuracy of information across retail stores as well as reducing retail store level administration requirements. In a particular embodiment of the present invention, the data is managed to deliver valued information to all or some of the marketplace solution members, that is, for example, manufacturers, store owners, wholesalers and logistics providers to the retail trade. Preferably, the electronic marketplace solution can provide access to this managed information relating to consumer purchases via a business-to-business web portal. In a particular embodiment of the present invention, it is sought to provide a web-site for the Logistics Providers to access information pertaining to the targeted Retailers.

In a further embodiment of the present invention, there is provided an integrated system for providing an electronic marketplace solution, the integrated system including:

means for Point of Sale (POS) scanning of goods and associated data capture by a Convenience Retailer;

means for determining a replenishment order for goods, based on sales by the Convenience Retailer, preordained Convenience Retailer criteria, or the Convenience Retailer manually selecting goods;

means for the electronic transfer of the replenishment order to a Supplier Internet-based ordering system; and

means for integration of the replenishment order to Internet-based browse and buy functionality on the Supplier Internet-based ordering system.

In a further embodiment of the present invention, there is provided an integrated system for providing an electronic marketplace solution, the integrated system including:

means for the electronic transfer of a Convenience Retailer's replenishment order of goods to a Supplier's ordering capture system;

means for Available To Promise (ATP) checking from the Supplier's inventory database;

means for providing electronic confirmation from the Supplier of replenishment order acceptance to the Convenience Retailer; and

means for electronic tracking of replenishment orders until delivery of the goods to the Convenience Retailer.

In a further embodiment of the present invention, there is provided a system for providing an electronic marketplace, the system including:

means for a Convenience Retailer to search and browse a multiple Supplier goods and pricing catalogue;

means to provide the Convenience Retailer with online order placement, tracking and management of goods;

means to generate customised reports; and

means for electronic bill presentation and payment.

According to another possible aspect, means are also provided to facilitate Supplier access to marketplace based promotions is provided. Also the system may include a telecommunications infrastructure providing: a secure private network; a secure connection via the Internet; and Internet connectivity. According to another aspect, the system includes Point of Sale (POS) scanning of goods, and inventory management and business reporting tools for the Convenience Retailer.

In a further possible form, the system is integrated with Supplier enterprise resource planning (ERP) systems to provide:

Available To Promise (ATP) checking from the Supplier's inventory database;

credit and payment status checking from the Supplier's financial database;

electronic transfer of orders to the Supplier's order capture system; and

Supplier confirmation of order acceptance and fulfilment. Preferably, the system communicates with commercial banking systems to provide electronic payment and funds transfer facilities.

In a further embodiment of the present invention, there is provided a method of providing an electronic marketplace solution, the method including the steps of:

a Convenience Retailer identifying, on a Convenience Retailer terminal, goods which the Convenience Retailer desires to purchase, via a computer network portal, the goods being offered by a Supplier on a Supplier ordering system;

the Convenience Retailer requesting, on the Convenience Retailer terminal, the purchase and delivery of the goods;

a request being transmitted, by the Convenience Retailer terminal via the computer network, to the Supplier ordering system for the requested goods;

an automated request being transmitted, by the Convenience Retailer terminal or the Supplier ordering system, to a Logistics Provider to effect delivery of the goods; and

the Logistics Provider arranging delivery of the goods to the Convenience Retailer, whereby the Convenience Retailer terminal can be used to access goods delivery status information on a database.

In a further embodiment of the present invention, there is provided a network based business to business Internet portal, the Internet portal facilitating network communication between:

a Convenience Retailer; and

a Supplier; and

a Wholesaler or Logistics Provider; and whereby, the Internet portal is used to allow functions including:

the Convenience Retailer to order and pay for goods or services; and

the Supplier to confirm the availability of goods; and

the Logistics Provider to provide tracking of goods delivery status.

In a further embodiment of the present invention, there is provided a set of computer readable medium of instructions for use in providing an electronic marketplace solution, the set of instructions enabling web-based order processing and including procedures for: Point of Sale (POS) scanning of goods at a Convenience Retailer; calculation of a replenishment order based on sales by the Convenience Retailer; electronic transfer of the replenishment order to a web-based ordering site; and web-based browse and buy functionality for Convenience Retailer's goods orders.

In a further embodiment of the present invention, there is provided a set of computer readable medium of instructions for use in providing an electronic marketplace solution, the set of instructions enabling web-based order processing and including procedures for: Available To Promise (ATP) checking from a Supplier's inventory database; electronic transfer of orders from a Convenience. Retailer to the Supplier's order capture system; and Supplier confirmation of order acceptance.

Preferably, the computer network is the Internet. Also preferably, each terminal is a PC. In a further embodiment of the present invention all transactions, purchases and the like are stored for subsequent access. In a further embodiment of the present invention all goods are scanned by a scanner connected to the Convenience Retailer's terminal when received by the Convenience Retailer, thereby updating relevant records for any of the participants. In still a further embodiment of the present invention all goods are scanned by a scanner connected to the Convenience Retailer's terminal when purchased by a consumer from the Convenience Retailer, thereby updating relevant records for any of the participants. In an embodiment of the present invention, relevant records include: inventory information; sales figures; time of sale; place of sale; identifying information about the consumer; and/or the like. In a further broad form of the present invention, the present invention also provides that information pertaining to consumer purchases gathered by the Convenience Retailer is visible to the FMCG Manufacturer; Wholesaler; Logistics Provider; and/or Service Provider. In still a farther embodiment of the present invention, automated ordering of goods by the Convenience Retailer's terminal occurs when database records indicate that the Convenience Retailer's stock of goods is at a predetermined level. In still a further embodiment of the present invention, the FMCG Manufacturer, Wholesaler, Logistics Provider, and/or Service Provider, can individually or cooperatively collate orders for goods from Convenience Retailer's so that the distribution of goods is efficiently carried out. In still yet a further broad form, the present invention provides that any or all of the participant's terminals reside in a private network and/or access to the computer network portal occurs via a proxy server which may require user authentication. In still yet a further broad form, the present invention provides that data, information and/or files pertaining to past transactions in the convenience marketplace are available, via a computer network, to authorised users or participants from at least one information source.

In yet a further broad form, the present invention provides that the computer network can be any network of two or more communicating computers or terminals including but not limited to, an internetwork, an intranetwork, a LAN, a WAN, or the Internet. In still yet a further broad form, in accordance with the present invention information or data is exchanged by means including but not limited to: metallic cables; semi-conducting cables; optical fibre cables; satellite links; electromagnetic waves; microwave links; exchanging of memory devices; or any other such medium or combination thereof connected to a network infrastructure.

### BRIEF DESCRIPTION OF FIGURES

The present invention will become apparent from the following description, which is given by way of example only, of a preferred but non-limiting embodiment thereof, described in connection with the accompanying figures, wherein:

FIG. 1 illustrates a preferred embodiment of the present invention wherein, the figure shows a broad schematic of the interaction between participants;

FIG. 2 illustrates a preferred embodiment of the present invention wherein, the figure represents the key functionality and benefits for both Independent and Organised Convenience stores;

FIG. 3 illustrates a preferred embodiment of the present invention wherein, the figure represents the key functionality and benefits for the Supplier group which includes FMCG Manufacturers, Wholesaler/Logistics Providers and Service Providers;

FIG. 4 illustrates further aspect of the functionality of an embodiment of the present invention;

FIG. 5 illustrates the software architecture of a preferred embodiment of the present invention;

FIG. 6 illustrates the key data flows associated with the business exchange of a preferred embodiment of the present invention;

FIG. 7 illustrates a schematic for Catalogue Search and Browse;

FIG. 8 illustrates a schematic for Catalogue Maintenance: Master Catalogue and Associated Views;

FIG. 9 illustrates a schematic for Catalogue Maintenance: Maintain Promotions;

FIG. 10 illustrates a schematic for Catalogue Maintenance: Maintain Pricing;

FIG. 11 illustrates a schematic for Catalogue Maintenance: Maintain My List;

FIG. 12 illustrates a schematic for Catalogue Maintenance: Maintain Frequently Ordered List;

FIG. 13 illustrates a schematic for Catalogue Maintenance: Maintain Company List;

FIG. 14 illustrates a schematic for Context Diagram: Order Capture—Saved Shopping Cart;

FIG. 15 illustrates a schematic for Context Diagram: Order Capture—Top-Up Order (Quick);

FIG. 16 illustrates a schematic for Context Diagram: Order Capture—HOS Generated Order (Aggregated Order);

FIG. 17 illustrates a schematic for Context Diagram: Order Capture—BOS Generated Order for a Single Store;

FIG. 18 illustrates a schematic for Context Diagram: Available to Promise;

FIG. 19 illustrates a schematic for Context Diagram: Community, Version 5;

FIG. 20 illustrates a schematic for Context Diagram: Order Tracking;

FIG. 21 illustrates a schematic for Context Diagram: Claims & Returns;

FIG. 21 illustrates a schematic for Electronic Payment;

FIG. 23 illustrates a schematic for Cash/Cheque Payment;

FIG. 24 illustrates a schematic for Initiate User Session;

FIG. 25 illustrates a schematic for Create & Maintain User Profile & Security;

FIG. 26 illustrates a schematic for Process Flow: Maintain Master Catalogue—Supplier Adds/Updates/Deletes Product/Price/Customer Information;

FIG. 27 illustrates a schematic for Process Flow: Maintain Master Catalogue—Retailer Adds/Updates/Deletes Product/Supplier Info. in POS/BOS;

FIG. 28 illustrates a schematic for Process Flow: Retailer adds/deletes item in their list in 12 Customer Management Suite, and generate/transmits data;

FIG. 29 illustrates a schematic for Process Flow: Retailer adds/deletes item in their list in 12 Customer Management Suite, and EMS catalogue admin. generate/transmit data;

FIG. 30 illustrates a schematic for Process Flow: Import BOS Generated Order;

FIG. 31 illustrates a schematic for Process Flow: Browse & Buy;

FIG. 32 illustrates a schematic for Process Model: Pricing;

FIG. 33 illustrates a schematic for Process Flow: Content and EMS Facilitated Email Creation and Distribution;

FIG. 34 illustrates a schematic for Process Flow: Goods Receipt;

FIG. 35 illustrates a schematic for Process Flow: Updated Order Status and Data;

FIG. 36 illustrates a schematic for Process Flow: Submit and Process Claims & Returns;

FIG. 37 illustrates a schematic for New Buyer/Retailer/Group of Retailers;

FIG. 38 illustrates a schematic for New Supplier.

### MODES FOR CARRYING OUT THE INVENTION

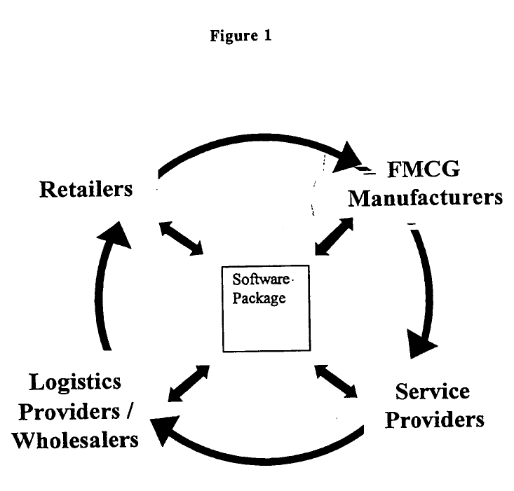

The present invention provides a new type of Internet based business to business portal. In a particular embodiment of the present invention, the present invention seeks to address the needs of participants in the Retail Convenience Store supply chain, these participants include Retailers, FMCG Manufacturers, Wholesalers/Logistics Providers and Service Providers. This is illustrated in FIG. 1, where the electronic marketplace solution includes a computer readable medium of instructions implemented as an Internet portal to enable the participants to efficiently communicate various particulars when operating in the convenience marketplace.

The present invention is designed to provide participants with a means to more effectively manage the growth and profitability of their businesses. For this to be achieved and the benefits of an exchange marketplace to be maximised, participation by a critical mass of Retailers and FMCG Manufacturers will be required. All participants should achieve benefits by subscribing to the business exchange system/method. Cost savings through process optimisation can be achieved in the areas of, for example, order capture, payment, and delivery. Real time business intelligence information and organisational efficiencies can significantly benefit network management, field sales, marketing and manufacturing. In addition, reduced administration workload will free up valuable time for participants to focus on their business.

The present invention may be applied to any convenience marketplace in the world, although various compliance changes may be required to implement the present invention these compliance changes should be considered to be encompassed by the scope of the present invention.

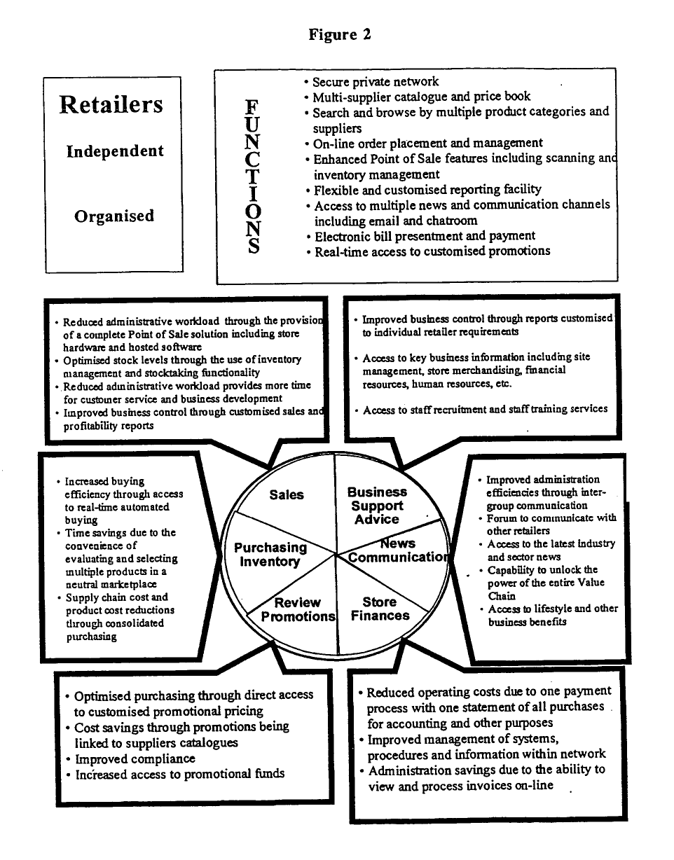

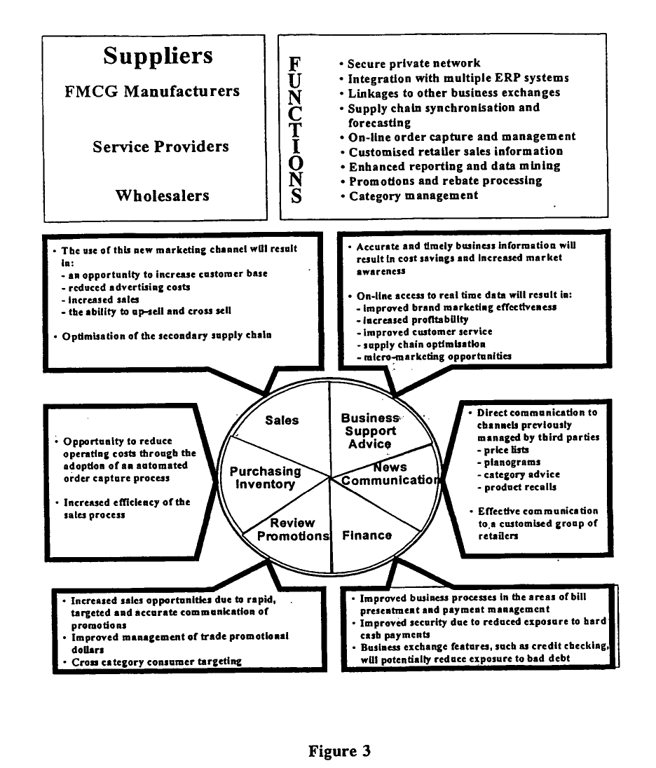

Participation in the business exchange system/method of the present invention can provide significant benefits. These benefits may vary depending on whether the participant is a Retailer (organised or Independent) or Supplier (FMCG Manufacturer, Wholesaler/Logistics Provider, or Service Provider). FIGS. 2 and 3 identify the functionality and benefits associated with each of these two participant groups in a preferred embodiment of the invention.

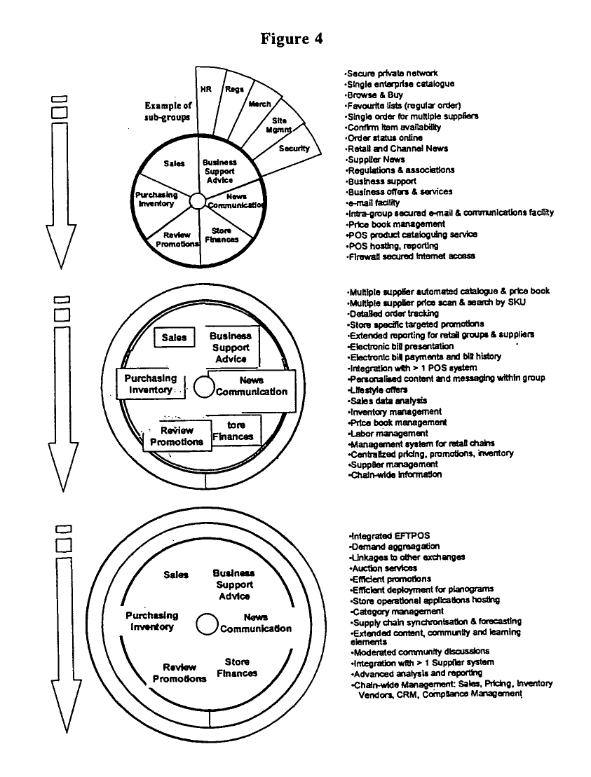

The introduction of the overall functionality, may take place progressively over a series of business releases, as shown in FIG. 4. It should be noted, however, that such a staggered release is not a requirement of the present invention. Any, or all, of the functional aspects identified in FIG. 4 may be introduced at any time or included with any version of the present invention. FIG. 4 is included to illustrate aspects of the functionality of an embodiment of the present invention, rather than a business release strategy.

In a preferred, but non-limiting, embodiment of the invention, the present invention utilises a software development platform to create a computer readable medium of instructions. In this embodiment, development software provides the necessary framework to support the present invention. The key modules of the solution of this embodiment include: Customer Management; Order Management; Demand Fulfilment; Business Intelligence; Replenishment Planner; and eBusiness Framework.

In addition to the development software, the total solution of this embodiment is dependent on a range of further software, including Electronic Bill Presentment and Payment software and an in-store Point of Sale system.

An overview of all the key modules is presented below. It should be noted that although development software and further software is described in this embodiment of the present invention, any form of creating or obtaining such software is applicable to the present invention. Numerous alternate software platforms/languages may be utilised to work the present invention.

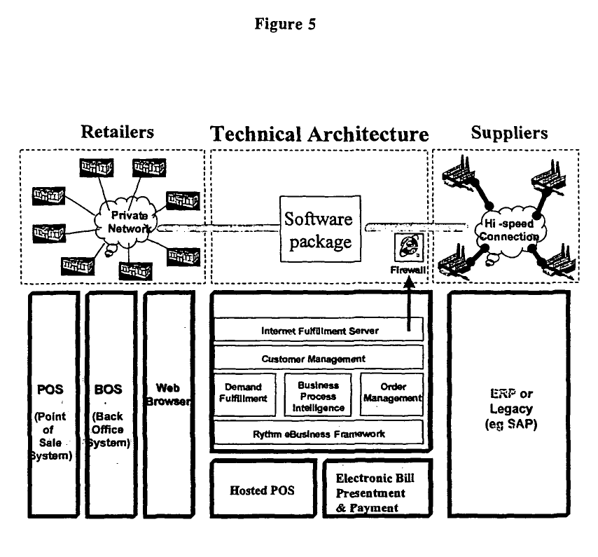

A possible B2B solution architecture of an embodiment of the present invention is illustrated in FIG. 5. Further technical details follow:

Point of Sale:

The Point of Sale solution (POS) comprises hardware (PC, scanner and/or data capture device) and back office software, which is located within the Retailers store, and hosted software located at a centrally managed facility. At the store level, Retailers can benefit from features including scanning technology, inventory management and sales data analysis. The hosted Point of Sale software can provide Retailers with the opportunity to use a range of applications geared towards providing increased efficiency and profitability, such as a management system, centralised pricing and promotional information, supplier management capabilities, etc.

Electronic Bill Presentment and Payment:

Electronic Bill Presentment and Payment (eBPP) is a flexible web-based application which digitises the current paper based billing, payment and notification process. The main functionality enables the creation and delivery of richly formatted bills, statements or notices, and associated advertising in an electronic format. This is transmitted via the electronic marketplace solution, to Retailers, and the return payment and remittance information to the biller.

Development software:

A software component of the business exchange is developed from the development software. This solution is made up of a number of integrated modules:

Customer Management—The Customer Management (CM) module provides users with a consistent user interface, via a single web site, to manage all interactions.

Order Management—The Order Management (OM) module provides all the necessary functionalities needed for an order management system deployed in a marketplace environment. The OM provides all the necessary work flow activities associated with an order including continuous tracking of customer orders, splitting them into individual supplier specific Purchase Orders (POs) and generating Invoices against the POs.

eBusiness framework—The eBusiness framework provides a set of workflows, guidelines and rules.

Demand Fulfilment—The Demand Fulfilment (DF) module is an intelligent order-fulfilment solution, addressing the total spectrum of needs in the order-promising process.

Fulfilment server—The Fulfilment server provides collaborative order fulfilment across discrete enterprises' individual supply chains, and an interface for integrating the front-end customer applications with back-end supply chain modules.

Business Intelligence—The Business Intelligence (BI) module provides the User Interface for interacting with the management information repository.

Data Flow:

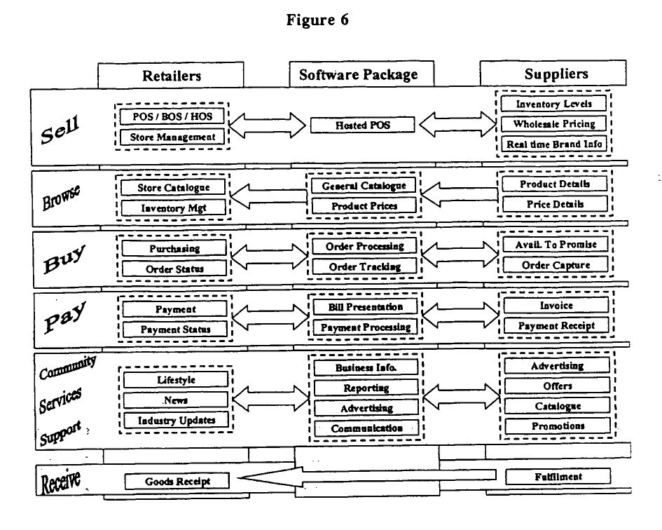

The present invention can provide Retailers and Suppliers with significant supply chain benefits in areas including product, price and promotion visibility, a state-of-the-art POS and scanning solution, electronic order placement and processing and electronic bill presentment and payment. FIG. 6 depicts the key data flows associated with the business exchange of a preferred embodiment of the present invention. In FIG. 6, the following abbreviations have been used: POS—Point of Sale; BOS—Back Office System; HOS—Head Office System.

Equipment Configuration:

Whilst the larger Convenience Organised Retailers may have the required technology to utilise the functionality of the present invention, ie. POS system and scanners, smaller independent Retailers may not have the necessary equipment.

The key equipment required by Convenience Retailers, in order to achieve certain benefits from the present invention, are scanners, PC's and connectivity to the Internet. It is also envisaged that further embodiments can provide additional functionality, such as the integration of EFTPOS card readers into the POS systems. Convenience stores may utilise existing infrastructure, requiring only connectivity to a computer network.

Further Examples

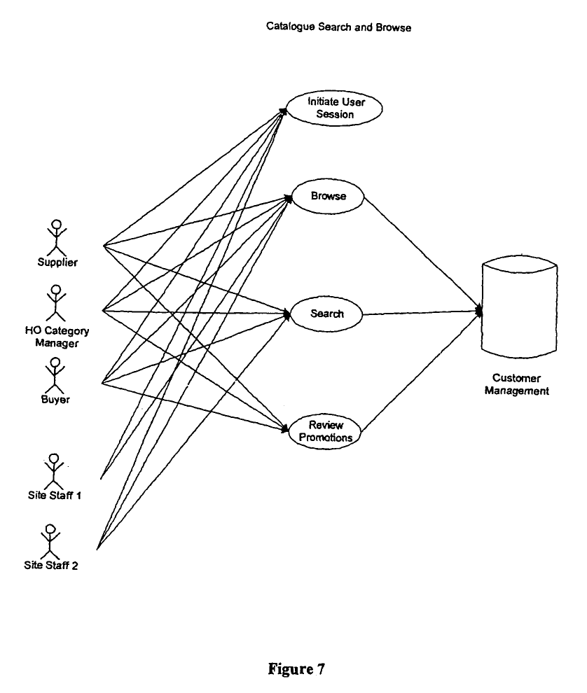

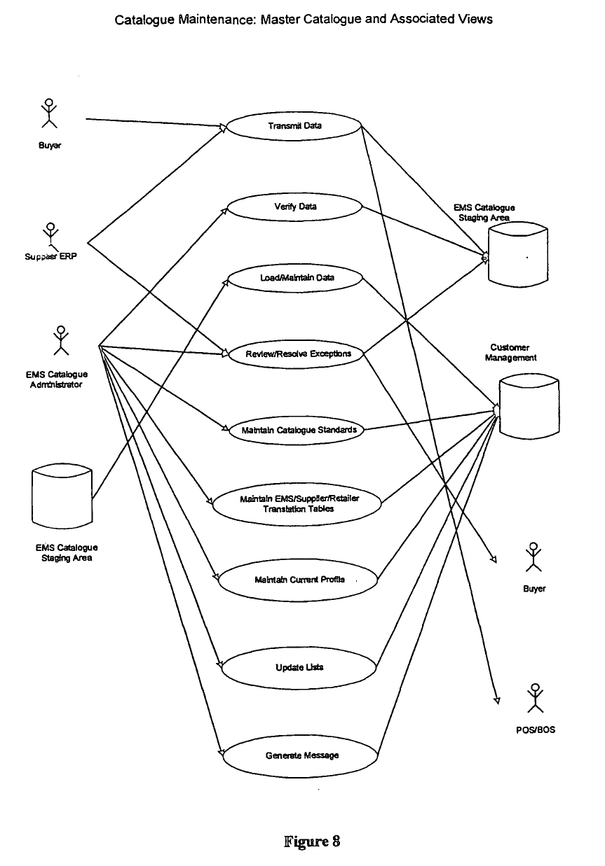

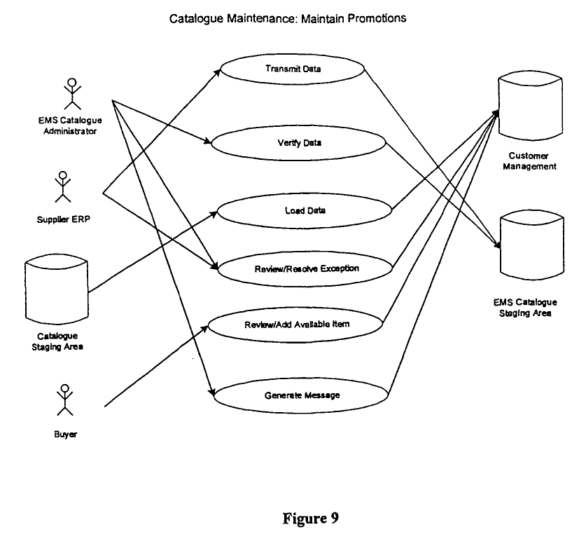

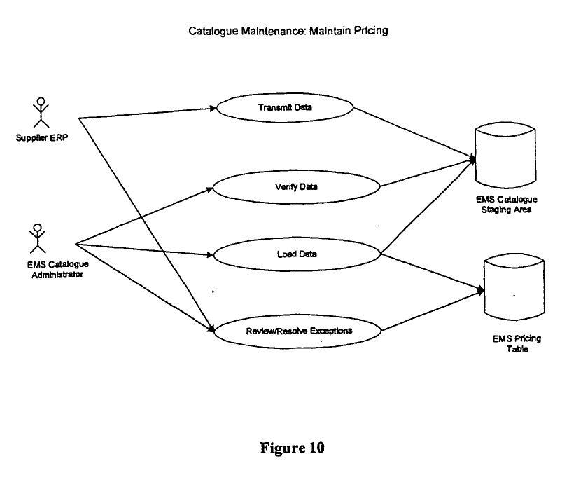

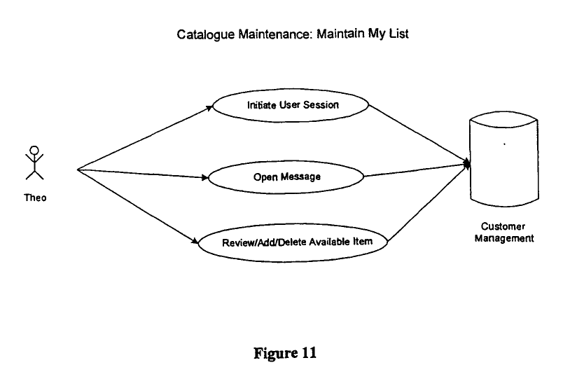

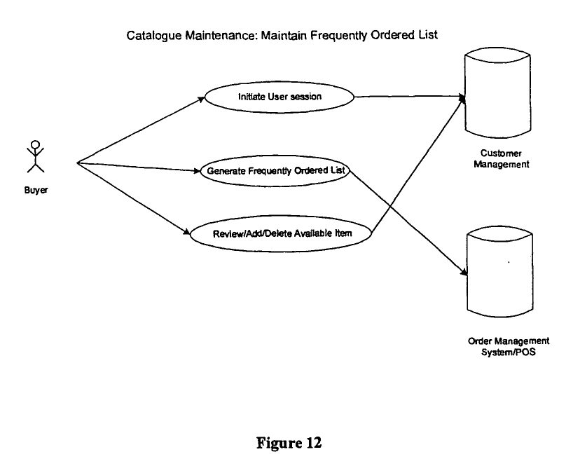

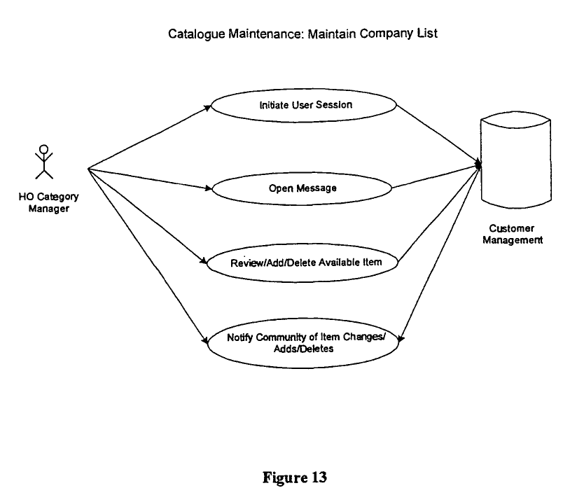

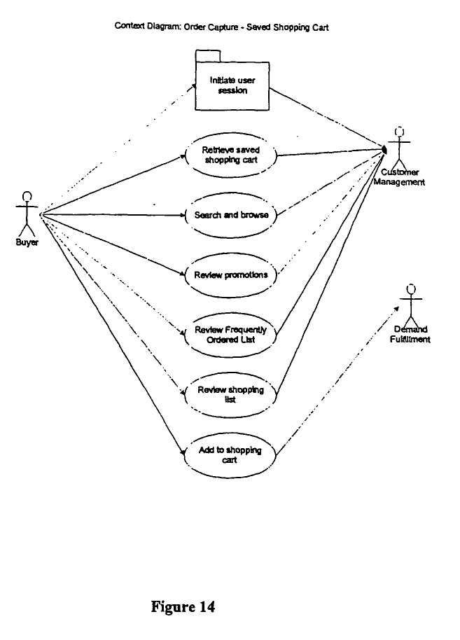

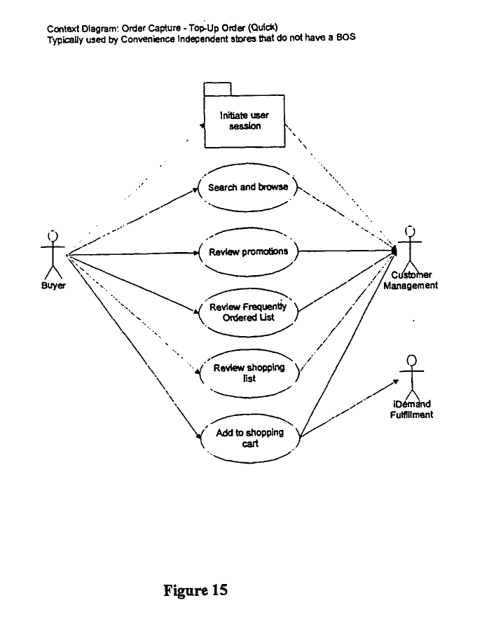

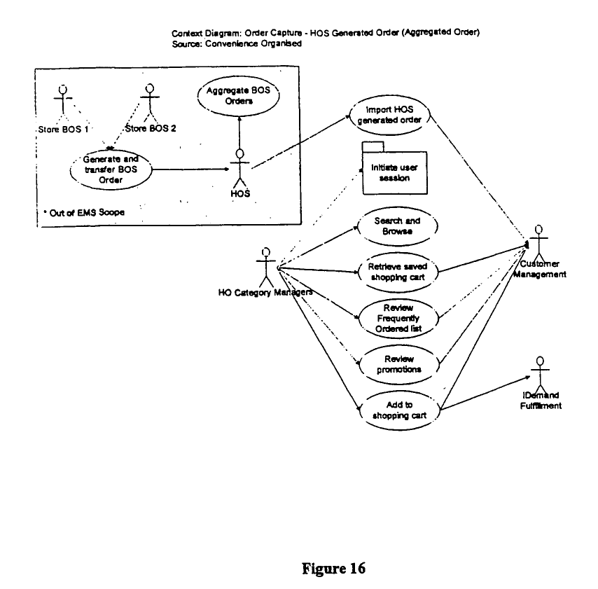

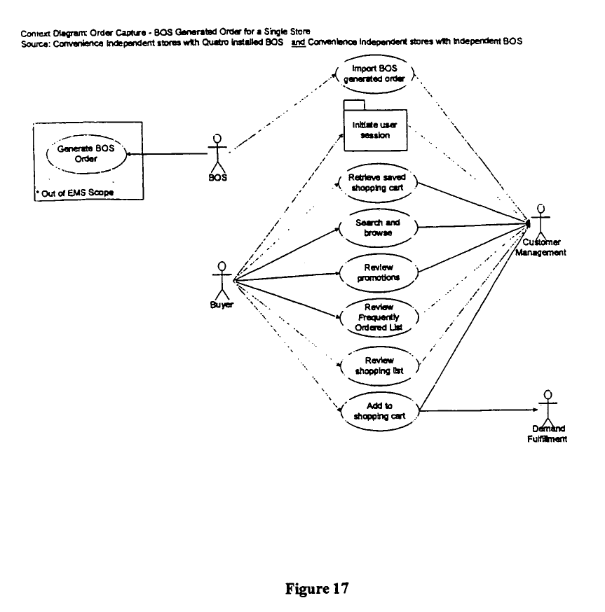

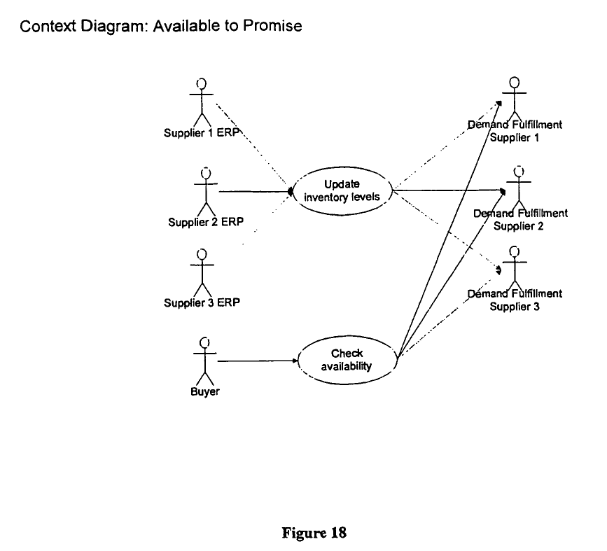

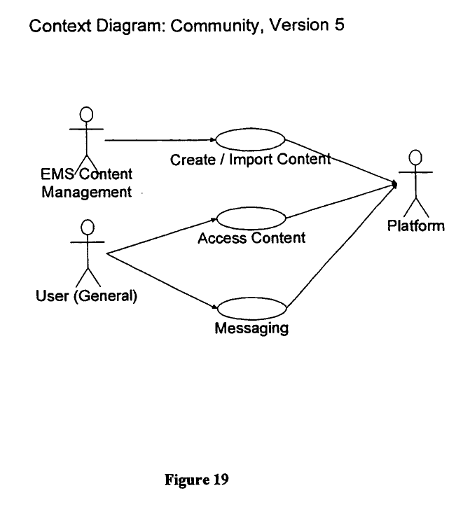

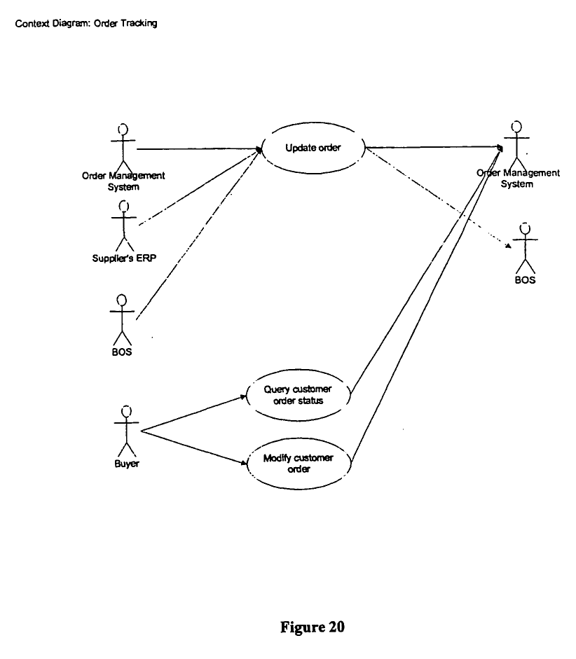

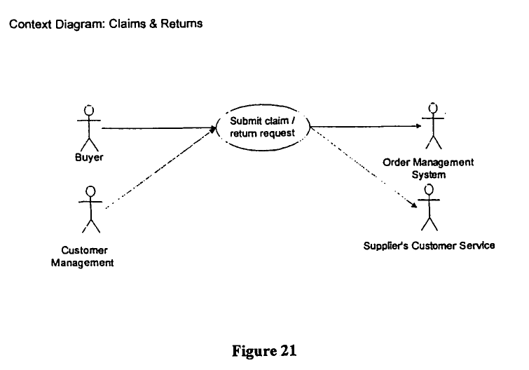

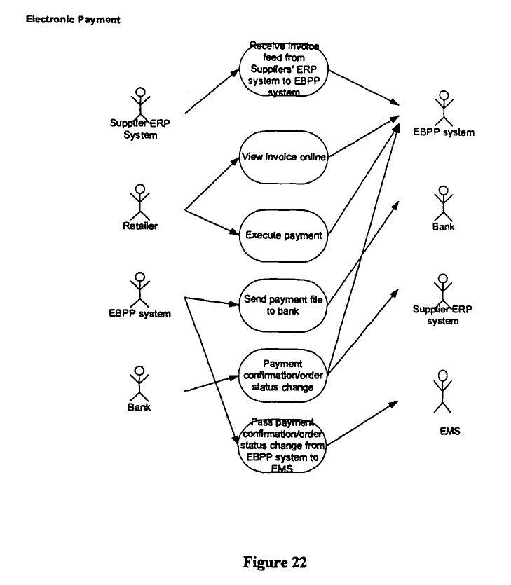

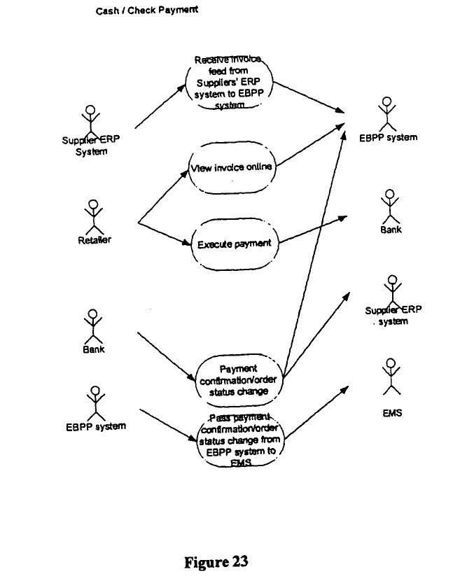

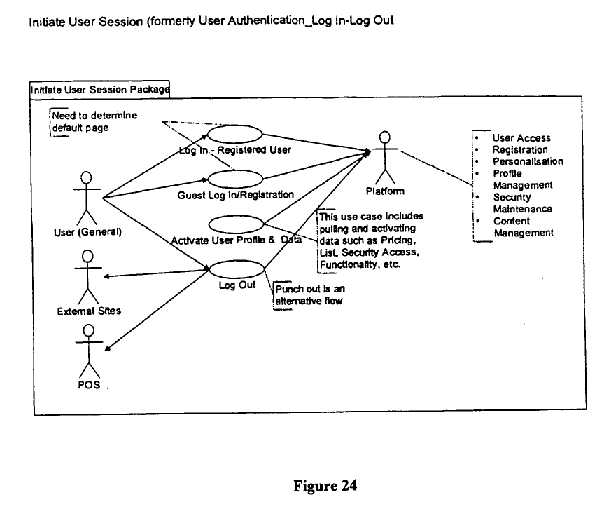

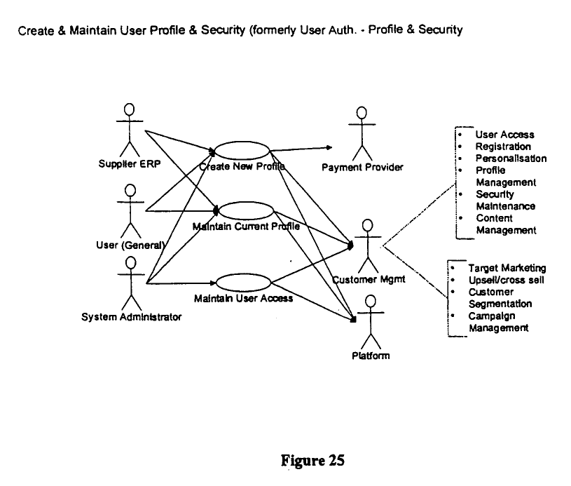

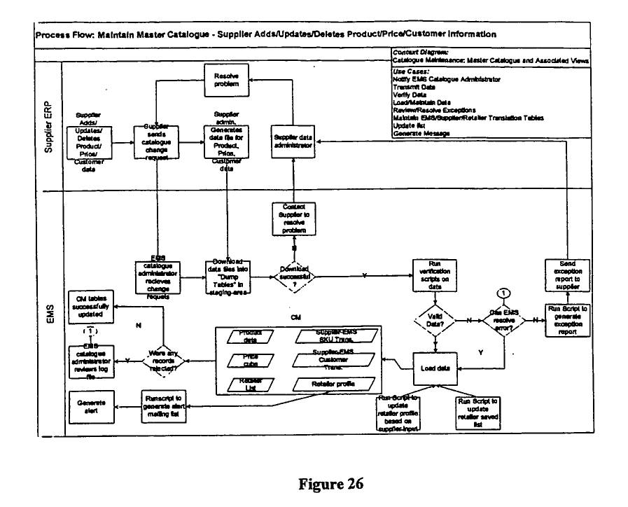

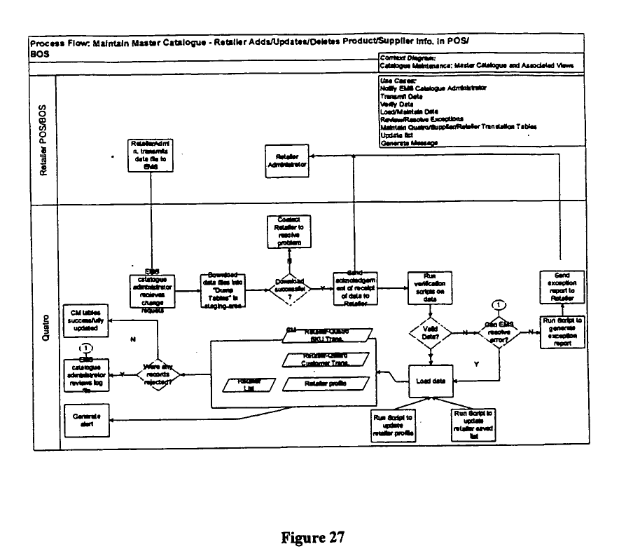

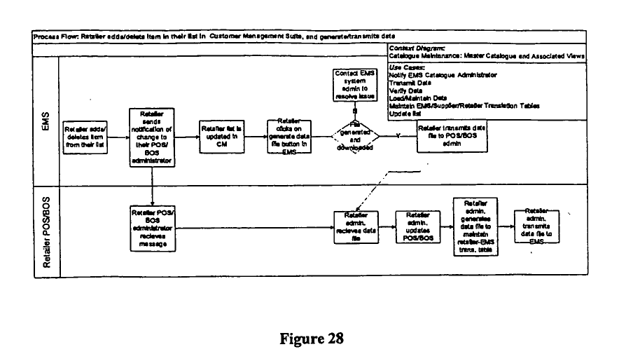

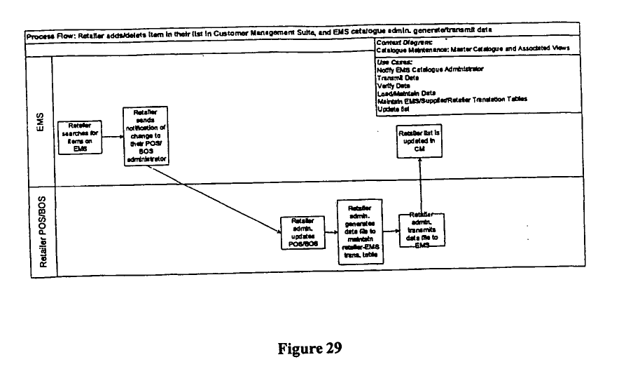

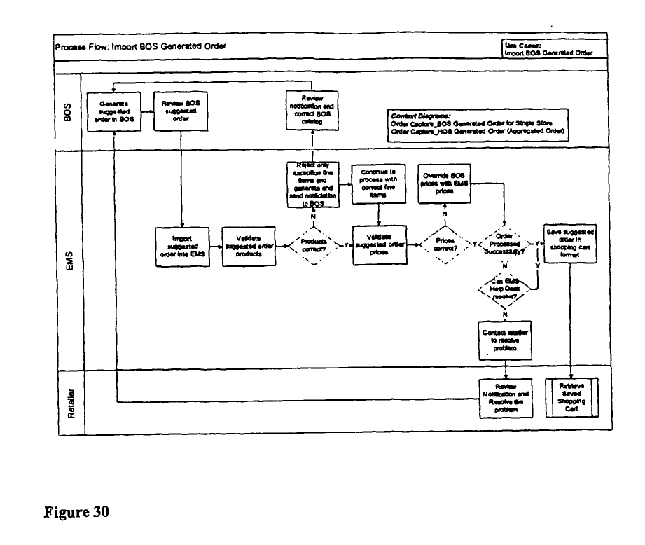

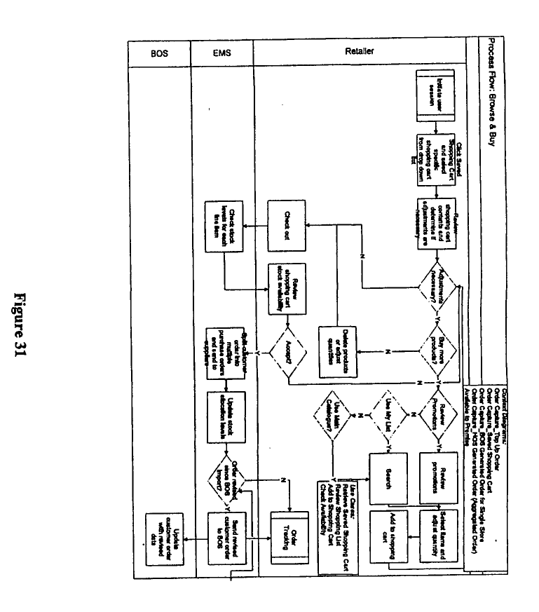

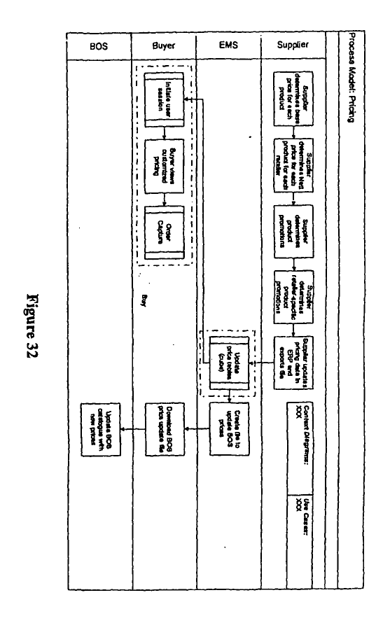

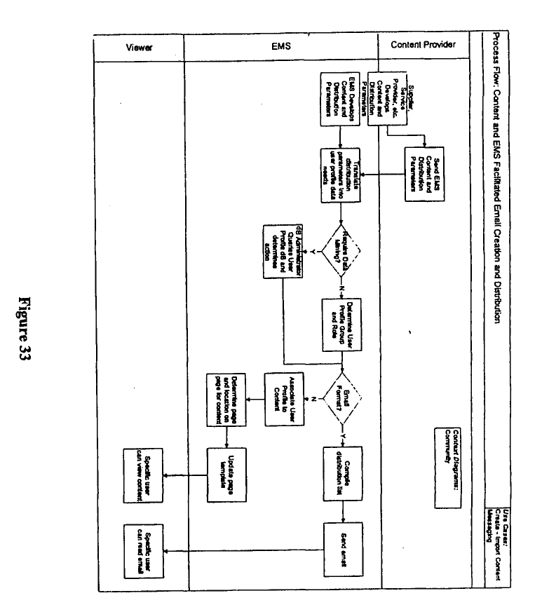

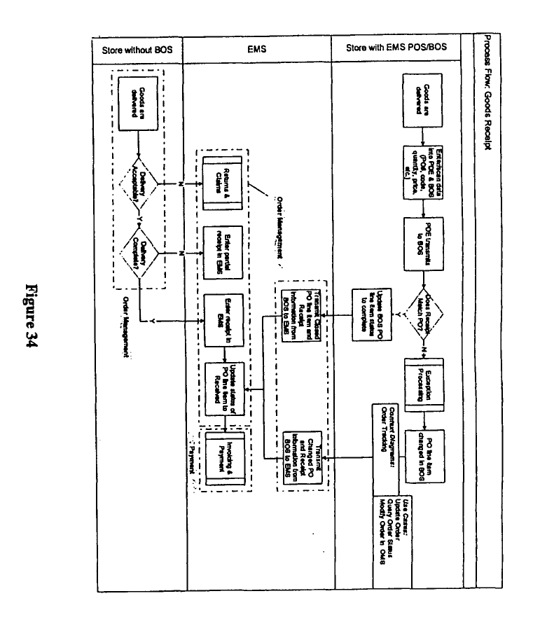

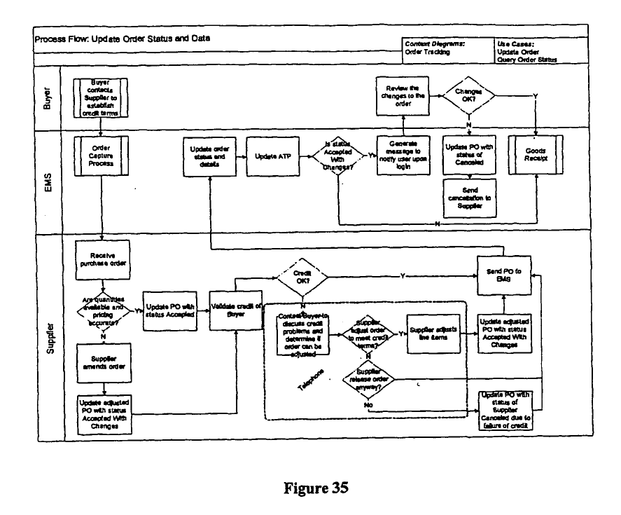

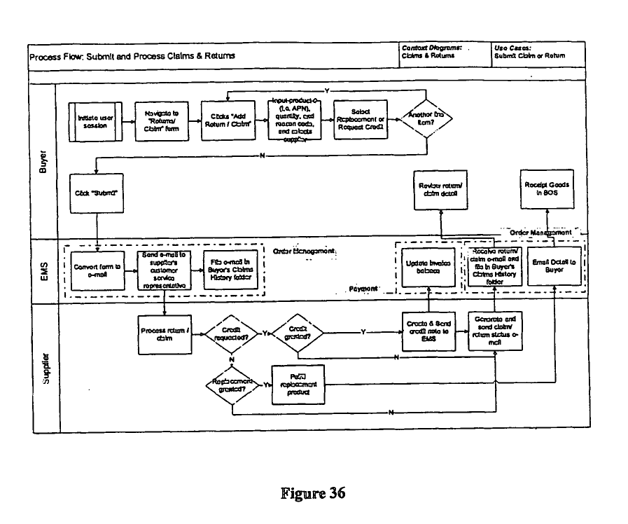

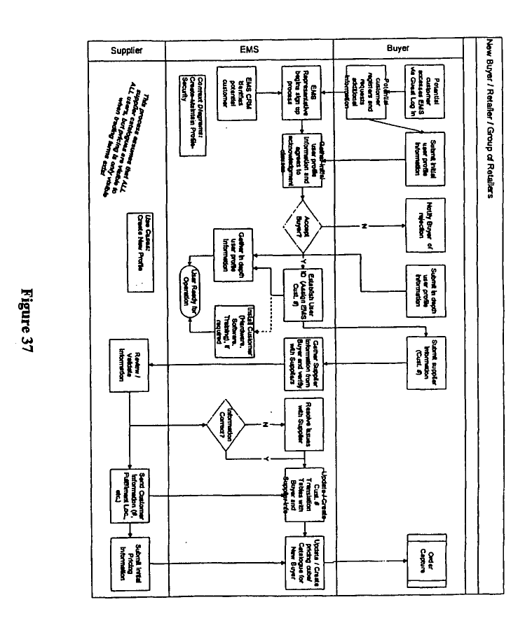

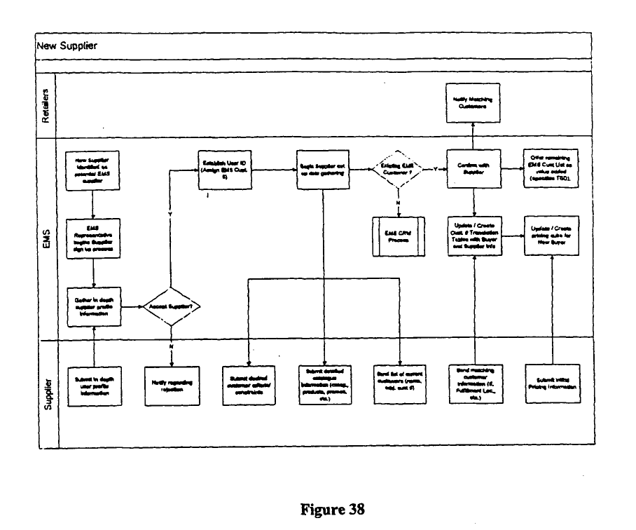

The following examples provide a more detailed outline of one embodiment of the present invention. These examples are intended to be merely illustrative and not limiting of the scope of the present invention. These examples describe “Use Case Specifications” which illustrate features of the main components or procedures of the exemplified embodiment(s). The following examples are to be read in conjunction with the FIGS. 7 to 38 which provide a visual illustration of the described embodiment(s).

Use Case Specification: <Transmit Data>

1. Use Case Diagrams

Catalogue Maintenance: Master Catalogue and Associated Views

Catalogue Maintenance: Maintain Promotions

Catalogue Maintenance: Maintain Pricing

2. Use Case Actors

Supplier ERP

Electronic Marketplace Solution Catalogue Staging Area

Buyer

POS/BOS

3. Brief Description

In this use case, data is transferred from the supplier to Electronic Marketplace Solution, from the buyer to Electronic Marketplace Solution

Supplier ERP provides the following data: supplier catalogue data, user profile data, pricing data, supplier translation tables, and promotions data

The buyer from CO provides translation tables data

The supplier provides new products data, if retailer is part of the, Electronic Marketplace Solution POS/BOS installed base—data transmission is done from Electronic Marketplace Solution catalogue to the POS/BOS system using an interface

The independent retailer with their own POS/BOS system will choose the one of the two options

4. Flow of Events

Basic Flow

Supplier transmits data in predefined format

Electronic Marketplace Solution catalogue administrator will down load the data file into the dump files in Electronic Marketplace Solution staging area

Electronic Marketplace Solution catalogue administrator sends acknowledgement after data is verified and loaded to Electronic Marketplace Solution catalogue

4.2 Alternative Flow(s)

Electronic Marketplace Solution catalogue administrator is not successful in down loading data files

Electronic Marketplace Solution catalogue administrator should contact the supplier/buyer to confirm data file format, and request resending the data files

Electronic Marketplace Solution catalogue administrator transmits product update data to POS/BOS

No longer valid, Electronic Marketplace Solution will not update retailer's POS/BOS. The retailer will have to update POS/BOS before trying to add or order an item in Electronic Marketplace Solution

Buyer's saved list is updated in Customer Management (CM)

Electronic Marketplace Solution catalogue administrator sends notification message to buyer

Electronic Marketplace Solution catalogue administrator will generate buyer specific product update files

Electronic Marketplace Solution catalogue administrator transmits this data to the buyer

Buyer updates POS/BOS system

Data transmission between Electronic Marketplace Solution and Electronic Marketplace Solution Managed POS/BOS

Retailer initiates a POS/BOS session

POS/BOS product master file is updated based on feed from the Electronic Marketplace Solution catalogue

POS/BOS product master file is now synchronised with the retailers list/cart in the Electronic Marketplace Solution CM

Data transmission between Electronic Marketplace Solution and CO POS/BOS

CO POS/BOS is updated

CO transmits translation table data for Supplier ID's/Product Information

CO/Electronic Marketplace Solution systems administrator updates translation tables

Data transmission between Electronic Marketplace Solution and small retailers with independent POS/BOS systems

This group will have to choose between the data transmission flow for Electronic Marketplace Solution Managed POS/BOS, or CI POS/BOS

5. Special Requirements

Release 1

Electronic Marketplace Solution Catalogue Staging area has to be developed to receive the supplier/buyer data (directory structure for pilot)

Data needs to be formatted based on Electronic Marketplace Solution's predefined standard

Data transmission medium should be fast and secure, to ensure that data transmitted is not corrupted

Basic scripts to automate the process of generating data files within Electronic Marketplace Solution

Transmission protocol has to be established with the supplier/buyer, if Electronic Marketplace Solution receives/sends data files via FTP

Basic scripts to validate add/update/delete data

Release 3

Scripts to automate the process of generating data files within Electronic Marketplace Solution

Scripts to validate add/update/delete data

Multi-enterprise catalogue functionality

Develop download button for buyers to generate a flat file that contains data on new items. This will save the Electronic Marketplace Solution catalogue administrator from having to generate and send data files to buyer to update POS/BOS. (no longer necessary because Electronic Marketplace Solution will not be responsible for updating POS/BOS system with new product information)

Phase 1

Develop interface between Electronic Marketplace Solution catalogue in CM and the Electronic Marketplace Solution managed POS/BOS system to synchronise the product master file and the Electronic Marketplace Solution catalogue

Develop translation tables between CI supplier/product data in the Electronic Marketplace Solution system, and the associated scripts to maintain/verify/load data

6. Pre-Conditions

Supplier/buyer/Electronic Marketplace Solution catalogue administrator has generated flat file. For example: product, user profile, pricing, and promotion data

Electronic Marketplace Solution catalogue staging area has been set up with the required tables and associated attributes

Data load, extraction, and verification scripts have been developed

Electronic Marketplace Solution data formats have been established

7. Post-Conditions

Data has been down loaded to the dump files in the Electronic Marketplace Solution catalogue staging area

Electronic Marketplace Solution catalogue administrator has sent acknowledgement to the supplier/buyer after successful down load, verification, and load into CM

8. Data Requirements

User profile attributes. Still to be defined

Product Data

Supplier SKU Number

APN Number

Description

Short Description

Base UOM

Buy UOM

Packaging Information

Effectivity Dates (For New Products)

Flag (New, Update, Delete)

Product obsolete flag

Promotion Data

APN Number

Supplier SKU Number

Promotion Effectivity Date (To-From)

Discount

Min Order Qty

Max Order Qty

Promotion Details

Pricing

Supplier ED

Customer ID

APN Number

Nett Price

Field to identify add/update/delete

9. Interfaces

Supplier/buyer will transmit the data based on their schedule. Based on the infrastructure the data file could be transmitted using FTP, e-mail attachment, or using an interface with the supplier's ERP system or the buyer's BOS/POS. The frequency of the data transmission will be done on a nightly batch process

Develop interface between Electronic Marketplace Solution catalogue in CM and the Electronic Marketplace Solution managed POS/BOS system to synchronise the product master file and the Electronic Marketplace Solution catalogue

Use Case Specification: <Update Lists>

1. Use Case Diagrams

Catalogue Maintenance: Master Catalogue and Associated Views

2. Use Case Actors

Customer Management

Electronic Marketplace Solution Catalogue Administrator

3. Brief Description

Once the supplier catalogue has been updated with the new products and/or promotions, and the supplier has provided the data on the general/specific user profile they would like to push their new products and/or promotions. The Customer Management Suite should update the buyer's saved lists.

For an existing item on a retailer list, if it is on promotion then the price for that item should be updated

For promotional sku's generated by the supplier, since they do not exist on the retailer list will not be pushed but will be added to the hot deals page

4. Flow of Events

4.1 Basic Flow

Supplier sends the product, promotions, and user profile data

Electronic Marketplace Solution Catalogue Administrator loads the data to the supplier catalogue, in the respective category, i.e. new products in the new products category, and the promotions in the promotions category

The Electronic Marketplace Solution catalogue administrator during the load data process would have automated the process to push items to the respective buyer's list by updating the users profiles

Electronic Marketplace Solution catalogue administrator generates new products or new promotions alert

The buyer logs in and views the alert with regards to the new products/promotions based on profile

Buyers, based on user profile, access saved lists and add/delete items

4.2 Alternative Flow(s)

Buyer does not have correct access to view new products/promotions

Either the user profile for the buyer has not been updated to reflect the correct access for those items, in which case the catalogue administrator should be able update their profile

5. Special Requirements

Release 1

Semi-automated alerts should be generated to notify buyers about new/promotions products

User should have the ability to add new products to their lists from the Electronic Marketplace Solution website

Automatically delete catalogue items once the end date passes. Item will be deleted from saved lists/carts if no longer on master catalogue file

Semi-automated process by which items are pushed to the retailer list/cart

Release 3

New/Promotional products should be highlighted (high priority, release 3)

Alerts should be automatically generated to notify the buyers about new/promotional products

The respective shopping lists should be updated automatically based on the user profile provided by the supplier.

Promotion item is pushed to buyer's saved lists/carts if the item is already on the list at regular price. There are issues surrounding the “how” because promotions are often based on effective dates.

Scripts to automate process of updating lists

Multi-enterprise catalogue functionality

Phase 1

Develop interface between Electronic Marketplace Solution catalogue and the Electronic Marketplace Solution managed POS/BOS system to synchronise the product master file in POS/BOS with the retailers saved list/cart in CM

Develop translation tables to synchronise the product master file in CO POS/BOS with their saved list/carts in CM. Update data file will be transmitted to the system administrator at the CO POS/BOS, and they have the option to accept/reject those changes

6. Pre-Conditions

Supplier data on new/promotional products has been successfully loaded into the catalogue

User profiles have been updated to reflect their ability to access/add these products to their lists

7. Post-Conditions

Buyers have updated lists.

8. Data Requirements

User profile data

New product catalogue data

Promotion data

9. Interfaces

Develop interface between Electronic Marketplace Solution catalogue and the Electronic Marketplace Solution managed POS/BOS system to synchronise the product master file in POS/BOS with the retailers saved list/cart in CM

Develop translation tables to synchronise the product master file in CO POS/BOS with their saved list/carts in CM

Use Case Specification: <Load/Maintain Data>

1. Use Case Diagrams

Catalogue Maintenance: Master Catalogue and Associated Views

Catalogue Maintenance: Maintain Promotions

Catalogue Maintenance: Maintain Pricing

2. Use Case Actors

Customer Management

Electronic Marketplace Solution Staging Area

Buyer

3. Brief Description

This use case describes the process of loading/maintaining in the CM. After data is verified, Electronic Marketplace Solution catalogue administrator will load the data from the Electronic Marketplace Solution catalogue staging area into the CM system. This process could be used to load the supplier catalogue data, user saved list data, user profile data, pricing data, promotion data, supplier/buyer translation table data.

4. Flow of Events

Basic Flow

The Electronic Marketplace Solution catalogue administrator has run the verification script

The Electronic Marketplace Solution catalogue administrator starts the script to load the data from the Electronic Marketplace Solution staging area to the CM suite

When the load run is complete, the Electronic Marketplace Solution catalogue administrator reviews the log file to validate the number of records loaded, and the number of records that were rejected

The different data streams get loaded to their respective tables, i.e. price cube, supplier's catalogue, promotion summary page, and the translation tables

An exception report is generated indicating records that were not loaded and the reason for the record failure

The basic flow applies to the following:

Product data into supplier catalogues (updates, new products, promotions)

Price cube

Promotion summary page

Supplier/Buyer translation tables

Alternative Flow(s)

The Customer Management is unable load the file

Error message should be transmitted to Electronic Marketplace Solution catalogue administrator

Electronic Marketplace Solution catalogue administrator should review file and resolve issue

Electronic Marketplace Solution catalogue administrator reloads data

The buyer sends file of new items, entered in POS/BOS

Buyer has added a new item to their POS/BOS system

Buyer transmits file containing new items added to their POS/BOS system

Buyer notifies Electronic Marketplace Solution administrator of pending data transfer

Electronic Marketplace Solution administrator runs script to load data into buyer's specific list, only if the item is part of the Electronic Marketplace Solution catalogue

An exception report is generated indicating records that were not loaded and the reason for the record failure

Updating buyer profiles

The Electronic Marketplace Solution catalogue administrator has updated the supplier catalogue (product updates, new items, promotion items)

The Electronic Marketplace Solution catalogue administrator will the run the script to update the buyer profile based on the supplier criteria

The buyers profile is updated and their saved lists now show the new/promotion products the supplier is targeting at them

POS/BOS passes suggested order list to Electronic Marketplace Solution

POS/BOS generates list

Electronic Marketplace Solution systems generate a PO for suppliers in Electronic Marketplace Solution catalogue

Electronic Marketplace Solution person manually orders items from suppliers that are not in Electronic Marketplace Solution catalogue (note: for pilot only)

5. Special Requirements

Release 1

Electronic Marketplace Solution staging area will need to be developed. Directory structure for release 1

Enable products based on start and end dates. Develop product effectivity date functionality, this will allow products to be viewed between their start and end dates

Data should be loaded in a batch process, and not one item at a time

Basic script to generate error file for exception handling

Basic scripts to load data to catalogue (basic scripts, semi-automated)

Scripts to update translation tables (basic scripts, semi-automated for pilot)

Develop the custom price cube, and the scripts to load the data (we will need to develop the data model)

Release 3

Multi-enterprise catalogue functionality

Staging area to verify data and begin load to CM.

When loading supplier catalogue data, the new products or promotions should be pushed to the buyer's saved lists based on user profile information. This process has to be automated (multi-enterprise catalogue functionality) (Manual process for pilot)

Automate the process to load data into CM tables

Seamless process

Script to generate error file for exception handling when loading the data. This script should incorporate intelligence indicating what caused the data to be rejected or why certain records failed

Error message should be sent to Electronic Marketplace Solution catalogue manager when data cannot be loaded. The message should include error codes.

Scripts to load data in supplier catalogue, buyer specific list, etc., based on user profile Scripts to enable maintaining user profiles to automate the push of items

Scripts to update translation tables

Phase 1

To maintain the data in the retailers POS/BOS system that is managed by Electronic Marketplace Solution, an interface will be developed to synchronize the product master file and the Electronic Marketplace Solution catalogue. Thus when a retailer adds a product to their saved list/cart in CM, the change will be replicated to the POS/BOS via this interface

To maintain the data in the CO POS/BOS system, when an item is added/updated to their list/cart in CM, the CO administrator will have to add that item into their POS/130S before it can be ordered, since their system has precedence over the list/cart in CM. Once they have added an item to their POS/BOS, they will have to send the translation tables data so as to synchronize these two data files. The HOS for CO has the prerogative to accept/reject list/cart updates data

No maintenance will be performed for retailers who have independent POS/BOS, they will have to choose between the above two options

Retailers with no POS/BOS, and who do not have Electronic Marketplace Solution maintained POS/BOS system, there will be no data loads, since they will procure directly from the web interface

6. Pre-Conditions

Data is in the correct format to be loaded into CM

Data has been verified and we have a clean set of data

Data resides in Electronic Marketplace Solution Catalogue Staging Area

Develop translation tables for Electronic Marketplace Solution and CO supplier/product data. If we enforce the rule that they provide us EAN product numbers along with the respective supplier id's, we would then have to only maintain translation tables for the supplier id's assigned by the CO POS/BOS system and the Electronic Marketplace Solution assigned supplier id's

7. Post-Conditions

Supplier Data has been updated in Customer Management System

Buyer saved lists have been updated

Retailer profiles have been updated

Supplier/Buyer translation tables have been updated

Price cube has been updated

8. Data Requirements

Supplier Catalogue—Product data attributes

Pricing—Supplier ID, Product ID, Customer ID, Nett Price

User Profile—attributes to be defined

Promotion's summary page—attributes

Supplier/Buyer translation table data requirements

BOS/POS data attribute

Product effective dates

9. Interfaces

The process by which data is loaded into the system will be via a batch job; the frequency of this load will depend on when suppliers/buyers send Electronic Marketplace Solution updates

Develop interface with POS/BOS for loading suggested order

Develop interface between Electronic Marketplace Solution catalogue in CM and the Electronic Marketplace Solution managed POS/BOS system to synchronize the product master file and the Electronic Marketplace Solution catalogue.

Use Case Specification: <Maintain Electronic Marketplace Solution/Supplier/Buyer Translation Tables>

1. Use Case Diagrams

Catalogue Maintenance: Master Catalogue and Associated Views

2. Use Case Actors

Electronic Marketplace Solution Catalogue Administrator

Customer Management

3. Brief Description

Translation tables need to be maintained to map the different unique identifiers in the back office systems of the supplier, buyer, and Electronic Marketplace Solution. The following tables need to be maintained:

Supplier SKU—APN Number

Buyer SKU—APN Number, Buyer TUN Number

Electronic Marketplace Solution SKU—APN Number

APN Number

Supplier maintained Customer ID's—Electronic Marketplace Solution maintained Customer ID's

Buyer maintained Supplier ID's—Electronic Marketplace Solution maintained Supplier ID's

4. Flow of Events

4.1 Basic Flow

Electronic Marketplace Solution Catalogue Administrator requests data from each entity in the trading exchange

Electronic Marketplace Solution Catalogue Administrator loads data into the appropriate table

When an entity, for example the supplier adds a new item or maintains an existing item in their ERP, they provide Electronic Marketplace Solution with their SKU Number and the corresponding APN number in a flat file

Electronic Marketplace Solution Catalogue Administrator adds/updates the translation table in CM, if it is a new item Electronic Marketplace Solution will assign an internal identifier

4.2 Alternative Flow(s)

Supplier adds/maintains customer in their ERP

Buyer adds/maintains item in their POS/BOS

Supplier adds/maintains an item

Buyer adds/maintains supplier in their POS/BOS

The Electronic Marketplace Solution catalogue administrator will follow the steps of the basic flow outlined above, but a different translation table will be updated depending on the action performed

Electronic Marketplace Solution—Electronic Marketplace Solution maintained POS/BOS system

For those retailers that have Electronic Marketplace Solution maintained POS/BOS systems, we will establish the rules for how the product, and supplier information is maintained, this will to eliminate the need for translation tables, as products in the POS/BOS system will be assigned the EAN number, and the supplier of that product will be assigned the quarto supplier number in the POS/BOS

Electronic Marketplace Solution product information—Supplier Product information

The rule has to be established that when a supplier sends us their product information, the EAN number along with the Electronic Marketplace Solution assigned id for that supplier is part of the product data file. The EAN number along with the Electronic Marketplace Solution assigned supplier id will be the unique identifier for that item, this is because a product can be procured from multiple suppliers

Electronic Marketplace Solution product information—CO POS/BOS systems

A. For those CO POS/BOS systems that store EAN numbers, we would not need translation tables for the products since this is the industry standard, and in the Electronic Marketplace Solution catalogue we are storing the products per EAN numbers

B. For those CO POS/BOS systems that do not store EAN numbers, we would have to maintain translation tables between their SKU and the EAN in Electronic Marketplace Solution

C. For the supplier id's stored in the product master file of the CO POS/BOS system, we would have to maintain translation tables

5. Special Requirements

Release 1

Business rules that govern the maintaining of these translation tables (data format, time, frequency)

Basic scripts to load/verify data

Translations tables will need to be custom built in the CM suite. High priority, must be in release 1 of pilot, Medium level of work

Release 2

Scripts to load/verify data into translation tables. Low priority, high level of work. Needs to be automated for release 3

Multi-enterprise catalogue functionality (note: Supplier and customer ID will still have to be maintained even after the multi-enterprise catalogue roll out for release 3)

Electronic Marketplace Solution—Electronic Marketplace Solution maintained POS/BOS system

For those retailers that have Electronic Marketplace Solution maintained POS/BOS systems, we will establish the rules for how the product, and supplier information is maintained, this will eliminate the need for translation tables, as products in the POS/BOS system will be assigned the EAN number, and the supplier of that product will be assigned the quarto supplier number in the POS/BOS

Electronic Marketplace Solution product information—Supplier Product information

The rule has to be established that when a supplier sends us their product information, the EAN number along with the Electronic Marketplace Solution assigned id for that supplier is part of the product data file. The EAN number along with the Electronic Marketplace Solution assigned supplier id will be the unique identifier for that item, this is because a product can be procured from multiple suppliers

Phase 1

Electronic Marketplace Solution product information—CO POS/BOS systems

A. For those CO POS/BOS systems that store EAN numbers, we would not need translation tables for the products since this is the industry standard, and in the Electronic Marketplace Solution catalogue we are storing the products per EAN numbers

B. For those CO POS/BOS systems that do not store EAN numbers, we would have to maintain translation tables between their SKU and the EAN in Electronic Marketplace Solution

C. For the supplier id's stored in the product master file of the CO POS/BOS system, we would have to maintain translation tables

6. Pre-Conditions

Each entity can provide the specified information

Translation tables have been set-up in customer management

Interface has been established to update translation tables between modules of

7. Post-Conditions

Translation tables are in synch with the different back office systems

8. Data Requirements

APN Number

Supplier maintained Customer ID's

Electronic Marketplace Solution maintained Customer ID's

Buyer maintained Supplier ID's

Electronic Marketplace Solution maintained Supplier ID's

Supplier SKU Number

Buyer SKU Number

Electronic Marketplace Solution assigned internal number

Buyer TUN Number

9. Interfaces

POS/BOS to Electronic Marketplace Solution

Electronic Marketplace Solution to supplier

Between modules of

Use Case Specification: <Generate Message>

1. Use Case Diagrams

Catalogue Maintenance: Master Catalogue and Associated Views

2. Use Case Actors

Electronic Marketplace Solution Catalogue Administrator

Customer Management

3. Brief Description

This use case describes the process of generating and sending the “Alert” message to inform users when Electronic Marketplace Solution receives new supplier data (new products or promotions). CM will generate an “Alert” message that the user will see on the Electronic Marketplace Solution screen. This message will inform the user that new products/promotions are available.

4. Flow of Events

4.1 Basic Flow

A supplier catalogue has been updated with new products and promotional products

CM determines which users should see which products based on user profile information

CM generates “Alert” message to inform users about the new supplier data

CM sends (or posts) the “Alert” message to the appropriate user's Electronic Marketplace Solution website

4.2 Alternative Flow(s)

The “Alert” message is not generated

The “Alert” message is not generated even though there is new supplier information that matches various user profiles

Electronic Marketplace Solution catalogue administrator should monitor the process to ensure that messages are created and sent

5. Special Requirements

5.1 Release 1

Semi-automated process to generate alerts and send them to buyers, this function will be performed by the catalogue administrator

5.2 Release 3

Button in the “Alert” message that will take the user directly to the list of new products or hot deals (low priority, release 3)

“Alert” messages automatically generated and sent to users based on the user profile. Note: Automating this process would be simple for a general message to all users, but very difficult to customize, based on user characteristics.

6. Pre-Conditions

Supplier has submitted new product data or promotions data

Electronic Marketplace Solution catalogue administrator was able to load new data in Electronic Marketplace Solution catalogue

User profile gives access to user to view new products and promotions

New products/promotions summary page has been set up

User profiles have been updated

Saved lists have been updated

7. Post-Conditions

User receives “Alert” message informing them of new products or promotions

8. Data Requirements

Product attributes

User profile attributes

Pricing attributes

Promotion attributes

Message Details

9. Interfaces

Use Case Specification: <Generate Frequently Ordered List>

1. Use Case Diagrams

Catalogue Maintenance: Maintain Frequently Ordered List

2. Use Case Actors

Buyer

Order Management Suite or POS

3. Brief Description

This use case describes the vision of generating a frequently ordered list based on PO history. This list would include frequently ordered products and quantities. The PO history would be extracted from Electronic Marketplace Solution or from the retailer's POS/BOS. The frequently ordered list could be generated by clicking on a button in the Electronic Marketplace Solution website. PO history is analyzed and the frequently ordered list is generated. The buyer can review the list, modify the list, and/or make the list into an order.

4. Flow of Events

4.1 Basic Flow

Buyer initiates new session

Buyer decides to generate a frequently ordered list

Buyer click on button to generate list based on PO history

CM accesses PO history to generate the frequently ordered list

List is displayed in web user interface

Buyer reviews list

Buyer may modify list, save list, and/or make the list into an order

4.2 Alternative Flow(s)

Buyer would like to delete an item from the Frequently Ordered List

Buyer opens his saved frequently ordered list

Buyer selects item to delete

Buyer clicks on “Delete Item” button

CM removes item from buyer's frequently ordered list

CM save changes to frequently ordered list

5. Special Requirements

1. Release 1

User will manually update the frequently ordered list for pilot. With in CM a use can develop different saved carts that are essentially their frequently ordered list. Work around: It may be possible to treat the Frequently Ordered List similar to the suggested order list. The buyer would than be able to make the frequently ordered list an order or keep it as a saved cart

The Buyer should be able to modify the frequently ordered list

The Buyer should be able to save the cart and access it in the future

Buyer should be able to make the frequently ordered list into an order

2. Release 3

Generate the frequently ordered list, based on PO history that is stored in either POS/BOS or in the order management system in Electronic Marketplace Solution. To automate this process we would have to build custom scripts based on some rules that would look at the different PO's and then generate the list

6. Pre-Conditions

Buyer initiates new session

Supplier catalogue has been maintained

User profiles have been set-up

There is PO history available to generate the frequently ordered list

A button has been created that will generate a frequently ordered list based on PO history when a buyer clicks on it

Business rules to generate the frequently ordered list have been established and maintained

7. Post-Conditions

Buyer has created a frequently ordered list

Buyer can view the frequently ordered list

Buyer can added an item to the frequently ordered list

Buyer can deleted an item on the frequently ordered list

Buyer can change a quantity on the frequently ordered list

Buyer can save the frequently ordered list

8. Data Requirements

Catalogue data requirements

PO history from Electronic Marketplace Solution or POS/BOS

Business rules for generating and maintaining frequently ordered list

User profile requirements

9. Interfaces

If frequently ordered list is generated based on PO history from retailer's POS/BOS, CM would need to interface with POS/BOS.

Use Case Specification: <Verify Data>

1. Use Case Diagrams

Catalogue Maintenance: Master Catalogue and associated Views

Catalogue Maintenance: Maintain Promotions

Catalogue Maintenance: Maintain Pricing

2. Use Case Actors

Electronic Marketplace Solution Catalogue Administrator

Electronic Marketplace Solution Catalogue Staging Area

3. Brief Description

In this use case the Electronic Marketplace Solution catalogue administrator starts the verification scripts to ensure that the supplier/retailer data has been formatted to the Electronic Marketplace Solution standard. The scripts should ensure that referential integrity is maintained. The Electronic Marketplace Solution catalogue administrator will generate a list of those records that fail. The output of this step is to have clean data before loading CM suite.

4. Flow of Events

4.1 Basic Flow

Electronic Marketplace Solution catalogue administrator has loaded data files into the dump tables in Electronic Marketplace Solution catalogue staging area

Electronic Marketplace Solution catalogue administrator runs the data verification script on the supplier/retailer provided data

On successful completion of the script, data is ready to be loaded into CM

4.2 Alternative Flow(s)

Verification script generates invalid data

Electronic Marketplace Solution catalogue administrator reviews data file to resolve issues

If issues are successfully resolved, data is ready to be loaded to CM suite

If issues are not resolved, Electronic Marketplace Solution catalogue administrator should run script to generate exception report

Electronic Marketplace Solution catalogue administrator should send exception report to appropriate supplier/retailer for resolution

5. Special Requirements

1. Release 1

Electronic Marketplace Solution has defined the different data format and integrity rules around the different reference tables, such as UOM, Category, etc.

Generate exception report scripts

Basic data verification scripts

Staging area to test data before data is loaded CM suite. (Use directory structure for pilot). Basic scripts for loading, verifying, and generating exception reports

1. Release 3

Data verification scripts, with intelligence built into the error report detailing the reason the record failed

Multi-enterprise catalogue development

6. Pre-Conditions

Data verification scripts have been developed

Electronic Marketplace Solution Staging Area has been set-up

Suppliers/retailers have provided files in Electronic Marketplace Solution format, and they have developed the required data extraction scripts

Script to generate exception report

Data file from the supplier/retailer has been down loaded to the Electronic Marketplace Solution staging area

Error Codes have been defined

7. Post-Conditions

Data file has been verified, and records have been marked as accept, or reject

Exception list has been generated, and is ready to be transmitted to the supplier/retailer for resolution (if the Electronic Marketplace Solution Catalogue Administrator cannot resolve the issues)

8. Data Requirements

Product attributes

Customer profile attributes

Pricing attributes

Promotion attributes

Error codes

Translation table data

9. Interfaces

Use Case Specification: <Review/Resolve Exceptions>

1. Use Case Diagrams

Catalogue Maintenance: Master Catalogue and Associated Views

Catalogue Maintenance: Maintain Pricing

Catalogue Maintenance: Maintain Promotions

2. Use Case Actors

Electronic Marketplace Solution Catalogue Administrator

Electronic Marketplace Solution Catalogue Staging Area

Supplier ERP

Buyer

3. Brief Description

In this use case the Electronic Marketplace Solution catalogue administrator will review the exception records that are generated once the verification scripts have been run, or for those records that were rejected during the data load process. The verification scripts will generate the list of all the records that do not match the Electronic Marketplace Solution catalogue data format. The scripts will also track those records that fail with the database integrity rules. The Electronic Marketplace Solution catalogue administrator reviews/resolves issues on exception report. If Electronic Marketplace Solution catalogue administrator is unable to correct records, the data will be sent back to the supplier/buyer for review and resolution.

4. Flow of Events

4.1 Basic Flow

Electronic Marketplace Solution catalogue administrator has performed either the verify data or data load process

Exception report for error records will be generated with error codes

Electronic Marketplace Solution catalogue administrator will review records, and resolve issues

If the issue can be resolved, the Electronic Marketplace Solution catalogue administrator loads data

4.2 Alternative Flow(s)

Electronic Marketplace Solution Catalogue Administrator cannot resolve the exceptions

The Electronic Marketplace Solution Catalogue Administrator will send the exceptions list to the respective supplier or buyer for resolution

5. Special Requirements

1. Release 1

Exception reports should be in a format that is acceptable to the supplier/buyer, so they can resolve the errors quickly

Data should be loaded in a batch process, and not one item at a time

Basic scripts to verify data, load data, generate exception reports

Staging area to test and hold data. (Use directory structure for pilot)

2. Release 3

Verification scripts with intelligence to list the attribute and the error (develop basic scripts for pilot, but intelligent error reporting will be needed for release 3)

Multi-enterprise catalogue functionality, thus the supplier will be responsible for maintaining their catalogue

6. Pre-Conditions

Data verification scripts/data load has been run

Exception report has been generated

Error codes have been defined

7. Post-Conditions

Electronic Marketplace Solution catalogue administrator resolves the exceptions and the data is ready to load

Supplier/buyer has received the exceptions list, and is in the process of resolving the issue

8. Data Requirements

Product attributes

Pricing attributes

Promotion attributes

User Profile attributes

Buyer translation table

BOS/POS requirements

Saved list data requirements

The exception report should have an error code field

9. Interfaces

We need to follow up on interface details. This is still unresolved.

Use Case Specification: <Review Promotions>

1. Use Case Diagrams

Catalogue Search and Browse

2. Use Case Actors

Supplier

HO Category Manager

Buyer

Site Staff 1

Site Staff 2

Customer Management Supplier, HO Category Manager, Buyer, and Site Staff 1 and Site Staff 2 could be users

3. Brief Description

This use case describes how users, based on their user profiles, will review promotions during search, browse, and order capture activities. The user should also be able to go directly to the list of items that are on promotion by selecting the promotions summary page. The user should be able to drill down on the item to view the promotion details, such as min/max order quantity, expiration date, special packaging, discounts etc

4. Flow of Events

4.1 Basic Flow

The user initiates their session

The user selects the promotions summary page

The user reviews the list of items on promotion

The user clicks on the view special details button

The user is then taken to the promotions template where they can review the details

The user then has the choice of going back to the promotions list, or adding the item to their shopping cart.

4.2 Alternative Flow(s)

User is in the order capture process

The user is currently in the process of reviewing their order list

Those items on promotion will have an icon (for e.g. a star) to designate that they are on promotion. The user should be able to view the details on the promotion by clicking on the view special details button

The user is then taken to the promotions template, where they can either go back to the order list, or go to the edit order page to adjust the line item

User is in the process of searching for an item

The user is currently in the process of searching for an item. The user is presented with the result set

Those items on promotion win have an icon (for e.g. a star) to designate that they are on promotion. The user should then be able to view the details on the promotion by clicking on the view promotion details button

The user is then taken to the promotions template, where they can either go back to the search page, or select the item and add it to their shopping cart

5. Special Requirements

5.1 Release 1

Promotion details can be accessed by clicking on the item. This is a link to a static page that contains the promotion details (the description of the promotion)

To view the promotion details, the promotion description text will have to be rendered in some format. All the promotion details, such discounts, etc. will have to be part of the promotion description

Hot deals page. Static text page for pilot

If a price changes on an item so that it is considered on promotion, the APN should remain the same. If there is some other type of change, a new APN should be created

5.2 Release 3

Promotions are displayed when the user is performing the following functions: Search, Browse, Order Capture

Promotions can be targeted to buyers that fit the profile defied by the supplier

Set up hot deals summary page to list items from all suppliers and show items by category, by product group, by line item. The catalogue will have to be modeled to accommodate this functionality

Automate the process by which the user profile is updated to grant/deny access to a promotional item

Automating the process by which promotional items are pushed to the buyer's lists based on the profile provided by the supplier (will accept workaround for pilot, workaround is sending an alert to user about new promotions, this issue will be easier to solve with Aspect functionality that should be available in for release 3). High Priority

Set up special indicator to designate an item is on promotion during search/browse/order capture (different color indicator is preferred by Electronic Marketplace Solution). High Priority

Promotions are displayed based on start and end dates, i.e. set up effective date functionality, this will drive when the item is available to be viewed

5.3 Phase 1

Develop rules to match promotion restrictions such as min/max order amount, effective dates, etc. when the item is added to the shopping cart

Click count on hot deals summary page, advertising banners, etc.

Since generates a unique number for items on promotions, it will be difficult for the supplier/buyer to analysis data for reporting reasons. Workaround: Electronic Marketplace Solution maintains translation tables between the regular SKU number and the Promotional SKU number

6. Pre-Conditions

Supplier's catalogues/lists/cart/promotions summary page have been set-up

User profiles have been set-up based on supplier target market data (i.e. profiles, specific retailers)

Promotional data has been set-up based on data provided by supplier details

Promotions summary page has been set up

7. Post-Conditions

User has reviewed promotion details

User has selected an item to add to cart

User has selected items for comparison

8. Data Requirements

Start/End Date

APN Number

Promotion Tag Line

Discount %

Promotion Description

Min Order Amount

Max Order Amount

Target Market Profile Data

Retailer ID

9. Interfaces

Pricing cube has been set-up in Customer Management. This price cube contains pricing per supplier, per customer, per product. The pricing data load from the supplier ERP system should be a batch load process.

Use Case Specification: <Review/Add/Delete Available Item>

1. Use Case Diagrams

Catalogue Maintenance: Maintain Company List

Catalogue Maintenance: Maintain Frequently Ordered List

Catalogue Maintenance: Maintain My List

Catalogue Maintenance: Maintain Promotions

2. Use Case Actors

HO Category Manager (in detailed text below, the term “buyer” includes HO Category Manager)

Buyer

Theo

Customer Management

3. Brief Description

This use case outlines how a buyer can add products to their saved lists or cart. The following options are available:

Buyer reviews products that are available based on user profile. Buyer adds items to a saved list/cart. For example, in a convenience organized setting the HO category manager would add products to the company list. The MSF store manager would add items to my list. For convenience independent, the store manger/owner would be able to update lists.

Buyer reviews new product lists and adds items to a saved list or cart

Buyer reviews hot deals page and adds items to a saved list or cart

4. Flow of Events

4.1 Basic Flow

Buyer reviews products available

Buyer reviews new product lists and promotions lists

Buyer finds products to add to one of their saved lists or cart

Buyer clicks on a button next to the item to add the item to a saved list or cart

CM saves the buyer's lists/carts

The buyer can access the lists/carts in the future

The user profile has to be maintained based on the supplier provided data to limit which items a buyer can access.

4.2 Alternative Flow(s)

Buyer does not want to add any items to a saved list

Buyer reviews supplier catalogues, new product lists, and promotions

Buyer does not want to add any items to a saved list

Buyer should be able to exit product list without selecting items

Buyer should be able to access other Electronic Marketplace Solution screens

Buyer would like to delete items from saved lists or cart

Buyer reviews saved list or cart to modify

Buyer selects item to delete

Buyer clicks on “delete” item button

Item is removed from saved list or cart

The list/cart is saved

5. Special Requirements

1. Release 1

Button that enables buyer to add item to a list/cart

Button that enables buyer to delete item from list/cart

Current functionality is acceptable, with regards to add/delete of an item

Semi-Automated process to push items based on user profile. The catalogue administrator will have to perform this function

2. Release 3

Button or Drop down box where buyer can choose which list to add the item

Automated push of new products and promotions based on user profile. Automated generation of alert message, informing users that there are new/promotion products available. (Semi-automated process for pilot. To determine the level of automated for release 3)

6. Pre-Conditions

Buyer initiated new session

Buyer has the appropriate profile to view items

Supplier catalogue has been updated

User profile has been set up

7. Post-Conditions

Item is added/deleted to one of the buyer's saved lists/cart

Buyer can access other screens in Electronic Marketplace Solution instead of adding an item to a saved list

After the buyer has added an item, they need to ensure that their respective POS/BOS system has also added the same item before it can be ordered through Electronic Marketplace Solution

8. Data Requirements

User profile

Product information

Pricing information

Promotions information

9. Interfaces

POS/BOS needs to be updated with new product information

Use Case Specification: <Notify Community of Changes/Adds/Deletes>

1. Use Case Diagrams

Catalogue Maintenance: Maintain Company List

2. Use Case Actors

HO Category Manager

Customer Management

3. Brief Description

This use case describes how the HO would notify the user community about changes, adds, and deletes to the company list. For example, when new products are available for the buyer to order or add to a saved list.

4. Flow of Events

4.1 Basic Flow

Electronic Marketplace Solution catalogue administrator uses a semi-automated process to send out alerts. The alerts will be generated after the Head Office has made an update that will affect a buyer's list. The alert will contain information about the update.

The buyer can act on this alert by updating saved list/cart

4.2 Alternative Flow(s)

4.2.1 Alerts are automatically generated

Alerts are automatically generated based on user profile

Electronic Marketplace Solution catalogue administrator would not have to manually send out alerts

4.2.2 Buyer's lists are automatically updated

The updates are pushed out based on user profile

This automated functionality would eliminate the alert step of the use case

The automation would also eliminate the need for the buyer to manually update saved list/cart

5. Special Requirements

1. Release 1

Electronic Marketplace Solution catalogue administrator should be able to generate alert message to send to the user communities

2. Release 3

Automated push of updates to buyer lists/carts

Automatic update of buyer's saved lists/cart (high priority, but will not be available until release 3, multi-enterprise catalogue)

Automated alert generation (low priority, this will be a semi-automated process for release 1)

6. Pre-Conditions

Catalogue data has been updated

User profiles have been set-up

7. Post-Conditions

Buyer is updated about changes

Buyer modifies saved list/cart

Buyer reviews updates

8. Data Requirements

User profiles

Product data

9. Interfaces

Use Case Specification: <Browse>

1. Use Case Diagrams

Catalogue Search and Browse

2. Use Case Actors

Supplier

HO Category Manager

Buyer

Site Staff 1

Site Staff 2

Customer Management Supplier, HO Category Manager, Buyer, and Site Staff 1 and Site Staff 2 could be users

3. Brief Description

This use case describes the browse function. A user can browse by a specific supplier's catalogue, and with in the different categories like, product category, promotions, or new products

The user should be able to browse based on product category (Cigarettes), and then be able to drill down into the brand group (B&H, Coca Cola), product group with in the brand group (B&H 100's)

The default browse list should be my list

The user should have the ability to change default settings to another list/catalogue

4. Flow of Events

4.1 Basic Flow

User initiates session

User selects the browse tab, the default browse list should be my list

The user should be able to browse by Supplier, Product, saved cart/list, or the promotions summary (hot deals page). The user clicks on the go button to retrieve the result set

User is then presented with the result set

User can select an item and add them to cart/list

User can select an item and delete it from cart/list

User can drill down on each product for more details about pricing, packaging etc.

User can select more than one item and do a comparison. User has option to add item(s) to cart/list

4.2 Alternative Flow(s)

User cannot find product via browsing

User cannot find desired information

User can access help functionality by clicking on the browse help tab

User can view a static help page that explains how the browse functionality works

User chooses another cart/list/catalogue to browse

User selects a cart/list/catalogue to browse

User clicks on the go button

Results set is returned

User can perform all the functions listed in the basic flow

User selects the promotions summary (hot deals) page

User selects the promotions summary page (hot deals page). This page lists all the products that are on promotion from the different suppliers

User selects more than one product and does a comparison

User adds item(s) to cart or continues to browse

5. Special Requirements

1. Release 1

Standard functionality, there will be no default browse list, as the user can choose the list/cart from the navigation bar.

User should be able to determine the default browse list. Since the current functionality is adequate for browsing, there is no default list. Standard functionality is accepted, the user can choose via the navigation bar which catalogue/list/cart they would like to browse

User should be able to browse by product category, manufacturer, and product group. we would have to, model the catalogue as a single catalogue, the hierarchy of the catalogue will be Category/Brand/Supplier/Product

User should be able to add item to the cart or to a saved list. In you can maintain only one list, but you can have multiple saved carts

System should confirm when item is added to shopping cart or saved lists. When you add an item to a list/cart, you are taken to the list/cart where the item has been added, but there is no system prompt

Hot deals summary page. This will be a static page is for release 1

Develop static page for browse help functionality. Consolidate the help functionality into one for search/browse, this will be a basic help page

Modeling for the catalogue should be in the following order: Category, Brand, Supplier, and Product

2. Release 3

Hot deals page lists all items from different suppliers that are on promotion. Page should be set up by category, by brand, by line item

User should be able to choose the cart/list they want to add items. Current functionality is that users pick list and than adds item to it, this will be acceptable for release 1, but would like functionality for release 3

Automatic targeted promotions based on supplier provided user profiles (high level of work, not necessary for pilot, functionality should be in release 3, where by we can identify and highlight existing items that are on promotion in a particular users list/cart)

One alternative item determined by supplier (this is low priority functionality, required for release 3 implementation. The work around for this would be to have the supplier suggest an alternative item, which will be stored as an attribute for the item)

6. Pre-Conditions

User has initiated new session

Supplier catalogue, user specified list, and shopping cart have been set-up

User profiles set up. This is how a specific user can only access certain categories in the supplier catalogue, as well as which catalogues, shopping lists, and shopping carts they have access to

Promotions information has been set up in the supplier catalogue and the user profile has been updated so that they can access the items

Promotions summary page has been set up

7. Post-Conditions

User can drill down and has found item(s)

User can select items and add to cart or saved lists

User can start a search, by going to the search button

User can choose to browse a different list or catalogue

8. Data Requirements

Product Name

Catalog number

Line Item number

APN number

Description

Size

Nett Price

Min/Max Order Qty (this will be an attribute of description)

Recommended Retail Price (RRP)

Promotional information

Supplier number

Packing conversion (number of each per pack)

User profile data

Supplier—Post Code table

Retailer's Post Code

Search Terms, per product. Additional product attributes; for example: retailers may call Winfield Ultra Lights as Winfield Blue

Alternative item determined by supplier (only one alternative item will be modeled)

9. Interface Requirements

Pricing cube has been set-up in customer management. This price cube contains pricing per supplier, per customer, per product. The pricing data load from the supplier ERP system should be a batch load process. Assumption: Electronic Marketplace Solution will not calculate GST.

The price cube will also have the RRP price. This requirement is for the POS/BOS system

Use Case Specification: <Search>

1. Use Case Diagrams

Catalogue Search and Browse

2. Use Case Actors

Supplier

HO Category Manager

Buyer

Site Staff 1

Site Staff 2

Customer Management Supplier, HO Category Manager, Buyer, and Site Staff 1 and Site Staff 2 could be users

3. Brief Description

This use case describes searching across an supplier catalogues, a specific supplier catalogue, saved lists/carts, frequently ordered list, promotions summary page (hot deals page). This use case also describes searching a category within a supplier's catalogue using a parametric search (this is an attribute based search).

4. Flow of Events

4.1 Basic Flow

User initiates session

User selects the search button

The default search list will be company/store list

The user will have the ability to choose a different catalogue/list to search, by selecting the appropriate list from the drop down box

The user will have the ability to select the criteria to search by. Various search criteria will be listed in a drop down box (i.e. keyword, product name, mfg., etc.)

User inputs specific search terms in the search field (i.e. soda, Coke, 123456, etc.)

User clicks on submit search button

Result set is presented with the product description and nett price from the custom price cube across all suppliers with whom the retailer has trade terms

User can then add items to their list or cart

4.2 Alternative Flow(s)

Item not found (i.e. no results returned).

A message is displayed directing the user to the advanced search link

User can access search tips or search help

5. Special Requirements

1. Release 1

Standard search functionality, which encompasses key word search, and with in a category attribute search (Parametric search)

Click button to frequently ordered list. Work around is to choose the different list/carts from the navigation bar.

Searches are not case-sensitive

If you search by “co” all products beginning with “co” are returned in the result set

Search tips are available via Help functionality. This will be a basic help page

Refine search or new search options. Currently you search by key word, and use the drill down, or parametric search to refine your results, this is acceptable.

The result set presented should also list the catalogue

Ability to add item to cart or list from results page

System should confirm when item is added to shopping cart or saved lists. When you add an item to a list/cart, you are taken to the list/cart where the item has been added

Ability to click on an item and view the details

Nett price needs to be displayed based on the supplier, customer, product

User is restricted to view/search items based on user profile

When searching for an item, the result set should also return those items that are on promotion. For release 1 we are building a static page, if the item on promotion is part of the main catalogue it will be returned in the search, otherwise it will be part of the static page

Hot deals page must be available for pilot, work around is a static page or semi-automatic process of modeling a hot deals catalogue

1. Release 3

Drop-down box to select the catalogue/list/cart to search. This not a needed, as current functionality is adequate

Ability to search on a list/cart. needs to follow-up with their development to see when this will be available

Storeowner should have the ability to set the defaults for the search functionality (i.e. default catalogue/list). This not a high priority, as current functionality is adequate

Set up the promotion summary page that lists all promotions across suppliers, grouped by product category. (high priority, automated functionality needed for release 3, where by promotions are pushed to the retailer list/cart)

Alternative/replacement product offering would need to be modeled in the Replenishment Planner module, and then need to develop solution on how to render it during search/browse (high priority)

6. Pre-Conditions

User initiated session

User profile has been set up

The supplier catalogues/my list/shopping cart/promotion summary page (hot deals page) have been set up

Advanced search, and search tips has been set-up

Help functionality available

Supplier has set up promotions and has included expiration date and promotion detail

Pricing cube has been set-up

Interface between CM and the price cube is active

7. Post-Conditions

Search results displayed

Item can be added to cart/list

User can choose next search or refine search

User can access the frequently ordered list

User can drill down and has found item(s)

User can access help functionality

8. Data Requirements

Keyword

Product Name

Margin

Catalog number

Line Item number

APN number

Description

Size

Nett Price

Min/Max Order Qty (description)

Recommended Retail Price (RRP)

Promotional information

Supplier number

Packing conversion (number of each per pack)

User profile data

Supplier—Postal Code table

Retailer's Postal Code

Search Terms, per product. Additional product attributes; for example: buyers may call Winfield-Ultra Lights, Winfield Blue

Alternative item determined by supplier

9. Interface Requirements

Pricing cube has been set-up in Customer Management. This price cube contains pricing per supplier, per customer, per product. The pricing data load from the supplier ERP system should be a batch load process.

Use Case Specification: <Maintain Catalogue Standards>

1. Use Case Diagrams

Catalogue Maintenance: Master Catalogue and Associated Views

2. Use Case Actors

Electronic Marketplace Solution Catalogue Administrator

Customer Management

3. Brief Description

This use case describes the process by which, the Electronic Marketplace Solution Catalogue Administrator will maintain the following catalogue standards:

Data formats (use GCI standard)

Categories (defined by BAT for pilot)

User roles

User access levels

Store classification (use BAT classification)

UOM conversion rules—use metric (Australian) conversion rules

Reference tables: A reference table is like a look up table and is used to standardize the different values an attribute can have. For example the unit of measure reference table will contain all the allowable uom values—low priority

Promotion template

4. Flow of Events

4.1 Basic Flow

Electronic Marketplace Solution Catalogue Administrator gets request from supplier/buyer for add/updating a reference value

Electronic Marketplace Solution Catalogue Administrator accepts request

Electronic Marketplace Solution Catalogue Administrator updates the catalogue standards, and notifies all parties of the change

4.2 Alternative Flow(s)

Electronic Marketplace Solution Catalogue Administrator rejects request

Electronic Marketplace Solution Catalogue Administrator informs respective party

Electronic Marketplace Solution initiates the update of its catalogue standards

Electronic Marketplace Solution Catalogue Administrator updates the catalogue standards, and notifies all parties of the change

5. Special Requirements

1. Release 1

Basic scripts to load reference tables if required

The Electronic Marketplace Solution catalogue staging area will require the different reference tables, and will have to be maintained by the catalogue administrator. High priority.

2. Release 3

Scripts to automate process

Multi-enterprise catalogue functionality.

6. Pre-Conditions

Initial set up of the data standards, and reference tables has be completed

Supplier/Buyer has initiated request to change

7. Post-Conditions

Updated catalogue standard has been implemented

All parties have been informed of this change, and the effect it shall have when they send data that has to be loaded

8. Data Requirements

UOM reference table attributes (all measures should be metric!)

Data formats (use GCI standards)

Standard categories (defined based on BAT for pilot)

User roles

User access levels

Store classification (use BAT classification/standards for pilot)

International standard format (GCI)

UOM should be defined in catalogue under product description for each item

Note: Price in Electronic Marketplace Solution Catalogue is the nett price. RRP (recommended retailer's price) is handled by POS/BOS. Retailer price to consumers is out of scope for this session, but in scope for POS/BOS and Electronic Marketplace Solution operations

Additional data requirements identified during RSW:

EAN

UPC/UCC

TUN

PLU (unique)

PSEDO PLU

Same across suppliers

Used for produce items

PLU LINK primary product

9. Interfaces

Use Case Specification: <Open Message>

1. Use Case Diagrams

Catalogue Maintenance: Maintain Company List

Catalogue Maintenance: Maintain My List

2. Use Case Actors

Buyer

HO Category Manager

Customer Management

3. Brief Description

This use case describes the process of the buyer opening the “Alert” message in the Electronic Marketplace Solution website. CM will send or post an “Alert” message informing the buyer about new products, products on promotion, and/or other system messages. There should be a button on the message that will take the buyer directly to the list of new products or promotions.

4. Flow of events

4.1 Basic Flow

Buyer sees new message alert in Electronic Marketplace Solution website

Buyer clicks on button to open message, or the message is displayed immediately when buyer logs in

The message informs the buyer about products that are on promotion, new products, and/or other system messages

Buyer clicks on button in message that will take him directly to the new products list or promotions summary page in Electronic Marketplace Solution website

4.2 Alternative Flow(s)

Buyer is unable to open the new message

Buyer should access Help functionality

Buyer could send a message to system administrator

5. Special Requirements

5.1 Release 1

Semi-automated process of generating and sending buyer alert messages

5.2 Release 3

“Alert” messages automatically sent to buyers based on the user profile Button in the “Alert” message that will take the buyer directly to the list of new products available or hot deals summary page (low priority, release 3)

6. Pre-Conditions

Buyer has initiated a new session

CM has generated “Alert” message

CM successfully sent or posted the “Alert” message on the Electronic Marketplace Solution website for a particular buyer, based on user profile

User profile has been set up

7. Post-Conditions

Buyer is able to review the message and act accordingly

Buyer can close the message and access other screens within Electronic Marketplace Solution

8. Data Requirements

Message Details

User Profile Details

New Product Details

Promotions Details

9. Interfaces

Use Case Specification: Check Availability

1. Use Case Diagrams

Available to Promise

2. Use Case Actors

Customer Management

Demand Fulfilment

3. Brief Description

Shopping cart is sent to Demand Fulfilment and stock availability is checked.

Upon accepting the allocation, shopping cart becomes a customer order with status of Open. The customer order is split and sent into purchase orders and sent to individual suppliers.

4. Flow of Events

4.1 Basic Flow

Shopping cart is sent to Demand Fulfilment.

Demand Fulfilment checks stock levels for each line item (can be for multiple suppliers).

Demand Fulfilment sends shopping cart back to Customer Management with available stock information.

Buyer reviews stock allocations.

Buyer clicks Accept and shopping cart is converted to an open customer order.

Customer order is split into purchase orders.

Purchase orders are sent to individual suppliers.

4.2 Alternative Flow(s)

4.2.1 Desired quantity is not available and buyer accepts order anyway

When there is not enough stock in Demand Fulfilment to meet the desired quantity levels, the Buyer has the ability to still place the order.

Demand Fulfilment returns to Customer Management saying the desired quantity is not available.

Buyer clicks on Accept without adjusting quantities.

Demand Fulfilment sends the purchase order directly to the supplier.

4.2.2 Desired quantity is not available and buyer adjusts the quantity, finds substitute products or suppliers, or deletes the line item.

When there is not enough stock in Demand Fulfilment to meet the desired quantity levels, the Buyer has the ability to change the line items on the order.

Buyer clicks on Change Order.

Buyer returns to shopping cart to add/edit/delete products and quantity (see Add to Shopping Cart use case).

5. Special Requirements

5.1 Usability

5.1.1 Pilot—Release 1

Check stock levels as a memory resident batch process for multiple products for multiple suppliers

Stock allocated on first in first out (FIFO) basis

Allow buyer to purchase more quantity than what Demand Fulfilment says is available

Provide a distinction between zero quantity available and no information on quantity is available

Provide a button to Accept the allocation

Provide a button to Change Order

Send final purchase orders to suppliers

Send final customer order to BOS (Electronic Marketplace Solution customer order is synchronised with BOS purchase order)

5.1.2 Pilot—Release 3

When desired quantity is not available, Buyer has to return to the shopping cart to adjust quantity. However, the Buyer no longer has visibility into the Demand Fulfilment available quantity. Provide a single page to view original quantity requested, available to promise quantity, and have a third field to input a new order quantity.

When the desired quantity is not available, suggest substitute products or alternate suppliers based retailer's substitution rules.

6. Pre-Conditions

6.1 Shopping cart has items

6.2 Supplier updates stock/available to promise data

No individual supplier stock allocation rules are maintained in Demand Fulfilment

7. Post-Conditions

7.1 Customer order is split into multiple supplier purchase orders and transmitted

7.2 Order status is updated to Open

7.3 Electronic Marketplace Solution sends customer order to BOS

This includes changes made to original BOS suggested order.

7.4 Demand Fulfilment inventory levels are decreased

8. Data Requirements

Data In

Supplier

Product number

Quantity desired

Data Out

Supplier

Product number

Quantity available

9. Interfaces

Interface to BOS to push back final customer order.

10. Assumptions

Use Case Specification: Retrieve Saved Shopping Cart

1. Context Diagrams

Order Capture Saved Shopping Cart

Order Capture-HOS Aggregated Order

Order Capture BOS Suggested Order Single Store

2. Use Case Actors

Category Manager/Store Owner (Buyer)

Customer Management

3. Brief Description

Buyer retrieves a shopping cart that has been previously saved.

4. Flow of Events

4.1 Basic Flow

4.1.1 Buyer clicks Saved Shopping Cart.

4.1.2 Buyer selects specific shopping cart from drop down list.

4.2 Alternative Flow(s)

4.2.1 No saved shopping cart available

If the Buyer has not previously saved a shopping cart or imported a BOS suggested order, upon clicking Saved Shopping Cart from the main order menu, the Buyer sees a blank page.

4.2.2 Selected wrong shopping cart

If the Buyer selects the incorrect shopping cart, the Buyer can navigate back to the Saved Shopping Cart pick list via the main menu.

5. Special Requirements

5.1 Usability

5.1.1 Pilot—Release 1

Shopping cart can be saved with a user-defined name.

Multiple shopping carts can be saved.

5.1.2 Pilot—Release 3

Indicate (i.e. in a different colour) the products in the shopping cart that are on promotion.

Provide a button to click on to get further details on the promotional products in the shopping cart.

Allow deletion of a shopping cart from the user interface.

Limit the maximum number of saved shopping carts to 15.

For saved BOS suggested order, highlight in a different colour the products in the shopping cart had their BOS prices overridden.

Provide a side by side view of the BOS price and the Electronic Marketplace Solution price for the line items were generated via a suggested order.

Set a default saved cart in user profile. Saved cart would automatically be retrieved upon login.

6. Pre-Conditions

6.3 A shopping cart has been manually saved or automatically populated based on BOS suggested order

6.4 User profile indicates whether store has BOS system or not

7. Post-Conditions

7.1 Buyer can view shopping cart contents.

Shopping cart includes product, price, and quantity.

7.2 Buyer can continue to search and browse entire catalogue.

7.3 Buyer can continue to add items to shopping cart.

7.4 Buyer can review promotions.

User profile defines whether BOS Buyer can review promotions. Some Convenience Organised stores may not be allowed to review promotions.

7.5 Buyer can add items from promotions page to shopping cart.

8. Data Requirements

Data In

Shopping cart name

Data Out

Supplier

Product number

Product description

Quantity

Electronic Marketplace Solution price

Indicator if product is on promotion

Highlighted price difference between BOS and Electronic Marketplace Solution

9. Interfaces

None

Use Case Specification: Import HOS/BOS Generated Order

1. Context Diagrams

Order Capture_HOS Aggregated Order

Order Capture_BOS Suggested Order Single Store

2. Use Case Actors

Back Office System (BOS)

Home Office System (HOS)

Customer Management

3. Brief Description

The suggested order generated by the HOS/BOS is loaded into Customer Management and saved as a shopping cart.

4. Flow of Events

4.1 Basic Flow

4.1.1 Electronic Marketplace Solution receives suggested order from HOS/BOS.

4.1.2 Electronic Marketplace Solution validates suggested order products and product numbers against catalogue products and product numbers.

If there is a discrepancy between BOS and Electronic Marketplace Solution, see alternative flow.

4.1.3 Electronic Marketplace Solution validates suggested order prices against Electronic Marketplace Solution prices.

If there is a discrepancy between BOS and Electronic Marketplace Solution, see alternative flow.

4.1.4 Electronic Marketplace Solution formats and saves suggested order as a shopping cart.

4.2 Alternative Flow(s)

4.2.1 Electronic Marketplace Solution rejects line items on suggested order.

If there is a discrepancy with line items on the HOS/BOS suggested order and Electronic Marketplace Solution catalogue, Electronic Marketplace Solution generates a flat file of the exception line items. The flat file includes the product number, description, and the reason for failure.

The correct line items on the suggested order are submitted and the exception line items drop off the suggested order.

Depending on user profile, Electronic Marketplace Solution determines the necessary action for the exception line items:

Convenience Independents With Electronic Marketplace Solution Installed BOS—Electronic Marketplace Solution overrides the BOS system with changes

Convenience Organised—Electronic Marketplace Solution provides the changed items in A flat file and Convenience Organised determines if change needs to be accepted

Convenience Independents With Independent BOS—If the user profile indicates the CI would like automatic updates to the BOS catalogue, then Electronic Marketplace Solution overrides the BOS system with changes. If the user profile indicates the CI would just like to be notified of the change, Electronic Marketplace Solution provides the changed item in A flat file.

4.2.2 Electronic Marketplace Solution overrides HOS/BOS price with Electronic Marketplace Solution price.

If there is a discrepancy with prices on the HOS/BOS suggested order and Electronic Marketplace Solution prices, Electronic Marketplace Solution overrides the HOS/BOS prices.

Order Management updates HOS/BOS prices when final order is converted into CO/PO.

4.2.3 Electronic Marketplace Solution cannot process order for unknown reason

Electronic Marketplace Solution Help Desk attempts to resolve problem.

If Electronic Marketplace Solution Help Desk cannot resolve the problem, Electronic Marketplace Solution contacts the Retailer and jointly resolve.

Electronic Marketplace Solution may push a flat file containing discrepancies to HOS/BOS.

5. Special Requirements

5.1 Usability

5.1.1 Pilot—Release 1

Automated transfer of suggested order from HOS/BOS to Electronic Marketplace Solution

Reject line items that do not match the Electronic Marketplace Solution catalogue and process the line items that do match

For Electronic Marketplace Solution suppliers, generate a flat file of rejected line items due to product number not found or any other reason.

Override HOS/BOS prices with Electronic Marketplace Solution prices

Provide a side by side view of the HOS/BOS price and the Electronic Marketplace Solution price for the line items were generated via a suggested order

Automatically save suggested order as a shopping cart with a meaningful, descriptive name (name format to be determined later)

From the main ordering menu, Buyer has ability to select one of potentially many shopping carts

Electronic Marketplace Solution accepts HOS/BOS orders for all suppliers, including orders for suppliers not on the Electronic Marketplace Solution system. Electronic Marketplace Solution generates a report for all order line items from non-Electronic Marketplace Solution suppliers. Orders for non-Electronic Marketplace Solution suppliers are manually placed by the Electronic Marketplace Solution organisation.

5.1.2 Pilot—Release 3

When products change in the Electronic Marketplace Solution catalogue or there is a discrepancy between products in the Electronic Marketplace Solution catalogue and HOS/BOS catalogue (as determined by exception processing when importing the suggested order), CM generates a flat file of all product changes. Depending on user profile, Electronic Marketplace Solution pushes out the changes to BOS, or sends a file of the changes. If the Buyer is sent a file of the changes, the Buyer determines whether to implement changes in BOS/HOS. The goal is to keep the HOS/BOS and Electronic Marketplace Solution catalogues synchronized.

Alert the Buyer upon login when a suggested order/saved shopping cart exists in Electronic Marketplace Solution. Buyer is able to see saved shopping cart upon navigating to Saved Shopping Cart pick list.

Send HOS/BOS order straight through to OMS without user intervention user profile indicated HOS/BOS information and ordering preference.

6. Pre-Conditions

6.1 Retailer user profile indicates whether retailer uses HOS/BOS or not (and interface is developed accordingly)

6.2 HOS/BOS generates a suggested order and the Category Manager reviews suggested order in HOS/BOS

6.3 HOS/BOS generates order in a format that can be imported by Electronic Marketplace Solution

6.4 Translation table between HOS/BOS product numbers and Electronic Marketplace Solution product numbers exists

7. Post-Conditions

7.1 Validated data has been loaded into Electronic Marketplace Solution and saved in shopping cart format

7.2 Electronic Marketplace Solution has sent notification of failed import items to HOS/BOS

7.3 Status of order is null—order status becomes Open when Buyer clicks Checkout

8. Data Requirements

Data In

Supplier

Product number

Product description

Quantity

BOS price (Retailer's nett price)

Data Out

Supplier

Product number

Product description

Quantity

Flag for failure of BOS import

Reason codes for failure of BOS import

9. Interfaces

There is a two-way interface between Electronic Marketplace Solution and HOS/BOS.

1. The HOS/BOS suggested order file is automatically exported to Electronic Marketplace Solution at the completion of an order in HOS/BOS. This export occurs real-time (is not batched).

2. Depending on user profile, the rejected line items due to product number discrepancy are automatically corrected in BOS. If not automatically corrected, the flat file is transmitted to HOS/BOS for manual review.

3. The rejected order due to unknown reasons may need to be sent back to HOS/BOS depending if the Electronic Marketplace Solution Help Desk can resolve the issue.

10. Assumptions

1. HOS/BOS sends Electronic Marketplace Solution the orders for suppliers not supported by Electronic Marketplace Solution. Orders for non-Electronic Marketplace Solution suppliers are manually processed by Electronic Marketplace Solution organisation. (See also Special Requirements)

Use Case Specification: Update Inventory Levels

1. Use Case Diagrams

Available to Promise

2. Use Case Actors

Supplier's ERP

Demand Fulfilment

3. Brief Description

Update product inventory levels in Demand Fulfilment.

4. Flow of Events

4.1 Basic Flow

4.1.1 Supplier sends a file containing stock information.

File is in a predefined Electronic Marketplace Solution format, containing product number and quantity for each available SKU, for each available stock location.

4.1.2 Electronic Marketplace Solution loads data.

4.1.3 Electronic Marketplace Solution validates data.

4.2 Alternative Flow(s)

4.2.1 Supplier's file is not sent

If the supplier's allocations are not received during the scheduled batch time, Electronic Marketplace Solution generates and sends notification to the supplier explaining allocations were not received and product availability in the Electronic Marketplace Solution may be incorrect

Stock allocations in Demand Fulfilment do not get updated.

4.2.2 Supplier's data does not match Electronic Marketplace Solution data

If there is a discrepancy between the supplier's data and the Electronic Marketplace Solution data, Electronic Marketplace Solution generates a flat file of the discrepancy line items. The flat file includes the product number, quantity, stock location, and reason code for failure.

The validated products are automatically updated in Demand Fulfilment and the exception products are rejected.

Electronic Marketplace Solution sends the flat file to the supplier.

4.2.3 Supplier submits spreadsheet containing stock allocation data

If a supplier does not have an ERP, the supplier can submit stock information in a Microsoft Excel spreadsheet.

The Electronic Marketplace Solution System Administrator loads the spreadsheet data.

5. Special Requirements

5.1 Usability

5.1.1 Pilot—Release 1

Allocations are updated via an automated, batch process

Supplier's user profile indicates whether the Demand Fulfilment is a reflection of stock allocation or actual inventory levels from the supplier's ERP

Supplier is allowed to submit stock allocation data via a spreadsheet format

5.1.2 Pilot—Release 3

6. Pre-Conditions

6.5 Supplier's products and stock locations have been loaded at least once into catalogue

7. Post-Conditions

7.5 Updated inventory levels

8. Data Requirements

Data In

Supplier

Location

Product number

Quantity available

Data Out

Supplier

Product number

Location

Quantity available

Notification of non-receipt

Flat file of discrepancy products

9. Interfaces

Batch interface between Demand Fulfilment and Supplier's ERP.

11. Delta

None

12. Assumptions

The supplier's stock allocation quantity in Demand Fulfilment reflects any transactions that have occurred in Electronic Marketplace Solution since the supplier's ERP was last refreshed.

Use Case Specification: Review Shopping List

1. Context Diagrams

Order Capture_Top Up Order (Non BOS)

Order Capture_Saved Shopping Cart

Order Capture_HOS Aggregated Order

Order Capture_BOS Suggested Order Single Store

2. Use Case Actors

Store Owner (Buyer)

Customer Management

3. Brief Description

Buyer reviews the shopping list and selects items for the shopping cart.

4. Flow of Events

4.1 Basic Flow

4.1.1 Buyer retrieves saved shopping cart.

If desired—otherwise buyer can start a new cart.

4.1.2 Buyer clicks Shopping List.

4.1.3 Buyer browses Shopping List.

4.1.4 Buyer selects products from Shopping List by clicking in the Select check box.

4.1.5 Buyer clicks Add to Shopping Cart button.

4.1.6 Buyer is brought to Shopping Cart page.

4.2 Alternative Flow(s)

4.2.1 No shopping list available

If the Buyer has not previously set up a shopping list, upon clicking “Shopping List” from the main order menu, the Buyer sees a blank page.

4.2.2 Buyer cannot find product on shopping list

If the Buyer cannot find the desired product on the shopping list, provide the ability to search the Store/Company list (otherwise known as Main Catalogue).

5. Special Requirements

5.1 Usability

5.1.1 Pilot—Release 1

Products can be added to and deleted from the Shopping List.

Provide functionality to input quantity at the time user is reviewing the shopping list and before the user has added to shopping cart.

5.1.2 Pilot—Release 3

Indicate (i.e. in a different colour) the products in the shopping cart that are on promotion.

Provide a button to click on to get further details on the promotional products in the shopping cart.

Provide a Select All button to select all items in Shopping List.

Provide ability to manually deselect items that are not desired after “Select All” button has been clicked.

6. Pre-Conditions

6.6 Shopping list is saved.

Shopping List is manually created via drag and drop functionality or via a file uploaded into the database.

6.7 Saved shopping cart is opened.

If Buyer wants to add items from Shopping List to saved shopping cart, the saved shopping cart must be opened prior to selecting the Shopping List.

6.8 User profile/assigned role indicates whether store generates orders in BOS or Electronic Marketplace Solution.

If store wishes to generate completed POs in BOS, the only saved shopping cart available is an imported suggested order.

7. Post-Conditions

7.5 Buyer can view shopping cart contents.

Shopping cart includes product, price, and quantity.

7.6 Buyer can continue to search and browse.

7.7 Buyer can continue to add items to shopping cart.

8. Data Requirements

Data In

Shopping list

Data Out

Supplier

Product number

Product description

Quantity

Electronic Marketplace Solution price

Indicator if product is on promotion

9. Interfaces

None

10. Assumptions

Use Case Specification: Add to Shopping Cart

1. Context Diagrams

Order Capture—Quick Order (Non BOS)

Order Capture—Saved Shopping Cart

Order Capture—BOS Suggested Order—Convenience Independent

Order Capture—BOS Suggested Order—Convenience Organised

2. Use Case Actors

Category Manager/Store Owner (Buyer)

Customer Management

3. Brief Description

Buyer adds/edits/deletes items and adjusts quantities within shopping cart. Upon checkout the shopping cart is sent to available to promise (ATP).

4. Flow of Events

4.1 Basic Flow

4.1.1 Buyer adds/edits/deletes items to shopping cart.

4.1.2 Buyer adjusts quantities.

4.1.3 Buyer accepts shopping cart contents and quantities and clicks Checkout.

4.1.4 Buyer reviews order total as it is incremented.

4.1.5 Customer order is sent to Demand Fulfilment.

4.2 Alternate Flow

4.2.1 Save shopping cart

Provide the ability for the Buyer to save the products and quantities as a shopping cart to be retrieved later.

Buyer clicks on Save Shopping Cart button.

Buyer enters name of shopping cart.

Buyer clicks on Save.

Shopping cart is saved.

If Buyer wishes to Checkout the shopping cart that was just saved, Buyer navigates to Saved Shopping Cart, selects the shopping cart from the pick list, and clicks Checkout.

4.2.2 Cancel customer order

Provide the ability for the Buyer to exit from the customer ordering process.

4.2.3 Buyer continues shopping before checkout

Buyer clicks on Continue Shopping.

Buyer can search and browse for more products and add to same shopping cart.

5. Special Requirements

5.1 Usability

5.1.1 Pilot—Release 1

Standard add/edit/delete shopping cart functionality

Ability to update quantity

Ability to remove products from shopping cart Recognize when minimum order quantity is not input and provide a message that informs the Buyer a correction is required.

Calculate line item order value (quantity multiplied by unit price)

Calculate total customer order value (sum of line item order value)

Provide button to Check Out and send shopping cart to Available to Promise

Provide button to Save Shopping Cart

Prompt Buyer to input name of shopping cart

Ability to save multiple shopping carts

Provide button to Continue Shopping

Save shopping cart if user session times out.

5.1.2 Pilot—Release 3

Upon clicking “Check out” provide a prompt “Do you want to save this shopping cart?”

6. Pre-Conditions

6.1 Catalogue is established

6.2 Retailer specific pricing is established

6.3 Promotion products exist in catalogue

6.4 Products have been selected for addition to shopping cart.

Products can originate from the Shopping List of Store/Company List.

7. Post-Conditions

7.1 Customer order transmitted to Demand Fulfilment

7.2 Shopping cart is emptied; all items are on the customer order

If the shopping cart has not been saved, the shopping cart is emptied

8. Data Requirements

Data In

Supplier

Product number

Product description

Quantity

Electronic Marketplace Solution price

Indicator if product is on promotion

Highlighted price difference between BOS and Electronic Marketplace Solution

Data Out

Supplier

Product number

Quantity

Electronic Marketplace Solution price

Total line item dollar value

Total purchase order dollar value

Total customer order dollar value

9. Interfaces

None

10. Assumptions

Case Specification Messaging

1. Use Case Diagrams

Community

2. Use Case Actors

User (General)

Platform

3. Brief Description

Messaging is used within the Electronic Marketplace Solution system for communication between all participants (suppliers, retailers, service providers, Electronic Marketplace Solution, etc.)

4. Flow of Events

4.1 Basic Flow

4.1.1 Email Messages—Electronic Marketplace Solution facilitated

Electronic Marketplace Solution receives email content (i.e. advertisements, product recalls, special offers, targeted information, etc.) from suppliers, service providers, logistics providers, etc.

Electronic Marketplace Solution also receives distribution parameters (e.g. target audience) from email content submitter. For certain messages, the audience could be all Electronic Marketplace Solution users.

A Electronic Marketplace Solution Content Administrator data mines the user profile to obtain the correct distribution list. Depending on the granularity of the target audience request, this could be a simple or complex task

The email is distributed to the distribution list

Electronic Marketplace Solution can also develop and distribute Electronic Marketplace Solution specific email

4.1.2 Email Messages—User facilitated

Electronic Marketplace Solution users have the ability to directly (i.e. without Electronic Marketplace Solution Admin intervention) receive, compose, forward, reply to, and delete private emails. This includes emailing fellow Electronic Marketplace Solution users in addition to other Internet contacts.

A Electronic Marketplace Solution Company can utilize Electronic Marketplace Solution's email functionality to manage and distribute intra-company messages

4.1.3 Alert Messages

Upon logging in to Electronic Marketplace Solution, users can view applicable alerts

Examples include order status changes, system outages, new messages, new promotions, etc.

To access the content behind the alert, the user must navigate to the appropriate page (i.e. Promotions) or click on a hyperlink attached to the alert

5. Special Requirements

5.1 Release 1

Acquire 3^{rd} party software or ISP provided email to address this functionality

All Electronic Marketplace Solution generated distribution lists are proprietary information. Emails should be sent in such a manner that the recipients cannot see who else received the message

All users will have a Electronic Marketplace Solution specific email address (e.g. User3785@Electronic Marketplace Solution.com)

Manual data query to develop distribution lists based on email addresses in user profiles

Electronic Marketplace Solution needs the ability to monitor and limit the # of bulk mail emails that are sent out daily. Need an internal business process discussion.

Users need the ability to compose, read, save, forward, delete, reply to, etc. emails

Users need the ability to manage emails via folders, create new message folders, move files to and from folders, and delete folders

Electronic Marketplace Solution needs the ability to send messages to all Electronic Marketplace Solution users

Ability to send promotional plans (text and attachments only) via messaging.

Ability to build and manage distribution lists

Pre-configured folders (i.e. supplier emails are automatically sent to a supplier folder)

5.2 Release 3

Forms can be converted to messages and sent to suppliers, users, or distribution lists

Automated link between the user profile and the email distribution list/Address book

6. Pre-Conditions

6.9 User has a Electronic Marketplace Solution account

7. Post-Conditions

7.6 User can send, receive, view, and manage messages

8. Data Requirements

User profile email address

9. Interfaces

External email software or ISP provided email

Use Case Specification: Create-Import Content

1. Use Case Diagrams

Community

2. Use Case Actors

Electronic Marketplace Solution Content Management

Platform

3. Brief Description

Adding content to Electronic Marketplace Solution website. Content includes images, advertising, hot topics, news/current events, career center information, supplier hyperlinks, and Electronic Marketplace Solution notifications and announcements.

4. Flow of Events

4.2 Basic Flow

4.2.1 Pull external content (e.g. news/current events, advertisements, hyperlinks, hot topics, and career center)

Contact information provider

Discuss appropriate content, timing, format, and recommended viewers

Discuss costs of displaying content

Provider submits content and defines effective dates, desired viewers, and special requirements

Electronic Marketplace Solution reviews content and provides feedback, as necessary

4.2.2 Develop internal content (e.g. Electronic Marketplace Solution announcements, hyperlinks, and hot topics)

Develop the content

Determine the audience

4.2.3 Add content to template

Open the template

Choose the container (i.e. location on page)

Load content to container

Define system variables (e.g. effective date and time)

4.1.4 Define audience based upon user profile

Determine groups and/or roles for content

Tie content to groups and/or roles

Save

4.1.5 Ongoing maintenance

Monitor available page “real estate”

Ensure adequate cross-section of material

Purge obsolete content on a regular basis

Maintain Groups and Roles as they related to content

Develop “filler” material for empty containers

Ensure consistent look and feel

Testing new content

4.2 Alternative Flow(s)

4.2.1 Define audience based upon user profile atributes

In the event Groups or Roles cannot identify the targeted users, querying the user profile database can identify the users.

Once the users are identified, determine if a new group or role needs to be added to easily manage the association to the content.

If so, add a group or role and tie content to that group or role

If not, tie user to content

5. Special Requirements

5.1 Release 1

Effective dates (start and end dates) for content display

Rolling banners

Content includes images, text, hyperlinks, content (hot topics, career centre, news/current events, etc.), advertisements, etc.

Content can share page location (i.e. container) and effective dates if targeted users are different

Content can be target to users based upon BAT's current customer hierarchy fitted to's profile structure

5.2 Release 3

New suppliers can request a limited # (proposed 5) of attributes to gather about Electronic Marketplace Solution users. This information can be used to target content.

Number of Groups and Roles added to accommodate this should be monitored to prevent excessive maintenance requirements

6. Pre-Conditions

6.10 Content is developed and ready for import to Electronic Marketplace Solution

6.11 Templates have been created

6.12 User profiles established

6.13 External content providers have been identified and submit content on a regular basis in a predefined format

6.14 Standards for content (e.g. size requirements, file formats) have been determined and communicated

7. Post-Conditions

7.7 Content tied to user profile and page location

8. Data Requirements

Groups

Roles

Users

User profile attributes

Content

Effective dates

User Target information

9. Interfaces

If content is external, it is provided in a format that is easily imported

Hyperlinks to external sites

Use Case Specification: Access Content

1. Use Case Diagrams

Community

2. Use Case Actors

User (General)

Platform

3. Brief Description

Method in which user can access content (based upon user profile) available on the Electronic Marketplace Solution website

4. Flow of Events

4.3 Basic Flow

4.1.1 User enters the Electronic Marketplace Solution and can view content

The user logs into Electronic Marketplace Solution

The user profile is activated (e.g. user specific content is pulled, security access is activated, etc.)

User can view their default page

Advertisements, logos, other images, Electronic Marketplace Solution messages, and hyperlinks are automatically displayed based upon requirements and user profile

User can navigate to other content areas (Hot Topics, News/Current Events, Career Center, and Messaging)

The content displayed on the other content areas is also based upon the user profile designations (i.e. Group, Role, User, etc.)

Chat rooms and discussion groups will be driven by the user. Should be monitored and managed (i.e. security access) by Electronic Marketplace Solution. Access could be limited by Groups and Roles. A 3^{rd} party software is recommended.

5. Special Requirements

5.1 Release 1

Easy to navigate

3^{rd} Party software, integrated with user profile, to provide discussion group and chat room functionality. The access to these functionalities can be turned on or off based upon user profile/security access.

Community content housed on separate tabs or pages to avoid information overload

5.2 Release 3

User can personalize (similar to Yahoo! and Excite functionality) the display of certain content areas (e.g. News/Current Events, Hot Topics, etc.)

6. Pre-Conditions

6.15 User has account with Electronic Marketplace Solution

6.16 User profile has been established

6.17 Content has been created, imported, and associated to user profiles

7. Post-Conditions

7.8 User can view targeted content

8. Data Requirements

User profile

Community content

9. Interfaces

Discussion Group/Chat Room provider

Use Case Specification: Query Order Status

1. Use Case Diagrams

Order Tracking

2. Use Case Actors

Category Manager/Store Owner (Buyer)

Customer Management

3. Brief Description

Buyer views order status.

4. Flow of Events

4.1 Release 1

4.1.1 Basic Flow

Query Using Order Summary

Buyer navigates to Order tab in Customer Management

Buyer selects Order Summary

Buyer views all purchase orders with a status not equal to Closed

4.1.2 Alternative Flow(s)

Query Using Order Search

Buyer navigates to Order tab in Customer Management

Buyer selects Order Search

Buyer inputs purchase order number and/or Buyer selects status from drop down box

Buyer clicks Search

Search results are populated in lower pane

Query Using Order Status

Buyer navigates to Order tab in Customer Management

Buyer selects an order status of Unconfirmed, Accepted, Accepted With Changes, Shipped, Paid, or Closed from the menu

Buyer inputs purchase order number (if desired)

Buyer clicks Search

Search results are populated in lower pane

4.2 Release 3

4.2.1 Basic Flow

Buyer goes to Customer Order Summary in Order Management System

Buyer drills down via hyperlink to specific Customer Order

Buyer drills down via hyperlink to specific Purchase Order within Customer Order

Buyer drills down via hyperlink to specific line items within Purchase Order

Buyer views line item status

4.2.2 Alternative Flow(s)

Buyer begins drill down by Customer Order number in Order Management System

Buyer begins drill down by Supplier in Order Management System

Buyer begins drill down by Product in Order Management System

5. Special Requirements

5.1 Release 1

5.1.1 Provide an Order Status Summary hyperlink on main Order menu

Upon clicking, the user is presented with all Orders that do not have a status of Closed. Orders are sorted in descending date.

5.1.2 Provide Status hyperlinks on main Order menu

Hyperlinks for Unconfirmed, Accepted, Accepted With Changes, Shipped, Paid, Closed

5.1.2 Provide Order Search functionality

Search on Purchase Order Number or Status

5.2 Release 3

5.2.1 Retailer can view a Retailer Status Summary Page (see Update Order Use Case)

5.2.2 Modify order

Upon querying order, Buyer has the ability to modify line items on the order (see Modify Order Use Case)

6. Pre-Conditions

6.18 Buyer is logged into Electronic Marketplace Solution and selected to go to Customer Management

6.19 At least one purchase order is created

7. Post-Conditions

7.9 Buyer is aware of order status and details

8. Data Requirements

Customer Order Information (Release 3)

Purchase Order Information

Supplier Sales Order Information

Status Information

9. Interfaces

All external interface requirements have been captured in the Update Order Use Case

Use Case Specification: Update Order

1. Use Case Diagrams

Order Tracking

2. Use Case Actors

Supplier's ERP

Demand Fulfilment

Customer Management

BOS

3. Brief Description

Update customer/purchase order data (i.e., status, unit price, delivery date, etc.).

4. Flow of Events

4.1 Basic Flow

4.1.1 Receive Updated Data from Within Electronic Marketplace Solution

Buyer clicks Accept in CM upon reviewing ATP data from DF

Electronic Marketplace Solution automatically updates status of PO to Unconfirmed

Buyer views PO in Order Summary Page

4.1.2 Receive Updated Order Data from Supplier ERP

Purchase Order is sent to Supplier

Supplier processes purchase order and converts to sales order

Supplier generates sales order flat file with updated PO Number, Delivery Date, Quantity, Price, etc.

Batch process imports sales order flat file into Electronic Marketplace Solution

Electronic Marketplace Solution automatically updates status to Accepted, Accepted With Changes, Shipped, Closed etc.

If status is anything other than Unconfirmed or Accepted, Electronic Marketplace Solution generates a PO Note with details.

Buyer views PO in Order Summary Page

4.1.3 Receive Updated Receipt Data from BOS

Goods are receipted in BOS

BOS generates a flat file containing the PO Number, Product Number, and Quantity Received

Batch process imports BOS file into Electronic Marketplace Solution

Electronic Marketplace Solution automatically updates status to Received

Buyer views PO in Order Summary Page

4.1.4 Receive Updated Payment Data from Payment Software Solution

Buyer triggers payment

Payment Software Solution generates a flat file containing the PO Number and notification of payment

Batch process imports payment flat file into Electronic Marketplace Solution

Electronic Marketplace Solution automatically updates status to Paid

Buyer views PO in Order Summary Page

4.1.5 Receive Updated Payment Data from Supplier

Supplier received payment

Supplier generates flat file with PO Number and notification of payment received

Batch process imports payment flat file into Electronic Marketplace Solution

Electronic Marketplace Solution automatically updates status to Closed

Buyer views PO in Order Summary Page

4.2 Status Definitions and Triggers

4.2.1 Release 1

As an order proceeds through its life cycle from order capture to payment, a status code for each line on the order will be kept in Electronic Marketplace Solution. The table below describes the statuses available and who triggers the status. Most of the statuses are updated automatically, and will be limited to 10 characters on the user interface and are abbreviated as follows:

| Status | Abbreviation | Definition | Who Triggers |
|---|---|---|---|
| Basic | | | |
| Flow | | | |
| Un- | Uncomfirmd | Customer Order is split | Buyer triggers |
| confirmed | | into multiple purchase | by clicking |
| | | orders | Accept in |
| | | | CM. |
| Accepted | Accepted | Sales Order received by | Supplier |
| | | Electronic Marketplace | triggers by |
| | | Solution and there are no | sending batch |
| | | changes from initial | file from ERP. |
| | | customer order | |
| Accepted | AccWith | Sales Order received by | Supplier |
| With | Chg | Electronic Marketplace | triggers by |
| Changes | | Solution with changes | sending batch |
| | | from initial customer order | file from ERP. |
| Invoiced | Invoiced | Goods are shipped and | Supplier |
| | | invoice is generated and | triggers by |
| | | sent. | sending batch |
| | | | file from |
| | | | ERP. |
| Received | Received | Products received into | Buyer |
| | | retailer's inventory system | triggers by |
| | | (BOS) | receipting goods |
| | | | in BOS. |
| | | | BOS sends |
| | | | a batch file to |
| | | | Electronic |
| | | | Marketplace |
| | | | Solution. |
| Closed | Closed | Payment is received and | Supplier |
| | | accepted by Supplier | triggers by |
| | | | sending batch |
| | | | file from ERP. |
| Alternate | | | |
| Flow | | | |
| Supplier | SuppCancel | Supplier can not fulfil | Supplier |
| Cancelled | | predefined order terms | |

4.2.2 Release 3

With the implementation of Order Management System, additional statuses will be valid:

| | | |
|---|---|---|
| Status | Definition | Who Triggers |

Basic
Flow

| | | |
|---|---|---|
| Un- | Customer Order is split into multiple | Buyer |
| confirmed | purchase orders | triggers by |
| | | clicking |
| | | Accept in CM. |
| Accepted | Sales Order received by Electronic | Supplier |
| | Marketplace Solution and there are no | triggers by |
| | changes from initial customer order | sending batch |
| | | file from ERP. |
| Accepted | Sales Order received by Electronic | Supplier |
| With | Marketplace Solution with changes | triggers by |
| Changes | from initial customer order | sending batch |
| | | file from ERP. |
| Shipped | Goods are shipped. This status is | Supplier |
| | only used if the invoice is not | triggers by |
| | generated at the time the goods are | sending batch |
| | shipped. If the invoice is generated at | file from ERP. |
| | the time the goods are shipped, the | |
| | order goes directly from a status of | |
| | Accepted to a status of Invoiced. | |
| Invoiced | Goods are shipped and invoice is | Supplier triggers by |
| | generated and sent. | sending batch file |
| | | from ERP. |
| Received | Products received into retailer's | Buyer triggers by |
| | inventory system (BOS) | receipting goods in |
| | | BOS. BOS sends a |
| | | batch file to |
| | | Electronic |
| | | Marketplace |
| | | Solution. |
| Paid | Retailer has initiated payment for | Buyer triggers by |
| | invoiced goods. | initiating payment in |
| | | Electronic |
| | | Marketplace |
| | | Solution. |
| Closed | Payment is received and accepted by | Supplier triggers by |
| | Supplier | sending batch file |
| | | from ERP. |
| Alternate | | |
| Flow | | |
| Partially | Goods have been partially shipped | Supplier |
| Shipped | | |
| Partially | Received partial goods due to partial | Buyer |
| Received | goods delivered or damaged goods | |
| | upon delivery | |
| Supplier | Supplier can not fulfil predefined | Supplier |
| Cancelled | order terms | |
| Customer | Customer does not agree with sales | Buyer |
| Cancelled | order | |
| Customer | Manually triggered | Buyer |
| Cancel- | | |
| lation | | |
| Request | | |
| Supplier | Manually triggered | Supplier |
| Cancel- | | |
| lation | | |
| Request | | |
| Customer | Manually triggered | Buyer |
| Change | | |
| Order | | |
| Request | | |

4.3 Valid Status Changes

4.3.1 Release 1

With Release 1, status changes occur based on the triggers in the above table. A status change can occur from any one status to another; there is no intelligence built into the system that restricts movement from one status to another.

4.3.2 Release 3

With Release 3, there are restrictions around movement from one status to another. Business rules based on the below table determine valid status changes.

Order Status

| | TO | | | | | | | | | | | | | | | |
|---|---|---|---|---|---|---|---|---|---|---|---|---|---|---|---|---|
| | | | Ac- | | | | | | | | | | | | | |
| | | | cept- | | | | | | | | | | | Cus- | Sup- | |
| | | | ed | | | | | | | | | Sup- | Cus- | tomer | plier | |
| | Un- | Ac- | With | | | | | | | Partially | Partially | plier | tomer | Can- | Can- | Cus- |
| | con- | cept- | Chang- | | Re- | In- | | | Partially | Re- | In- | Can- | Can- | cel- | cel- | tomer |
| FROM | firmed | ed | es | Shipped | ceived | voiced | Paid | Closed | Shipped | ceived | voiced | celled | celled | lation | lation | Change |
| Un- | | X | X | | | | | | | | | X | X | X | | X |
| con- | | | | | | | | | | | | | | | | |
| firmed | | | | | | | | | | | | | | | | |
| Accept- | | | | X | | X | | | X | | X | X | X | X | X | X |
| ed | | | | | | | | | | | | | | | | |
| Accept- | | | | X | | | | | | | | | X | X | | X |
| ed | | | | | | | | | | | | | | | | |
| With | | | | | | | | | | | | | | | | |
| Chang- | | | | | | | | | | | | | | | | |
| es | | | | | | | | | | | | | | | | |
| Shipped | | | | | X | X | | | | X | | | | | | |
| Re- | | | | | | | X | | | | | | | X | | X |
| ceived | | | | | | | | | | | | | | | | |
| In- | | | | | X | | X | | | X | | | | X | | X |
| voiced | | | | | | | | | | | | | | | | |
| Paid | | | | | | | | X | | | | | | | | |
| Closed | | | | | | | | | | | | | | | | |
| Partially | | | | X | | | | | | X | X | | | X | X | X |
| Shipped | | | | | | | | | | | | | | | | |
| Partially | | | | | X | | X | | | | | | | X | X | X |
| Re- | | | | | | | | | | | | | | | | |
| ceived | | | | | | | | | | | | | | | | |
| Partially | | | | | X | | X | | | X | | | | X | X | X |
| In- | | | | | | | | | | | | | | | | |
| voiced | | | | | | | | | | | | | | | | |
| Supplier | | | | | | | | | | | | | | | | |
| Cancelled | | | | | | | | | | | | | | | | |
| Customer | | | | | | | | | | | | | | | | |
| Cancelled | | | | | | | | | | | | | | | | |
| Customer | | | | | | | | | | | | | X | | | |
| Cancel- | | | | | | | | | | | | | | | | |
| lation | | | | | | | | | | | | | | | | |
| Request | | | | | | | | | | | | | | | | |
| Supplier | | | | | | | | | | | | X | | | | |
| Cancel- | | | | | | | | | | | | | | | | |
| lation | | | | | | | | | | | | | | | | |
| Request | | | | | | | | | | | | | | | | |
| Customer | | | X | | | | | | | | | X | X | X | X | |
| Change | | | | | | | | | | | | | | | | |
| Order | | | | | | | | | | | | | | | | |
| Request | | | | | | | | | | | | | | | | |

5. Special Requirements

5.1 Release 1

Provide an Order Status Summary page showing order details in a single page view. The summary is a static page with no hyperlinks to drill down into further detail. The summary page contains the original purchase order data.

| | | | Confirmed | |
|---|---|---|---|---|
| | | | Delivery | |
| PO | Date | Order Status | Date | PO Note |
| PO #1228 | 10-Aug-00 | Unconfirmed | 15-Aug-00 | |
| PO #1023 | 9-Aug-00 | Accepted With | 15-Aug-00 | PO Note |
| | | Changes | | |
| PO | 6-Aug-00 | Shipped | 12-Aug-00 | PO Note |
| #945 | | | | |
| PO #902 | 2-Aug-00 | Paid | 5-Aug-00 | |

Any modifications to the original purchase order (changes to quantity, price, etc.) are viewed in a PO Note from the Order Status Summary Page. The user clicks on the PO Note, which provides a running history about changes made to the PO Order. Changes can includes:

Supplier changes quantity based on availability (if supplier is out of stock quantity is set to zero)

Supplier changes price

The Supplier cannot automatically delete a line item of substitute an alternate product for a line item on the PO. If the line item is not available, quantity is set to zero. If the Buyer wants an alternate product, a new PO must be created.

Supplier confirmed delivery date is automatically updated on the CM user interface.

All changes made to a BOS generated order are communicated back to BOS.

Any purchase orders that have been changed by the supplier will be given the status “Accepted with Changes”.

An e-mail notification is generated alerting the Buyer that a purchase order exists with status Accepted With Changes. The alert contains the PO Number and a summary of the changes as detailed in the PO Note.

An e-mail notification is generated alerting the Buyer that a purchase order is in dispute (status of Customer Change Order Request or Customer Cancellation Request). The alert contains the PO Number and a summary of the dispute as detailed in the PO Note.

5.2 Release 3

Order Status Summary page has more detail. Ability to drill down (hyperlink) from a Customer Order status summary page to PO detail and order line detail. See example below:

| | | | | | | |
|---|---|---|---|---|---|---|
| | | Supplier | | Confirmed | | |
| | | ID/ | Order | Delivery | Payment | Amount |
| Buyer Name | Date | Name | Status | Date | Status | Outstanding |

| | | | | | |
|---|---|---|---|---|---|
| Cust. Order #100 | 6-Aug-00 | | | | |
| PO #945 | 8-Aug-00 | BATA | Shipped | 12-Aug-00 | Unconfirmed |
| PO #144 | 8-Aug-00 | COKE | Received | 10-Aug-00 | Paid |
| PO #858 | 9-Aug-00 | Davids | Confirmed | 21-Aug-00 | Closed |
| Cust. Order #101 | 7-Aug-00 | | | | |
| PO #A3R | 9-Aug-00 | Nestle | Accp. | | |
| PO #222 | 8-Aug-00 | Pepsi | w- Cha | | |
| | | | Cancelled | | |
| Cust. Order #102 | 8-Aug-00 | | — | | |
| — | — | — | — | | |
| — | — | — | — | | |

Provide a side-by-side view on the single page summary of the original purchase order line item data and the Accepted With Changes purchase order line item data.

Highlight in a different colour the customer order and line items that were altered from original customer order.

Buyer can capture a partial goods receipt in OMS. For Pilot, goods receipt can only occur in the BOS.

6. Pre-Conditions

6.20 Customer order is split into one purchase order per supplier and transmitted to the supplier's ERP.

Not relevant for Pilot—only one supplier.

7. Post-Conditions

7.10 Supplier sends confirmation of delivery date, updated quantity and price (if applicable).

Delivery date is automatically updated on the CM user interface. Updated quantity and price are reflected in the PO Note.

7.11 Electronic Marketplace Solution sends Accepted and Accepted With Changes purchase order to BOS.

Includes changes (quantity, price) made to originally generated BOS suggested order.

8. Data Requirements and Interfaces

8.1 Release 1

With Release 1, interfaces are based on the following systems:

CM

Supplier ERP

BOS

| | | | | |
|---|---|---|---|---|
| | Input | | Output | |
| Status | Interface(s) | Data Inputs | Interface(s) | Data Outputs |

Basic Flow

| | | | | |
|---|---|---|---|---|
| Unconfirmed | None | | CM to | Purchase Order |
| | | | Supplier | Information |
| | | | ERP | Purchase Order |
| | | | CM to BOS | #'s mapped to |
| | | | | Customer Order # |
| | | | | Line Item Detail |
| Accepted With | Supplier | Purchase | CM to | Buyer |
| Changes | manual online | Order | Supplier | cancellation |
| | entry | Information | ERP or | |
| | or Supplier | with changed | Supplier In | |
| | ERP to | fields = Supplier | Box | |
| | CM | Sales | | |
| | | Order | | |
| | | Supplier Sales | | |
| | | Order # | | |
| | | Supplier Sales | | |
| | | Order # | | |
| | | mapped to | | |
| | | Buyer PO # | | |
| | | New Quantity | | |
| | | New Unit | | |
| | | Price | | |
| | | New Total | | |
| | | Price | | |
| | | Estimated | | |
| | | Delivery Date | | |
| Invoiced | Supplier | NEED TO | | NEED TO |
| | ERP to | DETERMINE | | DETERMINE |
| | Electronic | | | |
| | Marketplace | | | |
| | Solution | | | |
| | (Payment | | | |
| | Software | | | |
| | Solution | | | |
| | and CM) | | | |
| Received | Buyer | Goods | | |
| | manual online | Receipt Data | | |
| | entry | PO/SO # | | |
| | or | reference | | |
| | BOS/POS | Customer | | |
| | to | Order # | | |
| | Electronic | Received | | |
| | Marketplace | Quantity | | |
| | Solution | Matching | | |
| | | exceptions | | |
| | | BOS/POS PO | | |
| | | adjustments | | |
| Closed | Supplier | NEED TO | | Supplier ERP sends |
| | ERP to | DETERMINE | | AR notification to |
| | Electronic | | | CM |
| | Marketplace | | | |
| | Solution | | | |
| Alternative | | | | |
| Flow | | | | |
| Supplier | Supplier | Reason Code: | Retailer BOS | |
| Cancelled | ERP or | (Credit terms, | | |
| | Supplier | Obsolete | | |
| | manual online | product, Back | | |
| | entry | order is not | | |
| | to | accepted, | | |
| | Electronic | Delivery | | |
| | Marketplace | terms, etc) | | |
| | Solution | SO/PO/CO | | |
| | | Information | | |

8.2 Release 3

With Release 3, interfaces are based on the following systems:

OMS

CM

Supplier ERP

BOS

| | | | | |
|---|---|---|---|---|
| | Input | | Output | |
| Status | Interface(s) | Data Inputs | Interface(s) | Data Outputs |

Basic Flow

| | | | | |
|---|---|---|---|---|
| Open | CM to | Customer | OMS to | Purchase Order |
| | OMS | Order | Supplier | Information |
| | | information | ERP | Purchase Order |
| | | Customer | OMS to BOS | #'s mapped to |
| | | Order # | | Customer Order # |
| | | Supplier | | Line Item Detail |
| | | Information | | |
| | | Line Item | | |
| | | Detail | | |
| Accepted | Supplier | Purchase | OMS to | Buyer |
| With | manual online | Order | Supplier | Acceptance |
| Changes | entry | Information | ERP or | |
| | or Supplier | with changed | Supplier In | |
| | ERP to | fields = Supplier | Box | |
| | OMS | Sales | | |
| | | Order | | |
| | | Supplier Sales | | |
| | | Order # | | |
| | | Supplier Sales | | |
| | | Order # | | |
| | | mapped to | | |
| | | Buyer PO # | | |
| | | New Quantity | | |
| | | New Unit | | |
| | | Price | | |
| | | New Total | | |
| | | Price | | |
| | | Estimated | | |
| | | Delivery Date | | |
| Shipped | Supplier | Advanced | | |
| | ERP or | Shipping Notice: | | |
| | Supplier | PO/SO/CO | | |
| | manual online | Information | | |
| | entry | Quantity | | |
| | to | shipper per | | |
| | Electronic | line item | | |
| | Marketplace | Delivery date | | |
| | Solution | Shipping | | |
| | | method | | |
| Received | Buyer | Goods | | |
| | manual online | Receipt Data | | |
| | entry | PO/SO # | | |
| | or | reference | | |
| | BOS/POS | Customer | | |
| | to | Order # | | |
| | Electronic | Received | | |
| | Marketplace | Quantity | | |
| | Solution | Matching | | |
| | | exceptions | | |
| | | BOS/POS PO | | |
| | | adjustments | | |
| Invoiced | Supplier | NEED TO | | NEED TO |
| | ERP to | DETERMINE | | DETERMINE |
| | Electronic | | | |
| | Marketplace | | | |
| | Solution | | | |
| | (Payment | | | |
| | Software | | | |
| | Solution | | | |
| | and OMS) | | | |
| Paid | Payment | NEED TO | | Payment Software |
| | Software | DETERMINE | | Solution to OMS |
| | Solution to | | | |
| | Electronic | | | |
| | Marketplace | | | |
| | Solution | | | |
| Closed | Supplier | NEED TO | | Supplier ERP sends |
| | ERP to | DETERMINE | | AR notification to |
| | Electronic | | | OMS |
| | Marketplace | | | |
| | Solution | | | |
| Alternative | | | | |
| Flow | | | | |
| Partially | Supplier | Advanced | | |
| Shipped | ERP or | Shipping Notice: | | |
| | Supplier | PO/SO/CO | | |
| | manual online | Information | | |
| | entry | Quantity | | |
| | to | shipper per | | |
| | Electronic | line item | | |
| | Marketplace | Delivery date | | |
| | Solution | Shipping | | |
| | | method | | |
| Partially | Buyer | Goods | | |
| Received | manual online | Receipt Data | | |
| | entry | PO/SO # | | |
| | or | reference | | |
| | BOS/POS | Customer | | |
| | to | Order # | | |
| | Electronic | Received | | |
| | Marketplace | Quantity | | |
| | Solution | Matching | | |
| | | exceptions | | |
| | | BOS/POS PO | | |
| | | adjustments | | |
| Partially | Supplier | NEED TO | | Supplier ERP sends |
| Invoiced | ERP to | DETERMINE | | invoice to Payment |
| | Electronic | | | Software Solution |
| | Marketplace | | | and OMS |
| | Solution | | | |
| | (Payment | | | |
| | Software | | | |
| | Solution | | | |
| | and OMS) | | | |
| Supplier | Supplier | Reason Code: | Retailer BOS | |
| Cancelled | ERP or | (Credit terms, | | |
| | Supplier | Obsolete | | |
| | manual online | product, Back | | |
| | entry | order is not | | |
| | to | accepted, | | |
| | Electronic | Delivery | | |
| | Marketplace | terms, etc) | | |
| | Solution | SO/PO/CO | | |
| | | Information | | |
| Customer | OMS to | | Retailer BOS | Reason: (Price |
| Cancelled | Supplier | | | changes, |
| | ERP or | | | available |
| | Supplier | | | quantity, desired |
| | In-Box | | | quantity, |
| | Retailer | | | delivery terms, |
| | BOS | | | etc) |
| | | | | SO/PO/CO |
| | | | | information |
| Customer | | | | |
| Cancellation | | | | |
| Request | | | | |
| Supplier | | | | |
| Cancellation | | | | |
| Request | | | | |
| Customer | | | | |
| Change | | | | |
| Order | | | | |
| Request | | | | |

Use Case: Submit Claim or Return Request (Phase 1)

1. Use Case Diagrams

Claims and Returns

2. Use Case Actors

Category Manager/Store Owner (Buyer)

Order Management System

Customer Management

3. Brief Description

Buyer alerts supplier that product needs to be returned and requests replacement or submits claim.

4. Flow of Events

4.1 Basic Flow (Release 3)

4.1.1 Buyer navigates to Returns/Claim Request Cart.

4.1.2 Buyer inputs return information:

APN or Product Number

Supplier

Quantity

Purchase Order Number (if available)

Invoice Number (if available)

Reason Code

4.1.3 Buyer selects Replacement or Request Credit.

4.1.4 Buyer adds 2^{nd} return line item

4.1.5 Buyer clicks “Submit”

4.1.5 Electronic Marketplace Solution converts Returns/Claims Cart to an e-mail.

4.1.6 E-mail is sent to supplier's customer service representative as defined in supplier user profile.

4.1.7 E-mail is populated in Returns/Claims Request History folder

4.2 Alternative Flow(s)

4.2.2 Buyer can not find product number

If the Buyer does not know the product number, the Buyer can navigate to the catalogue and search and browse. Upon finding the product number, the Buyer manually writes it down, navigates back to the Returns/Claim Request Cart, and inputs the product number.

5. Special Requirements

5.1 Usability (release 3)

Input product using search functionality

Populate product description upon entering product number

Select supplier from drop down list. Supplier drop down list is populated with available suppliers for that product (APN #) as defined in buyer user profile.

Select replacement or credit for each line item on the form

Select reason codes from drop down list. Reason codes are defined as:

Damaged

Over-stocked

Expired

Product Recall

Other

Ability to enter multiple returns from different suppliers in single cart

Ability to split line items in cart by supplier and send multiple e-mails to the supplier's customer service departments

Save submitted Returns/Claims Carts in a history folder to later be retrieved

Date/time stamp is generated when e-mail is sent. This date/time stamp is used for identification and tracking of claim.

Order status is updated as a result of claim being processed (status =Pending Claim?)

Invoice status is updated as a result of claim being processed (status =Pending Claim?)

6. Pre-Conditions (Release 3)

6.21 Buyer has goods to return

7. Post-Conditions (Release 3)

7.12 E-mail is sent to supplier

7.13 Buyer can view e-mail in Claims History folder

7.14 Order/Invoice status is updated

8. Data Requirements

On-line form fields

Date and Time (automatically generated)

Product # or APN (manual entry—required field)

Supplier Drop Down List (generated by mapping user profile defined suppliers to entered APN—required field)

Replacement or Credit drop down menu (manual entry—required field)

Quantity (manual entry—required field)

Reason Code Selection (manual entry—required field)

Purchase Order # (manual entry—optional field)

Invoice # (manual entry—optional field)

Supplier Customer Service Contact email (automatically driven off of supplier profile)

Buyer contact information—cust. #, contact name/email, etc. (automatically driven off buyer profile)

All fields transferred in email

9. Interfaces

Mechanism to send supplier email

13. Delta—to be revisited as requirements for Release 3

currently does not offer Returns/Claims functionality and all functionality in this use case needs to be customized. The customisation could potentially leverage the shopping cart concept. Claims and returns are added to a shopping cart, similar to a customer order, and distributed to multiple suppliers upon clicking Accept/Submit. Need to do further research on what module this functionality should reside in, where to store the shopping cart/e-mail for later retrieval, etc.

Searching on product numbers from the Returns/Claims Cart requires customisation. Ideally the Buyer inputs the customer number and upon tabbing off the field the description of the product is retrieved from the catalogue. This validation would help the Buyer ensure the correct product number was input.

Populating a drop down list with valid suppliers requires customisation. Valid suppliers for a product would be driven off the Buyer's user profile.

Use Case Specification: Modify Order in OMS

1. Use Case Diagrams

Order Tracking

2. Use Case Actors

Category Manager/Store Owner (Buyer)

Order Management System

3. Brief Description

Buyer can modify line items for orders after they have been transmitted to suppliers.

4. Flow of Events

4.4 Basic Flow

4.1.1 Buyer modifies quantity and/or product of an order

Buyer navigates to Customer Order and uses hyperlinks to drill down to line item on a Purchase Order (Alternate Flow: Buyer searches directly on Purchase Order number)

Buyer clicks “Modify”

Buyer has the ability to:

Update quantity desired

Delete line item

Buyer clicks “Save”

Modified purchase order is sent to supplier's ERP in the next batch run

4.1.2 Buyer updates received goods quantity on a Shipped Order or Partially Shipped Order (non BOS)

Buyer navigates to Customer Order.

Buyer navigates to Purchase Order.

Buyer navigates to line item on Purchase Order.

Buyer clicks “Modify”.

Buyer has the ability to:

Update quantity received

Buyer clicks “Save”

4.2 Alternative Flow(s)

4.2.3 Buyer decides not to modify order

Buyer has decided not to adjust the order and leave as is.

Buyer clicks “Cancel” and is returned to the Purchase Order view.

4.2.4 Buyer cancels entire purchase order for a supplier

Buyer has decided to delete all line items on the purchase order and cancel the entire order.

Buyer navigates to Customer Order.

Buyer navigates to Purchase Order.

Buyer navigates to line item on Purchase Order.

Buyer clicks “Check All”.

Buyer clicks “Delete”.

Buyer clicks “Save”:

5. Special Requirements

5.1 Release 1

5.1.1 Cannot modify an order for Release 1

OMS will not be implemented for Release 1. Instead, Customer Management will be used to provide order status and tracking functionality. An order cannot be modified in Customer Management.

5.2 Release 3

5.2.1 Edit box to adjust quantity of product

5.2.2 Ability to delete line item

5.2.3 Button to save changes

5.2.4 Ability for Buyer to cancel by customer order, by purchase order, or by line item

5.2.5 Order status defines whether an order can be modified or not.

e.g. When an order is “Shipped” order can not be changed

5.2.6 Edit box to adjust quantity of goods received

For stores without a POS/BOS, ability to input quantity of goods receipt directly into Electronic Marketplace Solution

6. Pre-Conditions

6.22 Order exists in OMS (Release 3)

7. Post-Conditions

7.15 Purchase order is modified (Release 3)

7.16 Customer order is updated with new purchase order details (Release 3)

7.17 Purchase order is resubmitted to supplier for acceptance (Release 3)

7.18 Modified purchase order is pushed back to BOS (Release 3)

8. Data Requirements

Customer Order/Purchase Order/Sales Order information

Changed Fields

Supplier change order by date

9. Interfaces

Supplier's ERP. Modified purchase orders are sent to supplier's ERP. This is a batch process.

BOS. Modified purchase orders are sent back to BOS. This is a batch process.

Use Case Specification: Pass Payment Confirmation/Order Status Change from eBPP system to Electronic Marketplace Solution

1. Context Diagrams

Context_Invoice and Payment (Electronic Payment and Cash Payment)

2. Use Case Actors

eBPP system

ELECTRONIC MARKETPLACE SOLUTION

3. Brief Description

Once the bank has processed payments, the bank sends a file to the eBPP system system stating the payment has been processed. The file will contain transaction reference numbers. eBPP system must pass this file to Electronic Marketplace Solution on a real-time basis.

4. Flow of Events

4.1 Basic Flow

As is done today, the bank sends a file to each manufacturers' ERP system after payments have been processed to balance their account reconciliation file.

The manufacturers' ERP system must then send a file to Electronic Marketplace Solution to change the status of the invoice to “Invoice Paid”.

4.2 Alternative Flow(s)—TBD based upon discussions with eBPP system.

5. Special Requirements—TBD based upon discussions with eBPP system.

5.1 Requirement Category (i.e. usability)

6. Pre-Conditions

6.1 Insert Pre-Condition

Payments have been successfully executed by the retailer and received by the manufacturer.

7. Post-Conditions

This file transfer from eBPP system to Electronic Marketplace Solution updates order status' on Electronic Marketplace Solution.

8. Data Requirements

This process is the same process as occurs today—the bank processes all transactions and sends a file to the manufacturer's ERP system. The ERP system must then pass the file to Electronic Marketplace Solution.

9. Interfaces

The manufacturers ERP file will contain the payment information. ELECTRONIC MARKETPLACE SOLUTION will change the invoice status from “payment executed” to “Payment complete.”

Use Case Specification: Payment Confirmation/Order Status Change

1. Context Diagrams

Context_Invoice and Payment (Electronic Payment)

2. Use Case Actors

Bank

Suppliers' ERP System

eBPP system

3. Brief Description

Once the bank has processed payments, the bank sends a file to the Suppliers' ERP system stating the payment has been processed. The file will contain transaction reference numbers.

The bank will also send this file to eBPP system.

4. Flow of Events

4.1 Basic Flow

As is done today, the bank sends a file to each manufacturers' ERP system after payments have been processed to balance their account reconciliation file.

The manufacturers' ERP system must then send a file to change the status of the invoice to “Invoice Paid”.

The bank will also send the file to eBPP system, which will change the status of the invoice to “invoice paid”.

4.2 Alternative Flow(s)—TBD based upon discussions with eBPP system.

5. Special Requirements—TBD based upon discussions with eBPP system.

5.1 Requirement Category (i.e. usability)

6. Pre-Conditions

6.1 Insert Pre-Condition

Payments have been successfully executed by the retailer and received by the manufacturer.

7. Post-Conditions

The file transmittal will result in an invoice order change on eBPP system to “invoice paid.”

8. Data Requirements

This process is the same process as occurs today- the bank processes all transactions and sends a file to the manufacturer's ERP system.

The bank will also send the file to eBPP system to update the system.

9. Interfaces

Bank file sent to eBPP system. File format TBD per, discussions with and eBPP system.

Use Case Specification: Send Payment File to Bank

1. Context Diagrams

Context_Invoice and Payment (Electronic Payment)

2. Use Case Actors

eBPP system

Bank

3. Brief Description

Retailers will execute payments via eBPP system. eBPP system will translate those payments into an AUS BECS/ACH format and transmit the file to the bank for processing. Payments will be transferred to the bank on a real-time basis.

4. Flow of Events

4.1 Basic Flow

Retailers will execute payments via eBPP system.

eBPP system formats the payments to AUS BECS/ACH standards.

Throughout the day, eBPP system transmits the payment file to the bank.

4.2 Alternative Flow(s)—TBD based upon discussions with eBPP system.

5. Special Requirements—TBD based upon discussions with eBPP system.

5.1 Requirement Category (i.e. usability)

6. Pre-Conditions

6.1 Insert Pre-Condition

Retailers execute payments onto eBPP system throughout the day.

7. Post-Conditions

eBPP system will have transmitted all payment instructions to the bank for execution.

8. Data Requirements

eBPP system will transfer the payments to the bank. The file sent to the bank will contain: purchase order number, invoice number, payment confirmation number, retailers bank name, retailers bank routing number, retailers bank account number, manufacturers bank name, manufacturers bank routing number, manufacturers bank account number, and value date of the payment.

9. Interfaces

On a real-time basis throughout the day, eBPP system will gather all payment authorizations, format the information into appropriate AUS BECS/ACH file format standards, and send the file to the bank.

1. Context Diagrams

Context_Invoice and Payment (Electronic Payment)

2. Use Case Actors

Retailer

eBPP system

3. Brief Description

Once the retailer has reviewed the invoice, they will make a payment via the “Execute Payment” screen.

4. Flow of Events

4.1 Basic Flow

Once the retailer has reviewed the invoice, and they decide to make payment.

The retailer clicks on the “Execute Payment” button.

The retailer sees a security message-verify with eBPP system.

The retailer is presented with a screen that lists the invoice number, item, price, quantity and total dollar amount due.

Fields exist which ask the retailer to input: bank account number, bank routing number, value date of payment, dollar amount. Allows multiple retailer bank accounts. (Confirm w/eBPP system)

Functionality is required to allow the retailer to enter the manufacturer's bank information once, and then each time they make a payment to that particular retailer, they can access a drop down menu which already contains the detailed bank information. (Confirm w/eBPP system.)

Functionality is also required for retailers to future date payments. (Confirm w/eBPP system)

Once all of the information is entered, the retailed pushes the “Submit Payment” button.

eBPP system will then generate a confirmation number for the retailer, which can be added in an BECS/ACH field to the bank, so that a) the retailer has confirmation of their transaction, and b) the retailer can call the bank with the transaction number for inquiries. This feature would add to the retailer's comfort in submitting online payments. (Confirm w/eBPP system)

Point to discuss with eBPP system: Detailed BECS/ACH file formats for AUS market. Exactly what field would allow for transaction number to be attached? Need to attach invoice number, and also transaction number directly tied to the payment.

Once the retailer hits “submit payment”, and they receive their confirmation number, they log out.

Payments are transmitted between eBPP system and the bank on a real time basis throughout the day. (Confirm w/eBPP system. Could be twice a day batch. If so, how impact transaction reference number allocations?)

The invoice status is then changed to “Payment Executed” on eBPP system, and eBPP system has a feed back to Electronic Marketplace Solution to update the order status.

4.2 Alternative Flow(s)—TBD based upon discussions with eBPP system.

5. Special Requirements—TBD based upon discussions with eBPP system.

5.1 Requirement Category (i.e. usability)

6. Pre-Conditions

6.1 Insert Pre-Condition

The retailer has to be able to review their invoice prior to executing payment.

7. Post-Conditions

The retailers will have successfully executed their payments to the appropriate suppliers.

8. Data Requirements

The “Execute Payment” screen must enable the retailer to execute payment to a number of manufacturers. They have to be able to retain the manufacturers'banks' detailed information (account number, routing number) to avoid continual reentry of information. They also need to receive a confirmation that the payment was executed, which will enable them to trace the payment with their bank, and the manufacturers' bank.

Data involved includes all of the retailer's bank information (routing number, account number, invoice number, value date), as well as all of the manufacturers' bank information (routing number, account number, invoice number, value date).

9. Interfaces

The eBPP system will transmit all payment transactions throughout the day to their bank. The files will be formatted into the appropriate AUS BECS/ACH file format standards, and send the file to the bank.

1. Context Diagrams

Context_Invoice and Payment (Electronic payment)

2. Use Case Actors

Retailer

eBPP system

3. Brief Description

Retailers will access eBPP system to view their invoices online. It is expected that when the retailer views their invoices, they will see all outstanding invoices for all manufacturers. They will have the ability to drill down on specific invoices for more detailed information. The invoice will contain the manufacturers brand, and will contain: date, purchase order number, sales order number, ASN number, invoice number, item, quantity, price, total amount due, payment terms, tax terms.

4. Flow of Events

4.1 Basic Flow

The retailer will click onto the “View Invoice” button.

This will link the retailer into their own secure https page—within the eBPP system domain. eBPP system will ask for their digital certificate information when they link to eBPP system.

When the “view invoice” screen appears, the retailer will see all of their outstanding invoices listed by manufacturer. This screen will list item, quantity, price, total amount due, and date. For more detailed information on a particular item, such as payment terms, the retailer will be able to click on a particular item to drill down.

eBPP system has stated that they are able to customize the invoice templates to look exactly like the suppliers' invoices. eBPP system has standard invoice templates available for no additional charge.

If an invoice is to due that day, the item will be highlighted.

When the retailer decides to pay the invoice, they will click on an “Execute Payment” button that will take them to the payment initiation screen.

4.2 Alternative Flow(s)

4.2.1 Example Alterative Flow

If the retailed would like to dispute an item on their invoice

5. Special Requirements

5.1 Requirement Category (i.e. usability)

The retailer will need a button to push “Execute Payment” which will take them to the payment initiation screen.

6. Pre-Conditions

6.1 Insert Pre-Condition

An invoice has to have been generated by the Suppliers' ERP system.

The data file from the Suppliers' ERP systems has to have been received eBPP system.

7. Post-Conditions

7.1 The retailer will be prepared to execute payment.

8. Data Requirements

The eBPP system invoice presentment must contain: date, purchase order number, sales order number, ASN number, invoice number, item, quantity, price, total amount due, payment terms.

9. Interfaces

The invoice will contain: date, purchase order number, sales order number, ASN number, invoice number, item, quantity, price, total amount due, payment terms. All of this information will be accessed via the initial “view invoice” screen, or the secondary “drill-down” detailed screen.

Use Case Specification: Receive invoice feed from Suppliers' ERP System to eBPP system

1. Context Diagrams

Context_Invoice and Payment (Electronic payment and cash payment)

2. Use Case Actors

Supplier ERP system

eBPP system

3. Brief Description

eBPP system needs to receive a feed from the Suppliers' ERP systems that contains all invoice information, both content and layout. The file will contain: date, purchase order number, sales order number, ASN number, invoice number, item, quantity, price, total amount due, payment terms.

4. Flow of Events

4.1 Basic Flow

The various Suppliers' ERP systems will generate a file in the eBPP system file format, and send it to the eBPP system system. It is expected that the eBPP system file will be sent real time throughout the day.

Suppliers will need to send the information in a eBPP system compatible format.

4.2 Alternative Flow(s)

4.2.1 Example Alternative Flow

5. Special Requirements

5.1 Requirement Category (i.e. usability)

6. Pre-Conditions

6.1 Insert Pre-Condition

Suppliers will need to send the information in a eBPP system compatible format.

The goods have to be ready for shipment for the invoice to be created.

7. Post-Conditions

7.1 Receipt of this file will result in an updated eBPP system database, and a formatted invoice that can be reviewed online.

8. Data Requirements

The file must be in the eBPP system predefined file format.

9. Interfaces

The file will contain: date, purchase order number, sales order number, ASN number, invoice number, item, quantity, price, total amount due, payment terms.

A nightly batch will trigger the file at a set time every night for the Electronic Marketplace Solution file.

When an invoice is generated for physical good delivery, the print stream will be triggered.

Use Case Specification: Maintain User Access

1. Use Case Diagrams

Create & Maintain User Profile & Security

2. Use Case Actors

Customer Management

Platform

System Admin

3. Brief Description

Develop and maintain user security access and profiles

4. Flow of Events

4.1 Basic Flow

4.1.2 User Profile/Security Entities

Each user within Electronic Marketplace Solution, will have at least the following profile entities: User, Group, Role, Content, Service, and Application Permissibility

With's profile model, a user can have one Group, many Roles, many content elements, and so on. Groups and sub-Groups have an inheritance relationship.

In the RSW, indicated that sub-group functionality is available. Unfortunately, this functionality will not be available until a future release.

These entities determine, upon user log in to Electronic Marketplace Solution, what functions can be performed and what content is viewed

4.1.2 User Profile/Security Maintenance

As a general rule, the more Groups and Roles that are developed the more maintenance that is required

An overall Electronic Marketplace Solution System Administrator will have the highest level of system maintenance functionality allowed

This Electronic Marketplace Solution System Administrator will be the only person who can add new entities or add new users

To reduce the burden of continual user changes, a company specific Sub-System Administrator can be assigned, if desired.

This Sub-Administrator can change the associations of any of their company's users to Service and Application Permissibility

4.1.3 User Profile/Security Updates

Each time a change to a profile is requested or required, the System Admin can utilize a user interface to make the changes

5. Special Requirements

5.1 Release 1

A digital certificate must be part of the user profile and passed prior to being able to perform payment activities

Payment is no longer a Release 1 functionality

The user profile needs to accommodate for the following individuals/roles:

Convenience Organized: HO Category Manager, HO Finance, HO Purchasing, MSF Account Mgr., MSF Operations Mgr., Store Manager, Store Owner, Site Staff 1, Site Staff 2, IT Support

Convenience Independent: Store Manager/Owner, Site Staff 1, Site Staff 2, IT Support

Electronic Marketplace Solution Operations: Security Admin., Catalogue/Profile Maintenance, Finance, IT Support, Help Desk

Electronic Marketplace Solution Development: Business Development, Content Development

Electronic Marketplace Solution Misc.: Customer Relations, MIS

Supplier: Brand Team, Trade Marketing Mgmt. Team, Trade Marketing Reps., IT Team, Finance-Security

Other: Service Providers, Logistics Providers

The User needs to understand and agree to be liable for profile and password usage

The user profile will be based on BAT's current customer hierarchy and fitted to's structure

The user profile is now based upon Electronic Marketplace Solution's Retailer and Supplier hierarchy fitted to's profile. Because doesn't support user profile hierarchies until future releases, new fields will be added to the user profile to represent the hierarchy.

5.2 Release 3

Sub-Group user profile hierarchy functionality

6. Pre-Conditions

6.1 The basic profile model has been developed (i.e. all entities have been designed)

7. Post-Conditions

7.1 User Profile/Security updated and maintained

8. Data Requirements

9. Interfaces

Use Case Specification: Create New Profile

1. Use Case Diagrams

Create & Maintain User Profile & Security

2. Use Case Actors

Customer Management

Platform

Payment Provider

System Admin

Supplier ERP

User (General)

3. Brief Description

Based upon whether the user is a buyer or a supplier, a user profile is created and all initial data is uploaded

4. Flow of Events

4.1 Basic Flow—New Buyer/Retailer/Group of Retailers

A Retailer is identified as a potential Electronic Marketplace Solution customer by Electronic Marketplace Solution CRM or via the Electronic Marketplace Solution Guest Log In procedure

A Electronic Marketplace Solution Representative contacts the Retailer and begins gathering initial user profile information (i.e. name, address, credit terms, etc.)

If the Retailer is accepted and agrees to Electronic Marketplace Solution terms and conditions, Electronic Marketplace Solution assigns them a Customer #/User ID/Store ID—Data team will develop hierarchy

In depth user profile information is gathered and hardware/software installation begins

The Retailer submits current supplier information (their supplier customer #'s) and that information is validated by the suppliers

If the information is correct, the Electronic Marketplace Solution-Supplier Customer # translation tables are updated, pricing and catalogue by supplier for Retailer is established, and the user profile is completed

4.2 Alternative Flow—New Buyer/Retailer/Group of Retailers

4.2.1 Incorrect Supplier Customer ID information submitted

Electronic Marketplace Solution resolves the issue with the supplier on behalf of the retailer

Retailer notified of issue and resolution

4.2.2 Retailer not accepted as Electronic Marketplace Solution customer

Retailer is notified of the reasons that they were not accepted as a customer and invited to try again in the future

4.3 Basic Flow—New Supplier

A Supplier is identified as a potential Electronic Marketplace Solution customer

A Electronic Marketplace Solution Representative contacts the Supplier and begins gathering initial user profile information (i.e. name, address, credit terms, etc.)

In depth user profile information is gathered and Supplier set up data (catalogue, desired customer criteria, categories; products, etc.) is gathered

If the Supplier is accepted and agrees to Electronic Marketplace Solution terms and conditions, Electronic Marketplace Solution assigns them a Customer #/User ID

A conversion team is established to match a supplier's customers to Electronic Marketplace Solution customers

For the matching customers, a notification is sent to those Retailers and catalogue and pricing is established for those retailers

For non-matching customers, Electronic Marketplace Solution can offer this information as a value add to the supplier (i.e. open new markets)

4.4 Alternative Flow—New Supplier

4.4.1 Supplier not accepted as Electronic Marketplace Solution customer

Supplier is notified of the reasons that they were not accepted as a customer and invited to try again in the future

5. Special Requirements

9.1 Release 1

Parent—Child relationship for profiles

The customer id is a logical join of the store proprietor and the store location

User profiles for Service Providers and Logistics Providers will follow a similar path but additional data elements may be required

User profile information will be gathered via paper forms and then entered into the user profile database

Electronic Marketplace Solution needs to assign a unique customer number for each new retailer. This # will be mapped to the Suppliers' customer id.

A digital certificate, required for performing payment functions, must be part of the user profile

Ability to query/data mine entire user profile

Honor the competitive landscape/information etc. Information sharing will operate similarly to Nielsen. Electronic Marketplace Solution will determine the information sharing parameters

Retailers have “View” capability prior to being on credit terms with Suppliers

Potential work around for waiting for supplier credit terms is to place retailers on COD until credit terms have been established/confirmed. This will require supplier buy-in.

The user profile will be based on BAT's current customer hierarchy and fitted to's structure.

9.2 Release 3

Electronic Marketplace Solution Representatives have a semi-automatic (i.e. on-line form) to gather user profile information which will populate a staging database

The number of attributes gathered on a Retailer will be limited. Each supplier can specify a limited number (proposed 5) attributes to be gathered.

6. Pre-Conditions

6.1 Buyer/Supplier is approved by Sales Rep or Guest Log In to be a user

7. Post-Conditions

7.1 Supplier/Buyer ready for operation

7.2 Main catalogue determined, Shopping List populated, Pricing matrix available

8. Data Requirements

Banking/Payment Provider data requirements

Refer to design specifications

Proprietor—Debt/Financial Responsibility

Employees

Physical Store Location—Store #—Ship to

Web Page Info

Supplier Info

Data Entry

Customer # is the logical joint of proprietor and store location

9. Interfaces

9.1 Supplier ERP

9.2 Electronic Marketplace Solution CRM

Use Case Specification: Maintain Current Profile

1. Use Case Diagrams

Create & Maintain User Profile & Security

2. Use Case Actors

Customer Management

platform

User (General)

Supplier ERP

System Admin

3. Brief Description

The user profile is updated with new information. The user can update some information via an on-line form. The remaining information must be submitted via predefined Electronic Marketplace Solution format (i.e. pricing, catalogue categories, etc.)

4. Flow of Events

4.1 Basic Flow

For information that a user can change, the user clicks on My Profile from the Electronic Marketplace Solution default page

Their profile is displayed with an edit button

The user can click on edit, update the information, and save

Typical information could include name, address, telephone #, generic store details, etc.

For information that a user cannot change (i.e. security access), the user can request changes by sending an email to Electronic Marketplace Solution

Electronic Marketplace Solution then facilitates the change

5. Special Requirements

5.1 Release 1

Access to fields based on user profile

On-line forms for change requests

Can customize what fields are editable by User

Manual work flow to update and change

6. Pre-Conditions

6.1 User has Electronic Marketplace Solution account and user profile

7. Post-Conditions

7.1 Profile Updated

7.2 Partners notified of change that affects them

8. Data Requirements

9. Interfaces

Supplier ERP-Manual data-pull and upload

Use Case Specification: Activate User Profile & Data

1. Use Case Diagrams

Initiate User Session Package

2. Use Case Actors

Platform

3. Brief Description

Upon successful log in, all pertinent user data is pulled and made “active” for the user session

4. Flow of Events

4.1 Basic Flow

User log in accepted

User information pulled (contact, etc.)

Pricing data pulled

Catalogue information/format pulled

Security active

Community content pulled

Promotion data/format pulled

Payment data pulled

Order Status data pulled

Functionality/Access active

5. Special Requirements

5.1 Release 1

The user profile will be based on BAT's current customer hierarchy fitted to the user profile structure

Restricted areas grayed out or not visible

All relevant data and content pulled upon log in

6. Pre-Conditions

6.1 User profile has been created

6.2 User has successful log in

7. Post-Conditions

7.1 User specific functionality and data active and populated on UI

8. Data Requirements

User profile

9. Interfaces

Use Case Specification: Log Out-Punch Out

1. Use Case Diagrams

Initiate User Session Package

2. Use Case Actors

User (General)

POS

External Sites

Platform

3. Brief Description

A user either ends a Electronic Marketplace Solution Session, toggles (or punches out) to POS, or punches out to an external site

4. Flow of Events

4.1 Basic Flow

In order to completely log out of Electronic Marketplace Solution, user must shut down Electronic Marketplace Solution Internet Session web browser

4.2 Alternative Flow(s)

4.2.1 Toggle to POS

Awaiting POS decision

4.2.2 Punch Out to External Site

If a user clicks on another URL, a new window is, open with no interruption to the Electronic Marketplace Solution session

5. Special Requirements

9.1 Release 1

Allow session time out. (Time to be determined by Electronic Marketplace Solution Management)

Currently, if an session times out, all non-confirmed/saved information is lost. A potential work around is to set the session time long enough to avoid this situation

user session should be maintained during external site punch out

Punch out functionality (go to another website) while maintaining Electronic Marketplace Solution site security

When a user clicks on a log out button, another page recommending that users shut down their browser to completely end their session is displayed

Seamless functionality between POS and Electronic Marketplace Solution—Awaiting POS decision

9.2 Release 3

If a session times out, no information should be lost

6. Pre-Conditions

6.1 Active Electronic Marketplace Solution Session

7. Post-Conditions

7.1 User logged out

7.2 User viewing external site

7.3 Security integrity maintained

8. Data Requirements

9. Interfaces

9.1 External sites

9.2 POS

Use Case Specification: Guest Log In—Registration

1. Use Case Diagrams

Initiate User Session Package

2. Use Case Actors

User (General)

Platform

3. Brief Description

A new user enters the main Electronic Marketplace Solution Site, can view generic material and register to become a user

4. Flow of Events

4.1 Basic Flow

User enters Electronic Marketplace Solution Site

Selects Log In as Guest

Views generic material

User clicks on Register

User prompted to enter information (i.e. contact info, minimal profile, supplier or buyer, location, name, phone number, etc.)

5. Special Requirements

5.1 Release 1

User can view generic information such as marketing material, Electronic Marketplace Solution information, supplier information, brief description of services—Refer to Electronic Marketplace Solution internal marketing to determine actual timing

On line form to enter registration information

The guest demo site does not hit the production system

Key customer qualification fields (i.e. geographical location) will have text disclaimers such as, “Available for Australia/New Zealand Residents Only”

5.2 Release 3

Users can be denied based upon basic requirements such as, location, size, etc.

6. Pre-Conditions

6.1 Active Internet session

7. Post-Conditions

7.1 Electronic Marketplace Solution has enough information to contact new potential/interested user

7.2 Guest user can view demo site

8. Data Requirements

User Registration information fields

9. Interfaces

9.1 Marketing server for demo site

Use Case Specification: Log In—Registered User

1. Context Diagrams

Initiate User Session Package

2. Use Case Actors

User (General)

Platform

3. Brief Description

A registered user logs into the secure Electronic Marketplace Solution site

4. Flow of Events

4.1 Basic Flow

User accesses Electronic Marketplace Solution web site

User navigates to “registered user log in” portion to access the log in page

System prompts user to Log In

User enters ID and Password

If Log In is correct, user is sent to default page (“My Page”)

If Log In is incorrect, see alternative flow

4.2 Alternative Flow(s)

4.2.1 Incorrect User Name/Password

The system displays message “Incorrect user id/password please try again”

User re-enters id and password

If correct, user is sent to default page

If incorrect, User can try one additional time. If still incorrect, a text box appears instructing the user how to request help and the session expires

5. Special Requirements

5. 1 Release 1

Alternative navigation paths based on registered or non-registered user

Main home page will allow guest users to register and registered users to log in to the secured site

User id and password format is easily configurable

Upon final incorrect password entry, a text box appears instructing the user to call the help desk at the following # <<insert #>> to request password assistance

Internet Explorer 5.0 for pilot—Note—* Establish exact version of pilot for every store and use the same one. Potential enhancements for future.

More information required on Payment Provider and related log in requirements

Different layers of security access based upon user profile

Disallow or recommend not using the save password function

User must re-enter password for payment functionality or user needs to be verified by some digital certification. Do not want to have system remember user name and password. There is a concern about the security of the fund transfer functionality

Various help desk screens—this is bigger than just log in

5.2 Release 3

Upon final incorrect password entry, user can navigate to a password help screen and request assistance via an online form

User can bookmark secure portion of Electronic Marketplace Solution to avoid main homepage

Seamless log in function between POS and Electronic Marketplace Solution—Awaiting POS decision

6. Pre-Conditions

6.1 User has started Internet session

6.2 User has registered with Electronic Marketplace Solution

6.3 User profile has been established

6.4 Help desk or help tips have been established and are accessible

6.5 Security has been activated

7. Post-Conditions

7.1 User sent to default page (“My Page”)

User accesses customized specific operational page for them. This is based on the user profile. Current events, news, and content. This is the page from which the user accesses the menu.

7.2 User Profile is “activated”. User specific data and access is pulled

Specific pricing data

Specific Store/Co and My List data

Security profile

Access/functionality

Targeted Content

8. Data Requirements

Password

User ID

User Profile information (content, advertising, functionality, access, etc.)

Security Access information

9. Interfaces

Payment provider

It should be noted that the computer network as referenced in this specification should be taken to include all forms of connected or communicating computers or terminals having at least two terminals connected or communicating as hereinbefore described. That is, the term computer network should be taken to include any type of terminal as hereinbefore defined, computer, computerised device, peripheral computer equipment, computerised accessory, mobile or cellular phone, digital electronic device or other similar type of computerised electronic device or part thereof which is rendered such that it is capable of communicating with at least one of any of the aforementioned entities. Said communication of information or data can occur over any data communications network, computer network, wireless network, internetwork, intranetwork, local area network (LAN), wide area network (WAN), the Internet and developments thereof, transient or temporary network, combinations of the above or any other type of network providing for computerised, electronic or digital devices.

Furthermore, references to the terms connecting, communicating, transmitting, requesting, receiving, exchanging and the like, and permutations thereof, as applied to the term computer network and/or components thereof should be taken to pertain to the transfer of information or data. Such transfers of information or data can be facilitated for by any form of entity/entities for facilitating such, including, but not limited to, metallic wires or cables, semi-conducting wires or cables, optical fibres and optical devices, wireless means, electromagnetic waves and the like and modulations thereof, acoustic waves and the like and modulations thereof; control of electric and/or magnetic fields, and/or the transportation of all forms of memory devices.

Thus, there has been provided in accordance with the present invention, a new type of Internet based business to business portal which satisfies the advantages set forth above.

The invention may also be said broadly to consist in the parts, elements and features referred to or indicated in the specification of the application, individually or collectively, in any or all combinations of two or more of said parts, elements or features, and where specific integers are mentioned herein which have known equivalents in the art to which the invention relates, such known equivalents are deemed to be incorporated herein as if individually set forth.

Although the preferred embodiment has been described in detail, it should be understood that various changes, substitutions, and alterations can be made herein by one of ordinary skill in the art without departing from the scope of the present invention as hereinbefore described and as hereinafter claimed.

1. An integrated system for providing an electronic marketplace solution, the integrated system including:
means for Point of Sale (POS) scanning of goods and associated data capture by a Convenience Retailer;
means for determining a replenishment order for goods, based on sales by the Convenience Retailer, preordained Convenience Retailer criteria, or the Convenience Retailer manually selecting goods;
means for the electronic transfer of the replenishment order to a Supplier via a Supplier ordering system; and
means for providing a payment processing module which links the Supplier ordering system and a payment gateway which is able to communicate with the Convenience Retailer's commercial banking system.

2. The system as claimed in claim 1, wherein electronic processing of returned goods is integrated into an order tracking procedure.

3. The system as claimed in either claim 1 or claim 2, wherein the Supplier is a FMCG Manufacturer or a Wholesaler.

4. The system as claimed in any one of the claims 1 to 3, wherein the system includes a centrally managed database which is linked with the Supplier ordering system.

5. The system as claimed in any one of the claims 1 to 3, wherein POS/BOS data is managed within a centrally managed database.

6. The system as claimed in any one of the claims 1 to 5, wherein goods are scanned on receipt by the Convenience Retailer and/or on sale to a consumer.

7. The system as claimed in any one of the claims 1 to 6, wherein the associated data is used to deliver market information to the Convenience Retailer, the Supplier, a Manufacturer, a Wholesaler or a Logistics Provider.

8. The system as claimed in claim 7, wherein the system provides network-based access to the market information via a business-to-business web portal.

9. The system as claimed in any one of the claims 1 to 8, wherein part of the system is in a private network and access to the part of the system requires user authentication.

10. The system as claimed in any one of the claims 1 to 9, wherein the system includes means for Available To Promise (ATP) checking from the Supplier's inventory database.

11. The system as claimed in any one of the claims 1 to 10, wherein the system includes means for providing electronic confirmation of replenishment order acceptance from the Supplier to the Convenience Retailer.

12. The system as claimed in any one of the claims 1 to 11, wherein the system includes means for electronic tracking of replenishment orders until delivery of the goods to the Convenience Retailer.

13. The system as claimed in any one of the claims 1 to 12, wherein all electronic transfers and ordering occur via the Internet.

14. An integrated system for providing an electronic marketplace solution, the system including:
means for Point of Sale (POS) scanning of goods and associated data capture by a Convenience Retailer;
means for a Convenience Retailer to search and browse a multiple Supplier goods and pricing catalogue for determining a replenishment order for goods;
means to provide the Convenience Retailer with online replenishment order placement to a Supplier;
means for the tracking and management of goods;
means for providing electronic bill presentation and payment; and,
means to generate customised reports for the Convenience Retailer or the Supplier.

15. The system as claimed in claim 14, wherein the system includes means to facilitate Supplier access to marketplace based promotions.

16. The system as claimed in claim 14, wherein the system includes a telecommunications infrastructure providing: a secure private network; a secure connection via the Internet; and Internet connectivity.

17. The system as claimed in any one of the claims 14 to 16, wherein the system includes inventory management and business reporting tools for the Convenience Retailer.

18. The system as claimed in any one of the claims 14 to 17, wherein the system is integrated with at least one Supplier enterprise resource planning (ERP) system to provide:
Available To Promise (ATP) checking from the Supplier's inventory database;
credit and payment status checking from the Supplier's financial database;
electronic transfer of orders to the Supplier's order capture system; and
Supplier confirmation of order acceptance and fulfilment.

19. The system as claimed in any one of the claims 14 to 18, wherein the system communicates with commercial banking systems to provide the electronic payment.

20. The system as claimed in any one of the claims 14 to 19, wherein the system includes business and technology integration with convenience industry Service Providers to promote and supply related goods or services.

21. A method of providing an electronic marketplace solution, the method including the steps of:
a Convenience Retailer performing Point of Sale (POS) scanning of goods and associated data capture;
determining a replenishment order for goods, based on sales by the Convenience Retailer, preordained Convenience Retailer criteria, or the Convenience Retailer manually selecting goods;
electronically transferring the replenishment order to a Supplier via a Supplier ordering system;
an automated request being transmitted, by a Convenience Retailer terminal or the Supplier ordering system, to a Logistics Provider to effect delivery of the goods;
the Logistics Provider arranging delivery of the goods to the Convenience Retailer; and,
performing payment processing which links the Supplier ordering system and a payment gateway which is able to communicate with the Convenience Retailer's commercial banking system.

22. The method as claimed in claim 21, wherein the Convenience Retailer terminal can be used to access a database providing the delivery status of the goods.

23. The method as claimed in claim 21, wherein goods are scanned by the Convenience Retailer, the Supplier and the Logistics Provider, thereby providing marketplace information able to be accessed in a database.

24. The method as claimed in claim 23, wherein goods are scanned by a scanner connected to the Convenience Retailer terminal when received by the Convenience Retailer, thereby updating relevant records in the database.

25. The method as claimed in claim 21, wherein relevant records include: inventory information; sales figures; time of sale; place of sale; or identifying information about the consumer.

26. The method as claimed in any one of claims 21 to 25, wherein information pertaining to consumer purchases gathered by the Convenience Retailer is visible to the Supplier; a Wholesaler; the Logistics Provider; and/or a Service Provider.

27. The method as claimed in any one of claims 21 to 26, wherein automated ordering of goods occurs when database records indicate that the Convenience Retailer's stock of goods is at a predetermined level.

28. The method as claimed in any one of claims 21 to 27, wherein the Supplier, a FMCG Manufacturer, a Wholesaler, a Logistics Provider, and/or a Service Provider, individually or cooperatively collate orders for goods from the Convenience Retailer.

29. The method as claimed in any one of claims 21 to 28, wherein data or information pertaining to past sales transactions in the convenience marketplace are available, via a computer network, to authorised users or participants from an information source.

30. A network based business to business Internet portal, the Internet portal providing access to an electronic marketplace solution, the Internet portal providing:
a facility to submit a replenishment order to a Supplier via a Supplier ordering system, the replenishment order based on sales of goods by the Convenience Retailer, preordained Convenience Retailer criteria, or the Convenience Retailer manually selecting goods;
a facility for the Supplier to confirm the availability of goods;
a facility to provide goods delivery status information; and,
a payment processing system which links the Supplier ordering system and a payment gateway which is able to communicate with the Convenience Retailer's commercial banking system allowing the Convenience Retailer to pay for goods.

31. A set of computer readable medium of instructions for use in providing an electronic marketplace solution, the set of instructions enabling web-based order processing and including procedures for:
Point of Sale (POS) scanning of goods and associated data capture;
determining a replenishment order for goods, based on sales by a Convenience Retailer, preordained Convenience Retailer criteria, or the Convenience Retailer manually selecting goods;
electronically transferring the replenishment order to a Supplier via a Supplier ordering system; and,
web-based browse and buy functionality providing payment processing which links the Supplier ordering system and a payment gateway which is able to communicate with the Convenience Retailer's commercial banking system.

32. The set of instructions as claimed in claim 31, wherein the procedures also include available To Promise (ATP) checking from the Supplier's inventory database, and Supplier confirmation of the replenishment order acceptance.
